(19) United States
(12) Patent Application Publication
(10) Pub. No.: US 2025/0070383 A1
(43) Pub. Date: Feb. 27, 2025

(54) FUNCTIONAL ULTRATHIN BATTERY SEPARATOR AND METHOD FOR FABRICATING THE SAME

(71) Applicant: Zhaoyang FAN, Phoenix, AZ (US)

(72) Inventor: Zhaoyang FAN, Phoenix, AZ (US)

(73) Assignee: Arizona Board of Regents on Behalf of Arizona State University, Scottsdale, AZ (US)

(21) Appl. No.: 18/815,775

(22) Filed: Aug. 26, 2024

Related U.S. Application Data
(60) Provisional application No. 63/578,973, filed on Aug. 25, 2023.

(51) Int. Cl. H01M 50/403; H01M 50/429; H01M 50/449; H01M 50/46

(52) U.S. Cl. CPC H01M 50/403; H01M 50/4295; H01M 50/449; H01M 50/46

(57) ABSTRACT

A functional ultrathin battery separator and method for fabricating the same is disclosed. The battery separator includes a polymer substrate that is flexible, and a functional barrier layer deposed on the polymer substrate. The functional barrier layer is polycrystalline and includes a metal-organic framework and a plurality of micropores. The functional barrier layer is able to flex with the polymer substrate. The functional barrier layer is compact, such that diffusion pathways through the functional barrier layer are limited to a cutoff size, and such that the diffusion pathways that are largest are located within grains of the polycrystalline functional barrier layer rather than between grains. The battery separator may be less than 10 μm thick, and the polymer substrate may be less than 9 μm thick. The metal-organic framework may be ZIF-8, and the functional barrier layer may be less than 2 μm thick.

### RELATED APPLICATIONS

This application claims the benefit of U.S. provisional patent application 63/578,973, filed Aug. 25, 2023, titled “FUNCTIONAL ULTRATHIN BATTERY SEPARATOR AND METHOD FOR FABRICATING THE SAME,” the entirety of the disclosure of which is hereby incorporated by this reference.

### STATEMENT REGARDING FEDERALLY SPONSORED RESEARCH

This invention was made with government support under 2103582 awarded by the National Science Foundation. The government has certain rights in the invention.

### TECHNICAL FIELD

Aspects of this document relate generally to battery separators for lithium-based batteries.

### BACKGROUND

Demands for electrified transportation and renewable energy have intensified the need for high-performance electrical energy storage devices. Lithium-ion batteries (LIB) currently play a dominant role among these devices, but are hampered by cost, material availability, and low capacity.

There are also efforts to move beyond LIB. The next generation of lithium-based batteries includes Li-metal (LMB) and Li-sulfur (LSB) batteries. LMBs, using Li-metal as the anode, are promising for next-generation energy storage due to lithium's highest specific capacity (3861 mAh g⁻¹) and lowest negative potential (−3.04 V vs. standard hydrogen electrode). However, the utility of current LMB technology is held back by several drawbacks. One of the biggest problems with using a Li-metal anode is that during charging, localized high lithium-ion flux results in Li-ions being unevenly deposited onto the anode, forming needle-like deposits called dendrites. These dendrites can grow through the separator and reach the cathode, causing a short circuit, which can lead to battery failure, potentially of a hazardous nature (e.g., fire, explosion, etc.). Moreover, the growth of lithium dendrites exposes fresh lithium to the electrolyte, leading to their continuous reaction, resulting in rapid capacity degradation, low Coulombic efficiency, and electrolyte consumption.

Taking a further step, using sulfur as the cathode, lithium-sulfur batteries (LSBs) have garnered significant attention among LMBs. The sulfur cathode offers a superior theoretical specific capacity of 1672 mAh g⁻¹, along with the merits of environmental friendliness and the abundance of sulfur, potentially overcoming the limitations of lithium-ion batteries. In addition to a large energy density, LSBs benefit from the low cost, abundant supply, and light weight of sulfur.

However, LSBs inherit the dendrite formation problem associated with the Li-metal anode and face additional challenges from the sulfur cathode, among which the notorious ‘shuttle effect’. With a cyclic ring (cyclo-octasulfur) structure, sulfur in the cathode undergoes stepwise reduction during discharge, forming long-chain and short-chain polysulfides. The long-chain LiPS (Li₂Sₓ, 4<=x<=8) can easily dissolve in the used ether-based electrolyte and diffuses out of the cathode matrix to the anode side, where it reduces and then transports back to the cathode. The resulting polysulfide shuttle effect leads to low Coulombic efficiency, anode corrosion, rapid capacity decay, and fast battery failure, sabotaging the practical utilization of Li-S battery technology.

Efforts to overcome these problems have included attempts to improve the separator. The primary function of the separator in a Li-based battery is to electrically isolate the active cathode and anode materials while allowing free transportation of Li⁺ ions. Polyolefin-based membranes, including polypropylene (PP) and polyethylene (PE), characterized by large (up to hundreds of nanometers) and non-uniform micropores, are commonly used as battery separators. However, these separators cannot fulfill their two fundamental roles since they cannot block polysulfide crossover and cannot facilitate Li⁺ transportation effectively. The hydrophobic nature of these separator materials prevents any chemical mechanisms from expediting Li⁺ transportation. Additionally, they lack functional groups that can actively regulate ion transport to enhance Li⁺ diffusion and its transference number.

The extruded polyolefin films used in commercial separators cannot, by themselves, address the challenges of LiPS shuttling and Li-metal dendrite formation. A separator that allows active LiPS shuttling between two electrodes does not fulfill its essential function. Therefore, modifying the separator to shut off LiPS shuttling is a straightforward and attractive strategy. Blocking the LiPS pathway can be achieved via pore size downscaling to a few nanometers, which allows Li⁺ transportation but prevents LiPS movement. Another attractive method is to graft polar functional groups onto the separator, creating strong intermolecular forces between these groups and LiPS, thus confining them to the cathode side.

While significant research efforts have been dedicated to immobilizing polysulfides within the cathode host, achieving effective separation using the separator remains a viable solution to polysulfide shuttling. Modifying the separator by reducing pore size or functionalizing it to facilitate uniform and rapid Lit transfer and block the polysulfide pathway emerges as a promising approach to mitigate both the lithium dendrite problem and the shuttle effect in LMBs and LSBs. This would also positively impact the Li-metal anode performance, as a separator with uniform nanoscale pore distribution and functional chemical groups could promote consistent and uniform Lit flux at the anode surface.

However, despite being an indispensable component of batteries, the passive separator does not actively contribute to any battery capacity. With a typical thickness of 20-30 μm, it occupies a significant portion of the battery volume. Reducing the thickness of the separator can help increase the battery's volumetric energy density. For instance, replacing a 30 μm thick separator with a 10 μm ultrathin one could increase the energy density of an NCM811-based LIB from 700 to 820 WhL⁻¹. Reduction of internal resistance is another merit of ultrathin separators. Yet, these ultrathin PP or PE separators lack the necessary puncture strength and penetration resistance crucial for battery manufacturing. Moreover, they do not possess enough mechanical strength to endure long-term battery cycling and cannot prevent Li dendrite penetration if a Li-metal anode is used.

### SUMMARY

According to one aspect, a battery separator includes a polymer substrate that is flexible, and a functional barrier layer deposed on the polymer substrate. The functional barrier layer is polycrystalline and includes a metal-organic framework and a plurality of micropores. The functional barrier layer is able to flex with the polymer substrate. The functional barrier layer is compact, such that diffusion pathways through the functional barrier layer are limited to a cutoff size, and such that the diffusion pathways that are largest are located within grains of the polycrystalline functional barrier layer rather than between grains.

Particular embodiments may comprise one or more of the following features. The battery separator may be less than 10 μm thick. The polymer substrate may be less than 9 μm thick. The polymer substrate may be bacteria cellulose. The polymer substrate may be polypropylene. The metal-organic framework may be ZIF-8. The functional barrier layer may be less than 2 μm thick. The cutoff size may be less than 10 Å.

According to another aspect of the disclosure, a battery separator includes a polymer substrate and a functional barrier layer deposed on the polymer substrate. The functional barrier layer is polycrystalline and includes a metal-organic framework and a plurality of micropores. The functional barrier layer is compact, such that diffusion pathways through the functional barrier layer are limited to a cutoff size, and such that the diffusion pathways that are largest are located within grains of the polycrystalline functional barrier layer rather than between grains. The functional barrier layer is less than 2 μm thick.

Particular embodiments may comprise one or more of the following features. The battery separator may be less than 10 μm thick. The polymer substrate may be bacteria cellulose. The polymer substrate may be polypropylene. The metal-organic framework may be ZIF-8. The cutoff size may be less than 10 Å.

According to yet another aspect of the disclosure, a method for fabricating a battery separator includes preparing a polymer substrate that is flexible, preparing a precursor solution that is a precursor to a metal-organic framework, and deposing a functional barrier layer on the polymer substrate using the precursor solution. The functional barrier layer being polycrystalline. The functional barrier layer is compact, such that diffusion pathways through the functional barrier layer are limited to a cutoff size, and such that the diffusion pathways that are largest are located within grains of the polycrystalline functional barrier layer rather than between grains. The battery separator is less than 10 μm thick.

Particular embodiments may comprise one or more of the following features. Preparing the polymer substrate may include sputtering a metal coating on the polymer substrate. The functional barrier layer may be deposed on the polymer substrate through electrodeposition within the precursor solution. The functional barrier layer may be deposed on the polymer substrate through interfacial growth within the precursor solution. The polymer substrate may be polypropylene. The metal-organic framework may be ZIF-8. The cutoff size may be less than 10 Å.

Aspects and applications of the disclosure presented here are described below in the drawings and detailed description. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for”, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed aspects, it is intended that these aspects not be limited only to the specific structure, material or acts that are described in the preferred embodiments, but in addition, include any and all structures, materials or acts that perform the claimed function as described in alternative embodiments or forms of the disclosure, or that are well known present or later-developed, equivalent structures, material or acts for performing the claimed function.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

The disclosure will hereinafter be described in conjunction with the appended drawings, where like designations denote like elements, and:

FIG. 1A shows a perspective view of a functional ultrathin battery separator;

FIG. 1B shows a perspective view of a metal-organic framework-based embodiment of the battery separator, with a close-up view of the functional barrier layer;

FIGS. 1C and 1D show a perspective view of two different embodiments of a polydopamine-based battery separator;

FIG. 2 is a process flow for the fabrication of a functional ultrathin battery separator;

FIG. 3A is a schematic view of the cathodic electrodeposition of polycrystalline

ZIF-8 onto a porous polypropylene 120 membrane;

FIG. 3B is a schematic view of a method for fabricating a PDA@BC separator;

FIG. 4A shows an XRD pattern for a ZIF-8@PP battery separator, and pure ZIF-8 crystals;

FIG. 4B shows an SEM top view of a ZIF-8@8-μm PP separator;

FIG. 5A demonstrates the stress-strain characteristics of different battery separators under uniaxial elongation;

FIG. 5B shows measurements of the electrolyte uptake by different battery separators;

FIG. 5C shows the EIS profiles of two-electrode symmetrical stainless-steel cells coupled with different battery separators;

FIG. 5D shows chronoamperometry profiles of two-electrode symmetrical lithium metal cells coupled with different separators;

FIGS. 6A and 6B show time-voltage curves for Li plating/stripping in a Li∥PP ∥Li cell and Li∥ZIF-8@PP∥Li symmetrical cells, the cells having 8 μm and 25 μm polypropylene, respectively;

FIGS. 6C and 6D show the time-voltage curves of Li plating-stripping in Li∥Cu asymmetrical cells with different separators, and their respective Coulombic efficiency comparison, respectively;

FIG. 7A shows open-circuit voltage (OCV) curves of Li—S cells assembled with different separators;

FIG. 7B shows voltage charge/discharge profiles of a Li—S cell coupled with ZIF-8@8-μm PP, from 0.1 to 1 C;

FIG. 7C shows the rate capabilities of LSBs coupled with different separators;

FIG. 8 shows performance data for Li—S cells comprising a battery separator having ZIF electrodeposited on top of a layer of polydopamine;

FIGS. 9A and 9B show top and cross-sectional SEM images of a PDA@BC separator, respectively;

FIG. 9C shows an SEM image of a free-standing carbonized scaffold derived from bacteria cellulose;

FIGS. 9D, 9E, and 9F show DSC curves, electrolyte uptake capability, and ion conductivity test results, respectively, for PDA@BC and C-2400 battery separators;

FIGS. 10A and 10B show the plating-stripping behavior of PDA@BC from 0.5 to 6 mAcm⁻², and of PDA@BC and C-2400 at 1 mAcm⁻², respectively;

FIG. 10C shows the overpotentials measured from FIG. 10B;

FIG. 11A shows the results of an Open Circuit Potential test of Li—S batteries with PDA@BC and C-2400 battery separators 100;

FIGS. 11B and 11C show the voltage profile and rate capability, respectively, of a Li—S battery with PDA@BC at different current densities;

FIG. 12A shows the Li—S battery performance at 1 C with PDA@BC separator; and

FIG. 12B shows images of the PDA@BC separator showing degradation after a specified number of cycles.

### DETAILED DESCRIPTION

This disclosure, its aspects and implementations, are not limited to the specific material types, components, methods, or other examples disclosed herein. Many additional material types, components, methods, and procedures known in the art are contemplated for use with particular implementations from this disclosure. Accordingly, for example, although particular implementations are disclosed, such implementations and implementing components may comprise any components, models, types, materials, versions, quantities, and/or the like as is known in the art for such systems and implementing components, consistent with the intended operation.

The word “exemplary,” “example,” or various forms thereof are used herein to mean serving as an example, instance, or illustration. Any aspect or design described herein as “exemplary” or as an “example” is not necessarily to be construed as preferred or advantageous over other aspects or designs. Furthermore, examples are provided solely for purposes of clarity and understanding and are not meant to limit or restrict the disclosed subject matter or relevant portions of this disclosure in any manner. It is to be appreciated that a myriad of additional or alternate examples of varying scope could have been presented, but have been omitted for purposes of brevity.

While this disclosure includes a number of embodiments in many different forms, there is shown in the drawings and will herein be described in detail particular embodiments with the understanding that the present disclosure is to be considered as an exemplification of the principles of the disclosed methods and systems, and is not intended to limit the broad aspect of the disclosed concepts to the embodiments illustrated.

Demands for electrified transportation and renewable energy have intensified the need for high-performance electrical energy storage devices. Lithium-ion batteries (LIB) currently play a dominant role among these devices, but are hampered by cost, material availability, and low capacity.

There are also efforts to move beyond LIB. The next generation of lithium-based batteries includes Li-metal (LMB) and Li-sulfur (LSB) batteries. LMBs, using Li-metal as the anode, are promising for next-generation energy storage due to lithium's highest specific capacity (3861 mAh g⁻¹) and lowest negative potential (−3.04 V vs. standard hydrogen electrode). However, the utility of current LMB technology is held back by several drawbacks. One of the biggest problems with using a Li-metal anode is that during charging, localized high lithium-ion flux results in Li-ions being unevenly deposited onto the anode, forming needle-like deposits called dendrites. These dendrites can grow through the separator and reach the cathode, causing a short circuit, which can lead to battery failure, potentially of a hazardous nature (e.g., fire, explosion, etc.). Moreover, the growth of lithium dendrites exposes fresh lithium to the electrolyte, leading to their continuous reaction, resulting in rapid capacity degradation, low Coulombic efficiency, and electrolyte consumption.

Taking a further step, using sulfur as the cathode, lithium-sulfur batteries (LSBs) have garnered significant attention among LMBs. The sulfur cathode offers a superior theoretical specific capacity of 1672 mAh g⁻¹, along with the merits of environmental friendliness and the abundance of sulfur, potentially overcoming the limitations of lithium-ion batteries. In addition to a large energy density, LSBs benefit from the low cost, abundant supply, and light weight of sulfur.

However, LSBs inherit the dendrite formation problem associated with the Li-metal anode and face additional challenges from the sulfur cathode, among which the notorious ‘shuttle effect’. With a cyclic ring (cyclo-octasulfur) structure, sulfur in the cathode undergoes stepwise reduction during discharge, forming long-chain and short-chain polysulfides. The long-chain LiPS (Li₂Sₓ,4<=x<=8) can easily dissolve in the used ether-based electrolyte and diffuses out of the cathode matrix to the anode side, where it reduces and then transports back to the cathode. The resulting polysulfide shuttle effect leads to low Coulombic efficiency, anode corrosion, rapid capacity decay, and fast battery failure, sabotaging the practical utilization of Li-S battery technology.

Efforts to overcome these problems have included attempts to improve the separator. The primary function of the separator in a Li-based battery is to electrically isolate the active cathode and anode materials while allowing free transportation of Li⁺ ions. Polyolefin-based membranes, including polypropylene (PP) and polyethylene (PE), characterized by large (up to hundreds of nanometers) and non-uniform micropores, are commonly used as battery separators. However, these separators cannot fulfill their two fundamental roles since they cannot block polysulfide crossover and cannot facilitate Lit transportation effectively. The hydrophobic nature of these separator materials prevents any chemical mechanisms from expediting Li⁺ transportation. Additionally, they lack functional groups that can actively regulate ion transport to enhance Li⁺ diffusion and its transference number.

The extruded polyolefin films used in commercial separators cannot, by themselves, address the challenges of LiPS shuttling and Li-metal dendrite formation. A separator that allows active LiPS shuttling between two electrodes does not fulfill its essential function. Therefore, modifying the separator to shut off LiPS shuttling is a straightforward and attractive strategy. Blocking the LiPS pathway can be achieved via pore size downscaling to a few nanometers, which allows Li⁺ transportation but prevents LiPS movement. Another attractive method is to graft polar functional groups onto the separator, creating strong intermolecular forces between these groups and LiPS, thus confining them to the cathode side.

While significant research efforts have been dedicated to immobilizing polysulfides within the cathode host, achieving effective separation using the separator remains a viable solution to polysulfide shuttling. Modifying the separator by reducing pore size or functionalizing it to facilitate uniform and rapid Li⁺ transfer and block the polysulfide pathway emerges as a promising approach to mitigate both the lithium dendrite problem and the shuttle effect in LMBs and LSBs. This would also positively impact the Li-metal anode performance, as a separator with uniform nanoscale pore distribution and functional chemical groups could promote consistent and uniform Lit flux at the anode surface.

However, despite being an indispensable component of batteries, the passive separator does not actively contribute to any battery capacity. With a typical thickness of 20-30 μm, it occupies a significant portion of the battery volume. Reducing the thickness of the separator can help increase the battery's volumetric energy density. For instance, replacing a 30 μm thick separator with a 10 μm ultrathin one could increase the energy density of an NCM811-based LIB from 700 to 820 WhL⁻¹. Reduction of internal resistance is another merit of ultrathin separators. Yet, these ultrathin PP or PE separators lack the necessary puncture strength and penetration resistance crucial for battery manufacturing. Moreover, they do not possess enough mechanical strength to endure long-term battery cycling and cannot prevent Li dendrite penetration if a Li-metal anode is used.

Contemplated herein is a functional ultrathin battery separator and method for fabricating the same. According to various embodiments, a functional barrier layer or coating is applied to an ultrathin (e.g., <10 μm) flexible polymer substrate. This barrier layer serves numerous purposes. The barrier layer acts as a Li-ion flux regulator, facilitating a uniform flux on the Li-metal anode which helps reduce the formation of dendrites in batteries with Li-metal anodes (e.g., LMB, LSB, etc.). The barrier layer also acts as a filter that allows Li ions to pass through while blocking other species such as polysulfides, helping to address the polysulfide shuttling problem in LSBs.

The contemplated functional barrier layer protects the separator, giving it enough mechanical strength to endure the battery cycling while also benefitting from an increased battery volumetric energy density due to its ultrathin nature. In addition to strength, the functional barrier layer also improves the wettability of the separator to the liquid electrolyte. The affinity between the separator and electrolyte is closely associated with ionic conductivity and internal resistance. Efficient wetting not only improves the performance of the battery by enhancing ion transportation but also reduces the time required for electrolyte filling, simplifying manufacturing processes and extending the battery life cycle.

Furthermore, the contemplated battery separator is also a Li ion transportation booster that increases Li ion conductivity and transference number, according to various embodiments. This means a battery using the contemplated separator can be charged and discharged faster, and with higher power.

It should be noted that while this disclosure will mainly focus on embodiments of the contemplated separator that are designed for use in a Li-metal battery, other embodiments of the contemplated ultrathin separator may be adapted for other uses including, but not limited to, gas separation and the like. Some embodiments of the contemplated separator may be thought of as very thin, flexible, sturdy molecular sieves. Those skilled in a variety of arts will recognize that there are numerous potential applications for such a technology.

Additionally, much of the discussion will focus on a small number of very specific embodiments. Samples of these embodiments have been fabricated and characterized to illustrate the various advantages the contemplated separator provides over conventional approaches. However, it should be remembered that these are non-limiting examples, and although much of the discussion will center on specific implementations of the functional barrier layer and polymer substrate, other embodiments may employ other forms of the contemplated barrier and/or substrate, as will be discussed below.

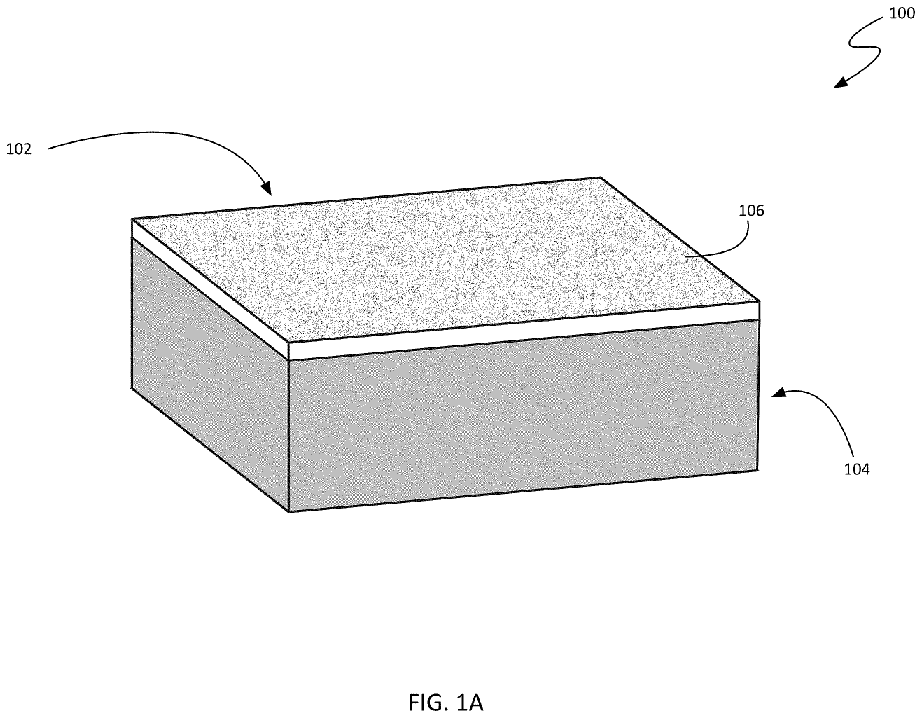

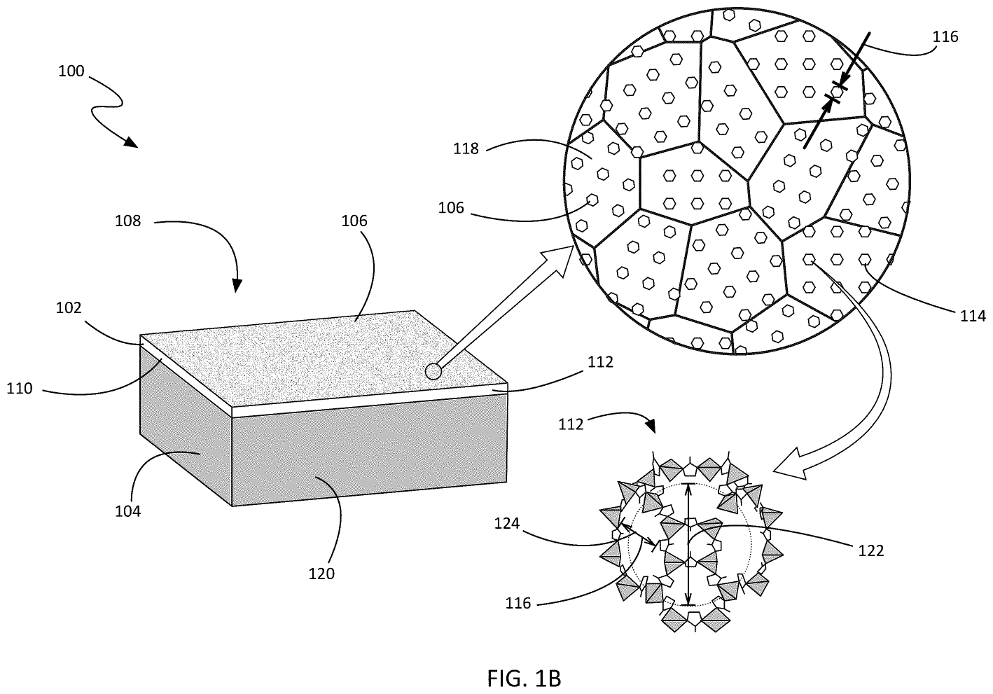

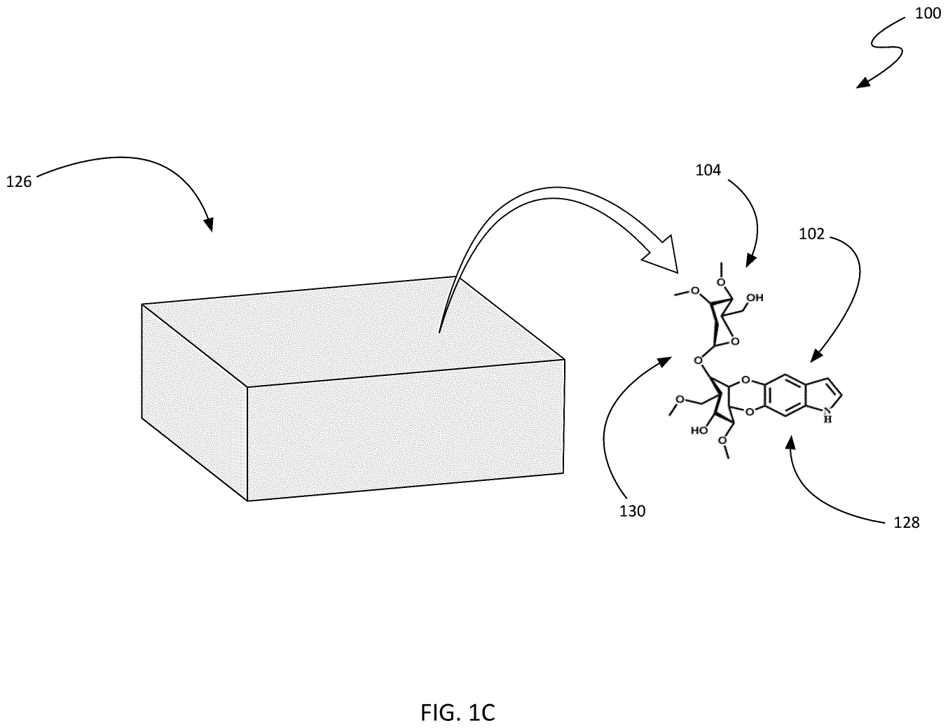

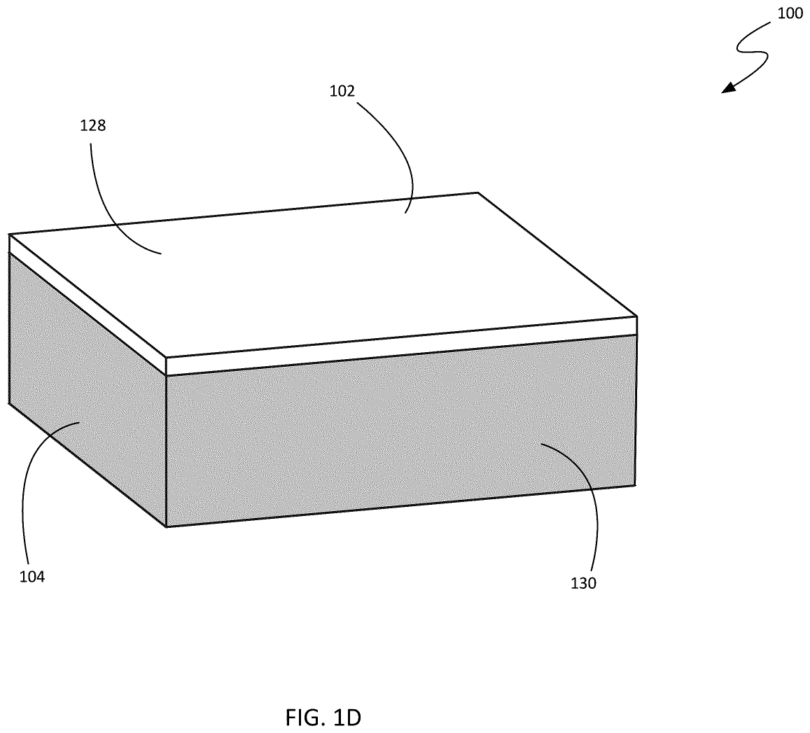

FIGS. 1A-1D show various views of non-limiting examples of a functional ultrathin battery separator 100. Specifically, FIG. 1A shows a perspective view of the general structure of the contemplated battery separator 100. FIG. 1B shows a perspective view of a non-limiting example of a metal-organic framework-based embodiment of the battery separator 100, with a close-up view of the functional barrier layer 102. FIGS. 1C and 1D show a perspective view of a non-limiting examples of a polydopamine-based embodiment of the battery separator 100. Each will be discussed in turn.

As shown, the contemplated ultrathin battery separator 100 comprises a functional barrier layer 102 deposed on a polymer substrate 104. Polymer substrates have been used as conventional battery separators for a long time, and suffer from the previously discussed problems of lithium dendrite formation and polysulfide shuttling. The addition of the contemplated functional barrier layer 102 addresses these problems through chemical, electrostatic, and physical interactions, as will be discussed below.

In some embodiments, including the non-limiting example shown in FIG. 1A, the functional barrier layer 102 may comprise a plurality of micropores 106 (i.e., pores with width <2 nm per IUPAC classification). In other embodiments, the functional barrier layer 102 may be porous, and may have pores larger than micropores. Such embodiments may employ other interactions with lithium ions and polysulfides to address the problems discussed above.

In addition to inhibiting the formation of lithium dendrites and the shuttling of polysulfides, the contemplated battery separator 100 can be very thin. According to various embodiments, the contemplated ultrathin battery separator 100 is less than 10 μm thick. This is mostly due to the novel functional barrier layer 102, which in some embodiments is less than 2 μm thick. Additionally, the functional barrier layer 102 is not as fragile or brittle as previous attempts at creating a functionalized barrier, allowing it to be used with a thin substrate. In some embodiments, the polymer substrate 104 may be less than 9 μm thick.

Because the contemplated battery separator 100 is able to be so thin, it takes up less of the total volume of the battery, increasing the overall power density. For instance, replacing a 30 μm thick separator with a 10 μm ultrathin separator 100 could increase the energy density of an NCM811-based LIB from 700 to 820 WhL⁻¹.

It should be noted that while much of the discussion is focused on ultrathin separators 100, the contemplated functional barrier layers 102 may be advantageously applied to thicker polymer substrates 104, enjoying the benefits that are not directly related to separator thickness. Furthermore, other embodiments of the battery separator 100 may employ thicker functional barrier layers 102, which may be advantageous in certain applications.

Previous attempts to solve the challenges of polysulfide shuttling and lithium dendrite formation have lacked the appropriate physical and chemical pore structure, making them less effective, or have been constrained to thicknesses that limit the overall performance. According to various embodiments, the contemplated ultathin battery separator 100 can be implemented with various functional barrier layers 102.

In some embodiments, the functional barrier layer 102 may be based on metal-organic frameworks 110 (MOFs), whose metallic nodes and organic ligands result in highly ordered and tunable pore size structures. MOFs 110 possess precisely controllable sub-nanoscale structures that can accommodate liquid electrolytes, serve as ion/molecule sieves to both block polysulfide transfer and regulate/enhance Li⁺ transportation, and homogenize Li⁺ flux on the Li-metal surface to inhibit dendrite formation. A specific, non-limiting example of a separator 100 comprising a compact, polycrystalline MOF 110 functional barrier layer 102 will be discussed in the context of FIG. 1B. Furthermore, a characterization of samples of said non-limiting example will also be discussed.

In other embodiments, the functional barrier layer 102 may be composed of polydopamine 128 (hereinafter PDA 128). Polydopamine 128 is a biopolymer. With phenolic hydroxyl, ortho-quinone, amine, and imine functional groups, PDA 128 can strongly bind with many molecules, including LiPS. In some embodiments, the PDA 128 may be applied as a layer on top of a thin film of polymer substrate 104. In other embodiments, the PDA 128 may be deposed as monomers on fibers of a polymer substrate 104, which then becomes the battery separator 100 as the monomers are polymerized into PDA 128. Both variations will be discussed in the context of FIGS. 1C and 1D. Furthermore, a characterization of samples of a non-limiting example of a separator 100 composed of bacteria cellulose 130 whose fibers are coated with PDA 128 (as shown in FIG. 1C).

In still other embodiments, combinations of materials may be used in the functional barrier layer 102. For example, while in some embodiments the functional barrier layer 102 may be composed entirely of PDA 128, in other embodiments PDA 128 may be used in conjunction with a layer of metal-organic framework 110 material.

In some embodiments, the functional barrier layer 102 may be deposed on one side of the polymer substrate 104. In other embodiments, the functional barrier layer 102 may cover both sides of the polymer substrate 104. This may be a function of the method of fabrication, or may be done deliberately. Many of the non-limiting examples shown in the Figures have a functional barrier layer 102 on a single side of the polymer substrate 104; this should not be interpreted as a limitation.

As shown, the functional barrier layer 102 is deposed on a polymer substrate 104. The polymer substrate 104 gives mechanical strength to the battery separator 100, helping it to withstand the strain of repeated charge/discharge cycles. According to various embodiments, the battery separator 100 may employ various different polymer substrates 104 including, but not limited to, the extruded plastics common to conventional separators (e.g., polyethylene (PE), polypropylene (PP), etc.), as well as natural polymers and cellulose (e.g., plant-derived cellulose, bacteria cellulose (BC), etc.). Those skilled in the art will recognize that the contemplated separators 100, functional barrier layers 102, and fabrication methods may be applied to other polymer substrates 104 known in the art.

In some embodiments, the polymer substrate 104 may be ultrathin (i.e., less than 10 μm thick), which combined with a thin functional barrier layer 102 can yield a battery with a higher energy density that what can be achieved with conventional separators. In other embodiments, the polymer substrate 104 may be thicker, which may be advantageous in certain applications (e.g., use cases where mechanical strength is of greater importance than overall energy density, etc.).

According to various embodiments, the polymer substrate 104 is flexible. This makes manufacturing easier and can result in a more rugged, durable battery. Many embodiments of the functional barrier layer 102 are able to flex with the polymer substrate 104, without cracking or suffering a structural failure that would impact its ability to prevent dendrites or polysulfide shuttling. Such functional barrier layers 102 may be referred to as being “crack-free”. In other embodiments, the polymer substrate 104, and the separator 100 as a whole, may be rigid, which may be desirable, or at least tolerable, in particular use cases that place demands, mechanical or otherwise, that are more extreme than those placed on standard lithium-based batteries.

There are a number of different embodiments of the contemplated ultrathin battery separator 100 that employ various functional barrier layers 102 and/or polymer substrates 104 combinations. Much of the discussion in the present disclosure will be focused on two particular material combinations, a metal-organic framework 110 deposed on a polypropylene 120 substrate, and polydopamine 128 with a bacteria cellulose 130 substrate. However, it should be noted that these are non-limiting examples, and that other embodiments may make use of different materials, while operating under the same principles that guided the creation of the novel combinations shown in FIGS. 1B-1D.

FIG. 1B shows a perspective view of a non-limiting example of a metal-organic framework-based embodiment of the battery separator 100, with close-up views of the functional barrier layer 102. Specifically, FIG. 1B shows a non-limiting example of an ultrathin battery separator 100 comprising a functional barrier layer 102 of a zinc imidazolate metal organic framework material deposed on a flexible polymer substrate 104 of polypropylene 120.

As previously discussed, some embodiments of the functional barrier layer 102 may utilize metal-organic frameworks 110 (MOFs), whose metallic nodes and organic ligands result in highly ordered and tunable pore size structures. MOFs possess precisely controllable sub-nanoscale structures that can accommodate liquid electrolytes, serve as ion/molecule sieves to both block polysulfide transfer and regulate/enhance Li⁺ transportation, and homogenize Li⁺ flux on the Li-metal surface to inhibit dendrite formation.

In some embodiments, including the non-limiting example shown in FIG. 1B, the functional barrier layer 102 may comprise a zeolitic imidazolate framework, specifically a zinc imidazolate metal organic framework material (hereinafter ZIF-8 112 or ZIF 108). Among a variety of MOFs, ZIF-8 112 stands out due to its suitable pore size as well as its high thermal and chemical stability. Other embodiments may employ other, similar materials (e.g., similar zeolitic imidazolate frameworks, similar metal organic frameworks, etc.). Because of their highly ordered and tunable pore sizes, MOFs may be chosen for specific use cases that would benefit from pore sizes different from those offered by ZIF-8 112.

The unit cell structure of ZIF-8 112 is shown in FIG. 1B. The lattice structure consists of a Zn(II) ion tetrahedrally coordinated with four 2-methylimidazolate ligands via Zn—N bonds. When 2-methylimidazole (C₄H₆N₂, MIM) loses a proton, it becomes 2-methylimidazolate (C₄H₅N₂⁻, MIM⁻). The deprotonated nitrogen (N⁻) coordinates with a Zn²⁺ ion. Additionally, the second nitrogen in the imidazolate ring, which is not deprotonated, has a lone pair of electrons that can interact with another Zn²⁺ ion, though not as strongly as the negatively charged nitrogen. Consequently, each of the four 2-methylimidazolate ligands, tetrahedrally coordinated to a Zn(II) ion, bridges to another Zn(II) ion. This interaction forms a 3D network that can be visualized as a tetrahedral coordination geometry around each zinc ion, with each 2-methylimidazolate ligand bridging two zinc centers. Thus formed ZIF-8 features a pore diameter 122 of approximately 11.6 Å and a pore aperture 124 of 3.4 Å. ZIF-8 112 combines the advantages of both MOFs and zeolites, exhibiting properties such as high crystallinity, porosity, and remarkable chemical and thermal stability.

According to various embodiments, ZIF-8 112 may be deposed as a functional barrier layer 102 in the form of a polycrystalline layer on a polymer substrate 104. In the specific, non-limiting example shown in FIG. 1B (and characterized elsewhere), polycrystalline ZIF-8 112 may be deposed on a polymer substrate 104 composed of polypropylene 120 (or PP 120). Because this non-limiting example of the contemplated ultrathin battery separator 100 will be discussed at length, including experimental characterization of fabricated samples, this specific embodiment with a ZIF-based functional barrier layer 102 deposed on a flexible polypropylene 120 substrate will hereinafter be referred to as a ZIF@PP separator 108, or simply ZIF@PP 108.

It should be noted that although the ZIF@PP separator 108 will be discussed at length, it is a non-limiting example of one of a variety of embodiments of the contemplated battery separator 100. Other embodiments comprising a functional barrier layer 102 composed of ZIF-8 112 may utilize a substrate made of other polymers including, but not limited to, the extruded plastics common to conventional separators (e.g., polyethylene (PE), polypropylene (PP), etc.), as well as natural polymers and cellulose (e.g., plant-derived cellulose, bacteria cellulose (BC), etc.).

The MOF-based functional barrier layer 102 is polycrystalline (i.e., composed of crystalline grains 118) and compact. In the context of the present description and the claims that follow, a polycrystalline functional barrier layer 102 is compact when diffusion pathways 114 through the functional barrier layer 102 are limited to a cutoff size 116, and the diffusion pathways 114 that are largest are located within grains 118 of the polycrystalline functional barrier layer 102 rather than between grains 118. Put differently, there is no grain boundary effect in a compact MOF thin film or layer. Compact MOF-based functional barrier layers 102 may also be referred to as being “crack free”.

The description of “compact” is an indicator of predictability. One of the advantages of metal-organic frameworks 110, and particularly ZIF-8 112, is the highly ordered and tunable pore size structures. In a compact MOF film, the largest diffusion pathways 114 are limited to those defined by the highly ordered and tunable pore structures, making them predictable and relatively uniform. In contract, a non-compact MOF film will also allow molecules to pass through the voids between grains, which are not uniform and could not be described accurately as having a cutoff size 116. Because of the predictable nature of the compact MOF-based functional barrier layer 102, it can be considered to have a molecular sieve function.

In some MOF-based embodiments, including the non-limiting example shown in FIG. 1B, the functional barrier layer 102 may be composed of ZIF-8 112. ZIF-8 112 is an attractive barrier material for a number of reasons. In addition to having high thermal and chemical stability, the structure of ZIF-8 112 includes a micropore 106 whose size is well suited for physically inhibiting the polysulfide shuttling effect.

Each unit cell of ZIF-8 112 contains a single micropore 106 with a pore diameter 122 of ˜11.6 Å and a pore aperture 124 of 3.4 Å. But the rotation of MIM ligands allows molecules with kinetic diameters of up to 6.7 Å to diffuse through the framework. In DOL/DME (i.e., a common solvent mixture that serves as a medium for dissolving lithium salts to form an electrolyte), the solvated polysulfides exist in many forms but generally have a size >10 Å, while the solvated Lit and free Lit are only 6.4 Å and 1.8 A, respectively. Therefore, the micropore 106 of ZIF-8 112 (e.g., a functional barrier layer 102 with a cutoff size 116 of ˜6.7 Å) can effectively block polysulfides while allowing Li⁺ transport. Small de-solvated polysulfides may enter the pores, but they can be trapped there due to the presence of the MIM ligand in ZIF-8 112 which contains a positively charged nitrogen atom (N⁺—CH₃) in the imidazole ring. According to various embodiments, a ZIF@PP separator 108 can function as an ionic sieve, selectively transporting Li⁺ while simultaneously preventing the shuttle effects of polysulfides species.

Many MOF materials exhibit a strong Lewis acid-base interaction with LiPSs. In the case of ZIF-8 112, the Zn metal acts as a Lewis acid center, effectively trapping polysulfides in the pores of ZIF-8 112 through strong interactions with the polysulfide soft Lewis base. This interaction plays a role in anchoring sulfur. Additionally, the N-rich functional groups present in ZIF-8 112 facilitate the trapping of LiPSs by forming Li—N bonds. Therefore, besides physically inhibiting polysulfide shuttling through sub-nanoscale micropores 106, the ZIF-8 112 functional barrier layer 102 can also capture and confine LiPSs by chemical interactions.

It should be noted that the effective kinetic aperture size of ZIF-8 112 discussed above is idealized. The actual behavior and sizing of the pore aperture 124 may be affected by other factors, including the manner of fabrication. For example, in some embodiments deposing the functional barrier layer 102 using electrodeposition, the electric field may distort the lattice of the ZIF-8 112 and change the size of the pore aperture 124. However, although the specific dimensions may vary, it has been shown through theory and experimentation that the micropores 106 of a functional barrier layer 102 composed of ZIF-8 112 are effective in physically blocking the shuttling of polysulfides.

In some embodiments, the cutoff size 116 may be 6.7 Å. In other embodiments, the cutoff size 116 may be less than 10 Å. In still other embodiment, the cutoff size 116 may be different, adapting a MOF-based functional barrier layer 102 for acting as a molecular sieve for compounds beyond the LiPS.

FIGS. 1C and 1D show perspective views of two non-limiting examples of a polydopamine-based embodiment of the contemplated ultrathin battery separator 100. Specifically, FIG. 1C shows a non-limiting example of a battery separator 100 where the functional barrier layer 102 is formed after being deposed on the polymer substrate 104, in this case being nanofibers of bacteria cellulose 130. FIG. 1D shows a non-limiting example of a battery separator 100 where the functional barrier layer 102 is polydopamine 128 that has been deposed on a thin film of bacteria cellulose 130. Each will be discussed, in turn.

According to various embodiments, the functional barrier layer 102 may be composed of polydopamine 128 (hereinafter PDA 128). Polydopamine 128 is a biopolymer. With phenolic hydroxyl, ortho-quinone, amine, and imine functional groups, PDA 128 can strongly bind with many molecules, including LiPS. In some embodiments, this ability to bond with many other materials may be used to attach another functional barrier layer 102 to a polymer substrate 104. As a specific example, in one embodiment a layer of PDA 128 may be applied to a polymer substrate 104 composed of flexible PP 120 before forming a layer of ZIF-8 112 through interfacial growth. This example will be discussed further, below.

Natural polymers and cellulose have gained traction in developing multifunctional separators for Li—S and other battery technology. This is particularly true for bacteria cellulose 130 (BC 130), which is superior to plant-derived celluloses because its higher purity and better crystallinity vest it with much better mechanical, thermal, and chemical properties.

While nanocellulose offers its dense network as a physical trap, the presence of polydopamine 128 in the battery separator 100 offers polar functional groups which not only have a high binding energy towards the polysulfides but also helps in redistribution of the Li⁺ ions across it.

The contemplated ultrathin battery separator 100 comprises a functional barrier layer 102 deposed on a polymer substrate 104. In some embodiments, the polymer substrate 104 may be a thin film or membrane, with the functional barrier layer 102 deposed on it as a film or coating. See, for example, the ZIF@PP separator 108 of FIG. 1B and the PDA-based separator 100 shown in FIG. 1D.

This concept of pairing a functional barrier layer 102 with a polymer substrate 104 can be extended to embodiments where the polymer substrate 104 is not in the form of a thin film or membrane when it is being introduced to what is, or will become, a functional barrier layer 102.

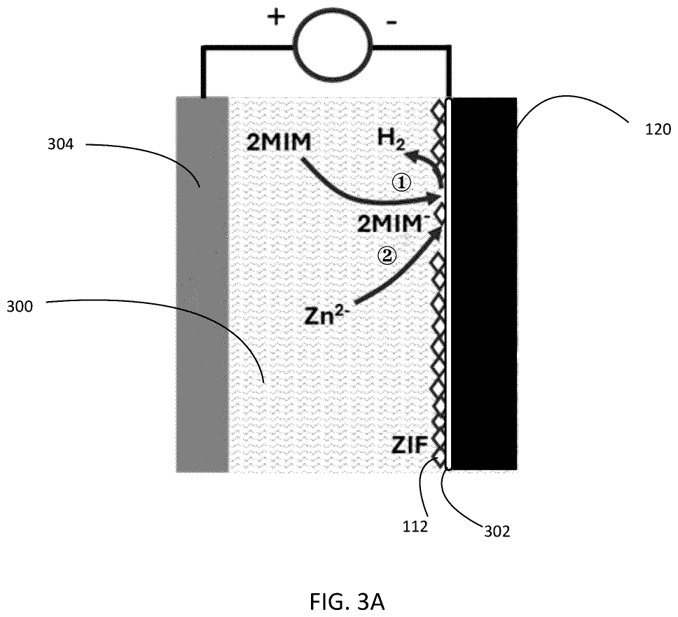

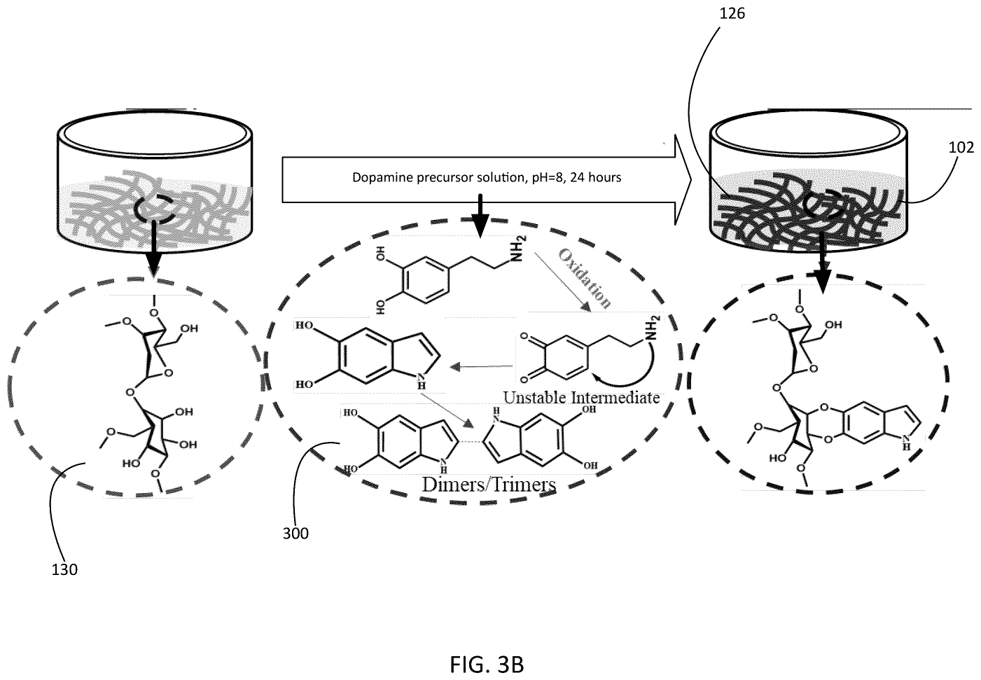

FIG. 1C shows a non-limiting example of such an embodiment. This particular PDA-based battery separator 100 could also be referred to as a polydopamine-functionalized bacteria cellulose membrane. According to various embodiments, it is formed by first functionalizing nanofibers of bacteria cellulose 130 with dopamine. Those functionalized nanofibers are then formed into a membrane through the polymerization of dopamine. The resulting lithophilic PDA@BC membrane with a uniform pore distribution can strongly bind LiPS and regulate Li⁺ transportation, thus helping address the two challenging problems of LiPS shuttling and Li dendrite formation in Li—S chemistry. The method for fabricating this PDA-based battery separator 100 (hereinafter referred to as a PDA@BC separator 126) will be discussed in greater detail, in the context of FIG. 3B, below.

It should be noted that the presentation of the chemical structure of PDA@BC separator 126 in FIG. 1C is more symbolic than a strict or limiting representation. According to various embodiments, the nanofibers will be polymerized segments of BC 130 of varying length, and the network of polydopamine 128 can extend in a variety of ways, as is known in the art. The structure and characterization of fabricated samples of PDA@BC separator 126 will be discussed at length, below.

FIG. 1D shows a non-limiting example of another embodiment of a PDA-based battery separator 100. This separator 100 has a structure that is more like the MOF-based embodiments discussed with respect to FIG. 1B. A functional barrier layer 102 of polydopamine 128 is deposed on a surface of a thin film of bacteria cellulose 130. It is important to note that this form of the contemplated ultrathin battery separator 100 is not what is being referred to as a PDA@BC separator 126. The PDA@BC separator 126 is specific to the functionalized nanofiber embodiment shown in FIG. 1C.

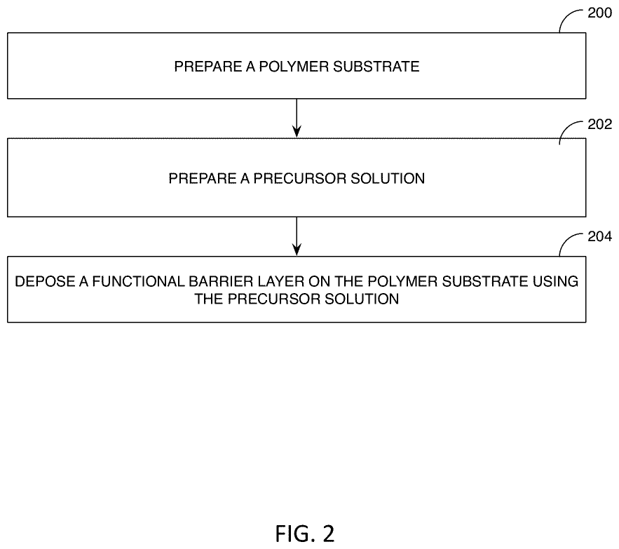

FIG. 2 is a process flow for a non-limiting example of a method for fabricating the contemplated functional ultrathin battery separator 100. The process begins with preparing the polymer substrate 104 (step 200) and a precursor solution (step 202). These preparations may typically be done in any order, and in some embodiments, may be trivial. For example, in some embodiments the battery separator 100 may be fabricated using a commercial polymer substrate 104, or a premade thin film or membrane whose preparation would simple entail whatever is needed to accomplish the third step, deposing the functional barrier layer 102.

In other embodiments, preparation of the polymer substrate 104 may require the synthesis of the polymer substrate 104. In still other embodiments, the preparation may comprise breaking down the polymer substrate 104 from one state into another. For example, according to various embodiments, the polymer substrate 104 of the PDA@BC separator 126, bacteria cellulose 130, may be prepared by impelling a sheet of bacteria cellulose 130 in water to form a suspension of BC nanofibers.

The preparation of the precursor solution will depend on the nature of the functional barrier layer 102. The precursor solution is simply a precursor to the material of the functional barrier layer 102, in a form that is adapted for deposition upon the polymer substrate 104. The precursor solution may also depend on the desired method of deposition.

Once the preparations are complete, a functional barrier layer 102 is deposed on the polymer substrate 104 using the precursor solution (step 204). As those with skill in the art know, there are a variety of ways to depose a thin film or coating of a polymer or polycrystalline material on a substrate. The exact nature of the method of deposition will depend on the nature of the materials (e.g., polymer substrate 104, functional barrier layer 102) being used. Other factors that will influence the method used include scalability and reliability, according to various embodiments.

The precise method for fabricating the contemplated separator may vary depending on the polymer substrate 104 being used. For example, bacteria cellulose 130 may be functionalized with polydopamine 128 while in the form of a nanofiber suspension, and then polymerized. Polypropylene 120, on the other hand, may be formed as a polymer film, onto which ZIF-8 112 is coated using electrodeposition. These two specific examples will be discussed in detail, below. However, they should not be taken as limiting. In other embodiments, these techniques may be applied to different functional barrier layer 102/polymer substrate 104 combinations. Additionally, in some embodiments, additional techniques may be employed that may be advantageous to the particular functional barrier layer 102 and/or polymer substrate 104 being used to fabricate the contemplated ultrathin battery separator 100.

The contemplated ultrathin battery separator 100 is an elegant solution to difficult problems, and is based on an approach that can be implemented with a variety of materials. A more meaningful discussion of the method of fabrication may be had by focusing on some specific, non-limiting examples, such as the fabrication of the ZIF@PP separator 108 and the PDA@BC separator 126.

FIG. 3A is a schematic view of a non-limiting example of the cathodic electrodeposition of polycrystalline ZIF-8 112 onto a porous polypropylene 120 membrane (i.e., the polymer substrate 104). In the broad field of MOF-based membrane technology, although many synthesis techniques have been developed, preparing uniform, crack-free, and compact MOF layers with a sub-μm thickness on flexible porous substrates has remained a challenge. Conventional MOF powder coating is excluded for being too thick, often tens of micrometers. Techniques such as layer-by-layer assembly and phase transformation interfacial growth could fulfill this purpose, but they usually need tens of hours for deposition, and hence are not suitable for large-scale battery separator applications. According to various embodiments, a cathodic (electro) deposition method allows the fabrication of compact MOF films with shorter synthesis time while also providing control over the thickness and morphology.

First, the polymer substrate 104 is prepared. In non-limiting example of a method for the fabrication of a ZIF@PP separator 108, the polymer substrate 104 may be a commercial polypropylene 120 membrane that is porous. According to various embodiments, the preparation comprises sputtering a metal coating 302 (e.g., gold, etc.) on the polymer substrate 104. The metal coating 302 is used as the cathode and as the hydrogen evolution catalyst. As a specific example, a commercial PP 120 membrane was prepared by sputtering a few nanometers thick gold coating to act as a conductive substrate for the in-situ growth of ZIF-8 112 using the current-driven electrosynthetic method.

Next, a precursor solution 300 is prepared. According to various embodiments, preparing the precursor solution 300 for this non-limiting example of a method for fabricating a ZIF@PP separator 108 comprises the preparation of two solutions, an aqueous solution of 2-Methylimidazole (MIM), and another aqueous solution of zinc acetate dihydrate (Zn(CH₃COO)₂·2H₂O). These two aqueous solutions are then mixed to form the precursor solution 300 in which the electrodeposition will be performed, according to various embodiments.

According to various embodiments, the functional barrier layer 102 may be deposed on the polymer substrate 104 through electrodeposition within the precursor solution 300, as shown in FIG. 3A. With Au/PP as the cathode, graphite paper as the anode 304, the MIM and Zn salt solution as the electrolyte (i.e., the precursor solution 300), a small current (e.g., 0.13 mA cm⁻²) is applied for electrodeposition. When MIM diffuses to the cathode surface, it is reduced by deprotonation: 2MIM+2e=2MIM⁻+H₂ (circle ‘1’ in FIG. 3A). Meanwhile, Zn²⁺ in the solution migrates to the cathode, coordinating with MIM⁻: Zn²⁺+2MIM⁻=Zn(MIM)₂ (circle ‘2’ in FIG. 3A), nucleating on the Au-coated PP surface, and eventually forming a film.

Since ZIF-8 112 is electronically insulating, deprotonation of MIM more easily occurs at the spots on the cathode where ZIF-8 112 has no perfect coverage. Therefore, electrodeposition is a self-limiting process, which ensures complete and pinhole-free coverage of ZIF-8 112 on the PP 120 substrate, while its thickness is self-limited. In some embodiments, the thickness of the ZIF-8 112 functional barrier layer 102 covering the PP 120 substrate surface may be only ˜1 μm (i.e., as thick as that of a single layer of MOF particles). It should be noted that this method of functional barrier layer 102 ZIF-8 using electrodeposition may be used to form ZIF-8 functional barrier layers 102 on other polymer substrates 104, and is not limited to PP polymer substrates 104.

As a specific example, in one embodiment a ZIF@PP separator 108 was fabricated using the following method. It should be noted that samples of this particular embodiment of the contemplated ZIF@PP separator 108 were fabricated and characterized, as will be discussed below. Two different thicknesses of PP 120 substrate were used, and will be referred to as specific examples of a ZIF@PP separator 108 followed by the PP 120 thickness.

In this specific example, 4.105 g 2-Methylimidazole (MIM) was initially dissolved in 50 ml DI water. Meanwhile, another aqueous solution was prepared by dissolving 0.183 g Zinc acetate dihydrate (Zn(CH₃COO)₂·2H₂O) in another 10 ml DI water. The two solutions were mixed and stirred to prepare the ZIF-8 precursor solution 300 for the cathodic electrodeposition.

The polymer substrates 104, 8-μm ultrathin commercial PP membranes, were coated with gold via sputtering at 20 mA for 20 seconds. The gold-coated PP membranes, along with a graphite paper, were positioned parallel to each other with a separation distance of 1.5 cm and soaked in the ZIF-8 precursor solution 300. The current-driven cathodic electrodeposition process was performed for 60 minutes under a current density of 0.13 mA cm⁻². The resultant ZIF@PP separators 108 were thoroughly rinsed by DI water and methanol to remove the residues after the synthesis process.

The obtained ZIF-coated 8-μm PP separator was tailored and named “ZIF-8@8-μm PP” separator. Similarly, “ZIF-8@25-μm PP” separators were prepared through the same synthesis protocol while replacing the ultrathin 8-μm PP membranes by conventional 25-μm PP membranes. The fabricated composite membranes were activated in methanol and dried in vacuum oven at 80° C.

FIG. 3B is a schematic view of a non-limiting example of a method for fabricating a PDA@BC separator 126, as described above. Specifically, this is a non-limiting example of a method for fabricating a separator 126 composed up of polydopamine-coated cellulose nanofibers, as shown in FIG. 1C.

The functional barrier layer 102 of PDA 128 on BC 130 fibers can be understood through the schematic in FIG. 3B. Dopamine has an amine group (—NH), which undergoes oxidation in an alkaline environment to yield unstable intermediates. As a result, the structure undergoes cyclic rearrangement, which causes the creation of multiple nucleophilic structures with aromatic nitrogen groups. The delocalized electron density on these unstable intermediates drives the nucleophilic attachment of these oxidized dopamine molecules to the cellulose. To bind with cellulose, these intermediaries go through the Michael Addition and Schiff Base reactions. In addition, the oxidized dopamine self-polymerizes by joining and cross-linking with one another. The binding between PDA 128 and BC 130 is also accelerated by the dehydration between catechol of PDA 128 and hydroxyl groups of BC 130. The presence of amino and phenolic groups in these molecules leads to enhanced binding among them through hydrogen bonding. The resulting lithophilic PDA@BC separator 126 with a uniform pore distribution can strongly bind LiPS and regulate Li⁺ transportation, thus helping address the two challenging problems of LiPS shuttling and Li dendrite formation in Li—S chemistry.

First, the polymer substrate 104 is prepared. While in some embodiments, preparing the polymer substrate 104 may comprise forming the substrate or preparing a surface of the substrate, in the contemplated method for fabricating a PDA@BC separator 126 the preparation of the polymer substrate 104 may instead involve breaking bacteria cellulose 130 down. According to various embodiments, sheets or films of bacteria cellulose 130 are broken down in water to form a suspension of cellulose nanofibers. In a specific embodiment, a 30 g of bacteria cellulose 130 (sheets) is impelled in 100 mL of DI water to form a dispersed bacteria cellulose 130 nanofiber suspension. These nanofibers will be the polymer substrate.

Next, the precursor solution 300 is prepared. The precursor solution 300 is the precursor to polydopamine 128, according to various embodiments. In the specific embodiment, polydopamine hydrochloride (i.e., 2 gL⁻¹) and 10 mM tris-HCl solution (i.e., pH=8) are combined to form the precursor solution 300 that will be used to functionalize the bacteria cellulose 130 nanofibers.

The functional barrier layer 102 is deposed on the polymer substrate 104 by first functionalizing the bacteria cellulose 130 nanofibers with the precursor solution 300, and then polymerizing the polydopamine 128. In the specific embodiment, the precursor solution 300 is added to the cellulose nanofiber suspension under vigorous stirring and left for 24 hours in the air, under a fume hood, for PDA 128 polymerization. The white color of the solution turns brownish-black due to the polydopamine coating on the BC 130. The resulting solution is then used to make a membrane via the vacuum filtration method.

The formed PDA@BC separator 126 is then washed with DI water to remove any unreacted precursors. After this step, solvent exchange with ethanol is used to remove water from the PDA@BC separator 126. The separator 126 is peeled carefully from the filter paper and kept between two glass slides for vacuum drying at 120° C. for 12 hours. The separator 126 is then roller pressed at 80° C. to reach a thickness of 30 μm, according to the specific embodiment. It should be noted that the steps of the specific embodiment may be modified and adapted for use with other materials, other techniques known in the art, and other scales, according to various embodiments.

In some embodiments, including this specific, non-limiting embodiment, the BC 130 begins in a bulk form. In other embodiments, this process may start with the BC 130 already in a thin film form. According to various embodiments, when starting with a thin film of BC 130 the polymer substrate 104 may simply be submerged in the polydopamine precursor solution 300 to coat the BC 130 film with PDA 128. This method may also be applied to other thin films, such as a PP 120 substrate, in other embodiments. The method of functionalization after thin film formation may lead to increased mechanical strength, since the resulting PDA functional barrier layer 102 is a continuous coating, rather than starting as coated fibers later formed into a membrane.

In some embodiments, the functional barrier layer 102 may comprise more than one material. In other embodiments, the battery separator 100 may comprise more than one functional barrier layer 102. For example, in some embodiments the battery separator 100 may comprise a functional barrier layer 102 composed of polycrystalline ZIF-8 112 that is deposed upon a functional barrier layer 102 composed of polydopamine 128. This approach may be advantageous in embodiments where, due to the material or the deposition method being used, a functional barrier layer 102 is difficult to depose.

As a specific example, in some embodiments a ZIF-based functional barrier layer 102 may be deposed using interfacial growth, which may be implemented by simply floating the substrate on the surface of the ZIF-8 precursor solution 300, or submerging it into the solution 300. However, PP and PE polymer substrates 104 have no chemical functional groups, making it difficult for ZIF-8 112 to nucleate. The application of a PDA functional barrier layer 102 first, however, gives the polycrystalline ZIF-8 112 a better surface for interfacial growth.

According to various embodiments, PP 120 (or other material such as BC 130) may first be submerged in the polydopamine precursor solution 300 (i.e., the polydopamine hydrochloride and tris-HCl solution) to coat with PDA 128. The PDA 128 will be coated on both surfaces and along the pore wall of the polymer substrate 104. Next, ZIF-8 112 is deposited on one surface using interfacial growth. The use of PDA as a “primer” layer does more than simply give the ZIF-8 112 better nucleation sites-it also serves as an additional functional barrier layer 102, while only slightly increasing the thickness of the resulting battery separator 100. Experiment has shown that Li—S cells using this dual functional barrier layer approach can result in a greater specific capacity than using PDA 128 alone. This primer approach may also be applied to other deposition techniques including, but not limited to, electrodeposition.

FIGS. 1A-1D show various views of non-limiting examples of a functional ultrathin battery separator 100. Specifically, FIG. 1A shows a perspective view of the general structure of the contemplated battery separator 100. FIG. 1B shows a perspective view of a non-limiting example of a metal-organic framework-based embodiment of the battery separator 100, with a close-up view of the functional barrier layer 102. FIGS. 1C and 1D show a perspective view of a non-limiting examples of a polydopamine-based embodiment of the battery separator 100. Each will be discussed in turn.

As shown, the contemplated ultrathin battery separator 100 comprises a functional barrier layer 102 deposed on a polymer substrate 104. Polymer substrates have been used as conventional battery separators for a long time, and suffer from the previously discussed problems of lithium dendrite formation and polysulfide shuttling. The addition of the contemplated functional barrier layer 102 addresses these problems through chemical, electrostatic, and physical interactions, as will be discussed below.

In some embodiments, including the non-limiting example shown in FIG. 1A, the functional barrier layer 102 may comprise a plurality of micropores 106 (i.e., pores with width <2 nm per IUPAC classification). In other embodiments, the functional barrier layer 102 may be porous, and may have pores larger than micropores. Such embodiments may employ other interactions with lithium ions and polysulfides to address the problems discussed above.

In addition to inhibiting the formation of lithium dendrites and the shuttling of polysulfides, the contemplated battery separator 100 can be very thin. According to various embodiments, the contemplated ultrathin battery separator 100 is less than 10 μm thick. This is mostly due to the novel functional barrier layer 102, which in some embodiments is less than 2 μm thick. Additionally, the functional barrier layer 102 is not as fragile or brittle as previous attempts at creating a functionalized barrier, allowing it to be used with a thin substrate. In some embodiments, the polymer substrate 104 may be less than 9 μm thick.

Because the contemplated battery separator 100 is able to be so thin, it takes up less of the total volume of the battery, increasing the overall power density. For instance, replacing a 30 μm thick separator with a 10 μm ultrathin separator 100 could increase the energy density of an NCM811-based LIB from 700 to 820 WhL⁻¹.

It should be noted that while much of the discussion is focused on ultrathin separators 100, the contemplated functional barrier layers 102 may be advantageously applied to thicker polymer substrates 104, enjoying the benefits that are not directly related to separator thickness. Furthermore, other embodiments of the battery separator 100 may employ thicker functional barrier layers 102, which may be advantageous in certain applications.

Previous attempts to solve the challenges of polysulfide shuttling and lithium dendrite formation have lacked the appropriate physical and chemical pore structure, making them less effective, or have been constrained to thicknesses that limit the overall performance. According to various embodiments, the contemplated ultathin battery separator 100 can be implemented with various functional barrier layers 102.

In some embodiments, the functional barrier layer 102 may be based on metal-organic frameworks 110 (MOFs), whose metallic nodes and organic ligands result in highly ordered and tunable pore size structures. MOFs 110 possess precisely controllable sub-nanoscale structures that can accommodate liquid electrolytes, serve as ion/molecule sieves to both block polysulfide transfer and regulate/enhance Li⁺ transportation, and homogenize Li⁺ flux on the Li-metal surface to inhibit dendrite formation. A specific, non-limiting example of a separator 100 comprising a compact, polycrystalline MOF 110 functional barrier layer 102 will be discussed in the context of FIG. 1B. Furthermore, a characterization of samples of said non-limiting example will also be discussed.

In other embodiments, the functional barrier layer 102 may be composed of polydopamine 128 (hereinafter PDA 128). Polydopamine 128 is a biopolymer. With phenolic hydroxyl, ortho-quinone, amine, and imine functional groups, PDA 128 can strongly bind with many molecules, including LiPS. In some embodiments, the PDA 128 may be applied as a layer on top of a thin film of polymer substrate 104. In other embodiments, the PDA 128 may be deposed as monomers on fibers of a polymer substrate 104, which then becomes the battery separator 100 as the monomers are polymerized into PDA 128. Both variations will be discussed in the context of FIGS. 1C and 1D. Furthermore, a characterization of samples of a non-limiting example of a separator 100 composed of bacteria cellulose 130 whose fibers are coated with PDA 128 (as shown in FIG. 1C).

In still other embodiments, combinations of materials may be used in the functional barrier layer 102. For example, while in some embodiments the functional barrier layer 102 may be composed entirely of PDA 128, in other embodiments PDA 128 may be used in conjunction with a layer of metal-organic framework 110 material.

In some embodiments, the functional barrier layer 102 may be deposed on one side of the polymer substrate 104. In other embodiments, the functional barrier layer 102 may cover both sides of the polymer substrate 104. This may be a function of the method of fabrication, or may be done deliberately. Many of the non-limiting examples shown in the Figures have a functional barrier layer 102 on a single side of the polymer substrate 104; this should not be interpreted as a limitation.

As shown, the functional barrier layer 102 is deposed on a polymer substrate 104. The polymer substrate 104 gives mechanical strength to the battery separator 100, helping it to withstand the strain of repeated charge/discharge cycles. According to various embodiments, the battery separator 100 may employ various different polymer substrates 104 including, but not limited to, the extruded plastics common to conventional separators (e.g., polyethylene (PE), polypropylene (PP), etc.), as well as natural polymers and cellulose (e.g., plant-derived cellulose, bacteria cellulose (BC), etc.). Those skilled in the art will recognize that the contemplated separators 100, functional barrier layers 102, and fabrication methods may be applied to other polymer substrates 104 known in the art.

In some embodiments, the polymer substrate 104 may be ultrathin (i.e., less than 10 μm thick), which combined with a thin functional barrier layer 102 can yield a battery with a higher energy density that what can be achieved with conventional separators. In other embodiments, the polymer substrate 104 may be thicker, which may be advantageous in certain applications (e.g., use cases where mechanical strength is of greater importance than overall energy density, etc.).

According to various embodiments, the polymer substrate 104 is flexible. This makes manufacturing easier and can result in a more rugged, durable battery. Many embodiments of the functional barrier layer 102 are able to flex with the polymer substrate 104, without cracking or suffering a structural failure that would impact its ability to prevent dendrites or polysulfide shuttling. Such functional barrier layers 102 may be referred to as being “crack-free”. In other embodiments, the polymer substrate 104, and the separator 100 as a whole, may be rigid, which may be desirable, or at least tolerable, in particular use cases that place demands, mechanical or otherwise, that are more extreme than those placed on standard lithium-based batteries.

There are a number of different embodiments of the contemplated ultrathin battery separator 100 that employ various functional barrier layers 102 and/or polymer substrates 104 combinations. Much of the discussion in the present disclosure will be focused on two particular material combinations, a metal-organic framework 110 deposed on a polypropylene 120 substrate, and polydopamine 128 with a bacteria cellulose 130 substrate. However, it should be noted that these are non-limiting examples, and that other embodiments may make use of different materials, while operating under the same principles that guided the creation of the novel combinations shown in FIGS. 1B-1D.

FIG. 1B shows a perspective view of a non-limiting example of a metal-organic framework-based embodiment of the battery separator 100, with close-up views of the functional barrier layer 102. Specifically, FIG. 1B shows a non-limiting example of an ultrathin battery separator 100 comprising a functional barrier layer 102 of a zinc imidazolate metal organic framework material deposed on a flexible polymer substrate 104 of polypropylene 120.

As previously discussed, some embodiments of the functional barrier layer 102 may utilize metal-organic frameworks 106 (MOFs), whose metallic nodes and organic ligands result in highly ordered and tunable pore size structures. MOFs possess precisely controllable sub-nanoscale structures that can accommodate liquid electrolytes, serve as ion/molecule sieves to both block polysulfide transfer and regulate/enhance Li⁺ transportation, and homogenize Li⁺ flux on the Li-metal surface to inhibit dendrite formation.

In some embodiments, including the non-limiting example shown in FIG. 1B, the functional barrier layer 102 may comprise a zeolitic imidazolate framework, specifically a zinc imidazolate metal organic framework material (hereinafter ZIF-8 112 or ZIF 108). Among a variety of MOFs, ZIF-8 112 stands out due to its suitable pore size as well as its high thermal and chemical stability. Other embodiments may employ other, similar materials (e.g., similar zeolitic imidazolate frameworks, similar metal organic frameworks, etc.). Because of their highly ordered and tunable pore sizes, MOFs may be chosen for specific use cases that would benefit from pore sizes different from those offered by ZIF-8 112.

The unit cell structure of ZIF-8 112 is shown in FIG. 1B. The lattice structure consists of a Zn(II) ion tetrahedrally coordinated with four 2-methylimidazolate ligands via Zn—N bonds. When 2-methylimidazole (C₄H₆N₂, MIM) loses a proton, it becomes 2-methylimidazolate (C₄H₅N₂⁻, MIM⁻). The deprotonated nitrogen (N⁻) coordinates with a Zn²⁺ ion. Additionally, the second nitrogen in the imidazolate ring, which is not deprotonated, has a lone pair of electrons that can interact with another Zn²⁺ ion, though not as strongly as the negatively charged nitrogen. Consequently, each of the four 2-methylimidazolate ligands, tetrahedrally coordinated to a Zn(II) ion, bridges to another Zn(II) ion. This interaction forms a 3D network that can be visualized as a tetrahedral coordination geometry around each zinc ion, with each 2-methylimidazolate ligand bridging two zinc centers. Thus formed ZIF-8 features a pore diameter 122 of approximately 11.6 Å and a pore aperture 124 of 3.4 Å. ZIF-8 112 combines the advantages of both MOFs and zeolites, exhibiting properties such as high crystallinity, porosity, and remarkable chemical and thermal stability.

According to various embodiments, ZIF-8 112 may be deposed as a functional barrier layer 102 in the form of a polycrystalline layer on a polymer substrate 104. In the specific, non-limiting example shown in FIG. 1B (and characterized elsewhere), polycrystalline ZIF-8 112 may be deposed on a polymer substrate 104 composed of polypropylene 120 (or PP 120). Because this non-limiting example of the contemplated ultrathin battery separator 100 will be discussed at length, including experimental characterization of fabricated samples, this specific embodiment with a ZIF-based functional barrier layer 102 deposed on a flexible polypropylene 120 substrate will hereinafter be referred to as a ZIF@PP separator 108, or simply ZIF@PP 108.

It should be noted that although the ZIF@PP separator 108 will be discussed at length, it is a non-limiting example of one of a variety of embodiments of the contemplated battery separator 100. Other embodiments comprising a functional barrier layer 102 composed of ZIF-8 112 may utilize a substrate made of other polymers including, but not limited to, the extruded plastics common to conventional separators (e.g., polyethylene (PE), polypropylene (PP), etc.), as well as natural polymers and cellulose (e.g., plant-derived cellulose, bacteria cellulose (BC), etc.).

The MOF-based functional barrier layer 102 is polycrystalline (i.e., composed of crystalline grains 118) and compact. In the context of the present description and the claims that follow, a polycrystalline functional barrier layer 102 is compact when diffusion pathways 114 through the functional barrier layer 102 are limited to a cutoff size 116, and the diffusion pathways 114 that are largest are located within grains 118 of the polycrystalline functional barrier layer 102 rather than between grains 118. Put differently, there is no grain boundary effect in a compact MOF thin film or layer. Compact MOF-based functional barrier layers 102 may also be referred to as being “crack free”.

The description of “compact” is an indicator of predictability. One of the advantages of metal-organic frameworks 110, and particularly ZIF-8 112, is the highly ordered and tunable pore size structures. In a compact MOF film, the largest diffusion pathways 114 are limited to those defined by the highly ordered and tunable pore structures, making them predictable and relatively uniform. In contract, a non-compact MOF film will also allow molecules to pass through the voids between grains, which are not uniform and could not be described accurately as having a cutoff size 116. Because of the predictable nature of the compact MOF-based functional barrier layer 102, it can be considered to have a molecular sieve function.

In some MOF-based embodiments, including the non-limiting example shown in FIG. 1B, the functional barrier layer 102 may be composed of ZIF-8 112. ZIF-8 112 is an attractive barrier material for a number of reasons. In addition to having high thermal and chemical stability, the structure of ZIF-8 112 includes a micropore 106 whose size is well suited for physically inhibiting the polysulfide shuttling effect.

Each unit cell of ZIF-8 112 contains a single micropore 106 with a pore diameter 122 of ˜11.6 Å and a pore aperture 124 of 3.4 Å. But the rotation of MIM ligands allows molecules with kinetic diameters of up to 6.7 Å to diffuse through the framework. In DOL/DME (i.e., a common solvent mixture that serves as a medium for dissolving lithium salts to form an electrolyte), the solvated polysulfides exist in many forms but generally have a size >10 Å, while the solvated Li⁺ and free Lit are only 6.4 Å and 1.8 Å, respectively. Therefore, the micropore 106 of ZIF-8 112 (e.g., a functional barrier layer 102 with a cutoff size 116 of ˜6.7 Å) can effectively block polysulfides while allowing Li⁺ transport. Small de-solvated polysulfides may enter the pores, but they can be trapped there due to the presence of the MIM ligand in ZIF-8 112 which contains a positively charged nitrogen atom (N⁺—CH₃) in the imidazole ring. According to various embodiments, a ZIF@PP separator 108 can function as an ionic sieve, selectively transporting Li⁺ while simultaneously preventing the shuttle effects of polysulfides species.

Many MOF materials exhibit a strong Lewis acid-base interaction with LiPSs. In the case of ZIF-8 112, the Zn metal acts as a Lewis acid center, effectively trapping polysulfides in the pores of ZIF-8 112 through strong interactions with the polysulfide soft Lewis base. This interaction plays a role in anchoring sulfur. Additionally, the N-rich functional groups present in ZIF-8 112 facilitate the trapping of LiPSs by forming Li—N bonds. Therefore, besides physically inhibiting polysulfide shuttling through sub-nanoscale micropores 106, the ZIF-8 112 functional barrier layer 102 can also capture and confine LiPSs by chemical interactions.

It should be noted that the effective kinetic aperture size of ZIF-8 112 discussed above is idealized. The actual behavior and sizing of the pore aperture 124 may be affected by other factors, including the manner of fabrication. For example, in some embodiments deposing the functional barrier layer 102 using electrodeposition, the electric field may distort the lattice of the ZIF-8 112 and change the size of the pore aperture 124. However, although the specific dimensions may vary, it has been shown through theory and experimentation that the micropores 106 of a functional barrier layer 102 composed of ZIF-8 112 are effective in physically blocking the shuttling of polysulfides.

In some embodiments, the cutoff size 116 may be 6.7 Å. In other embodiments, the cutoff size 116 may be less than 10 Å. In still other embodiment, the cutoff size 116 may be different, adapting a MOF-based functional barrier layer 102 for acting as a molecular sieve for compounds beyond the LiPS.

FIGS. 1C and 1D show perspective views of two non-limiting examples of a polydopamine-based embodiment of the contemplated ultrathin battery separator 100. Specifically, FIG. 1C shows a non-limiting example of a battery separator 100 where the functional barrier layer 102 is formed after being deposed on the polymer substrate 104, in this case being nanofibers of bacteria cellulose 130. FIG. 1D shows a non-limiting example of a battery separator 100 where the functional barrier layer 102 is polydopamine 128 that has been deposed on a thin film of bacteria cellulose 130. Each will be discussed, in turn.

According to various embodiments, the functional barrier layer 102 may be composed of polydopamine 128 (hereinafter PDA 128). Polydopamine 128 is a biopolymer. With phenolic hydroxyl, ortho-quinone, amine, and imine functional groups, PDA 128 can strongly bind with many molecules, including LiPS. In some embodiments, this ability to bond with many other materials may be used to attach another functional barrier layer 102 to a polymer substrate 104. As a specific example, in one embodiment a layer of PDA 128 may be applied to a polymer substrate 104 composed of flexible PP 120 before forming a layer of ZIF-8 112 through interfacial growth. This example will be discussed further, below.

Natural polymers and cellulose have gained traction in developing multifunctional separators for Li—S and other battery technology. This is particularly true for bacteria cellulose 130 (BC 130), which is superior to plant-derived celluloses because its higher purity and better crystallinity vest it with much better mechanical, thermal, and chemical properties.

While nanocellulose offers its dense network as a physical trap, the presence of polydopamine 128 in the battery separator 100 offers polar functional groups which not only have a high binding energy towards the polysulfides but also helps in redistribution of the Lit ions across it.

The contemplated ultrathin battery separator 100 comprises a functional barrier layer 102 deposed on a polymer substrate 104. In some embodiments, the polymer substrate 104 may be a thin film or membrane, with the functional barrier layer 102 deposed on it as a film or coating. See, for example, the ZIF@PP separator 108 of FIG. 1B and the PDA-based separator 100 shown in FIG. 1D.

This concept of pairing a functional barrier layer 102 with a polymer substrate 104 can be extended to embodiments where the polymer substrate 104 is not in the form of a thin film or membrane when it is being introduced to what is, or will become, a functional barrier layer 102.

FIG. 1C shows a non-limiting example of such an embodiment. This particular PDA-based battery separator 100 could also be referred to as a polydopamine-functionalized bacteria cellulose membrane. According to various embodiments, it is formed by first functionalizing nanofibers of bacteria cellulose 130 with dopamine. Those functionalized nanofibers are then formed into a membrane through the polymerization of dopamine. The resulting lithophilic PDA@BC membrane with a uniform pore distribution can strongly bind LiPS and regulate Li⁺ transportation, thus helping address the two challenging problems of LiPS shuttling and Li dendrite formation in Li—S chemistry. The method for fabricating this PDA-based battery separator 100 (hereinafter referred to as a PDA@BC separator 126) will be discussed in greater detail, in the context of FIG. 3B, below.

It should be noted that the presentation of the chemical structure of PDA@BC separator 126 in FIG. 1C is more symbolic than a strict or limiting representation. According to various embodiments, the nanofibers will be polymerized segments of BC 130 of varying length, and the network of polydopamine 128 can extend in a variety of ways, as is known in the art. The structure and characterization of fabricated samples of PDA@BC separator 126 will be discussed at length, below.

FIG. 1D shows a non-limiting example of another embodiment of a PDA-based battery separator 100. This separator 100 has a structure that is more like the MOF-based embodiments discussed with respect to FIG. 1B. A functional barrier layer 102 of polydopamine 128 is deposed on a surface of a thin film of bacteria cellulose 130. It is important to note that this form of the contemplated ultrathin battery separator 100 is not what is being referred to as a PDA@BC separator 126. The PDA@BC separator 126 is specific to the functionalized nanofiber embodiment shown in FIG. 1C.

FIG. 2 is a process flow for a non-limiting example of a method for fabricating the contemplated functional ultrathin battery separator 100. The process begins with preparing the polymer substrate 104 (step 200) and a precursor solution (step 202). These preparations may typically be done in any order, and in some embodiments, may be trivial. For example, in some embodiments the battery separator 100 may be fabricated using a commercial polymer substrate 104, or a premade thin film or membrane whose preparation would simple entail whatever is needed to accomplish the third step, deposing the functional barrier layer 102.

In other embodiments, preparation of the polymer substrate 104 may require the synthesis of the polymer substrate 104. In still other embodiments, the preparation may comprise breaking down the polymer substrate 104 from one state into another. For example, according to various embodiments, the polymer substrate 104 of the PDA@BC separator 126, bacteria cellulose 130, may be prepared by impelling a sheet of bacteria cellulose 130 in water to form a suspension of BC nanofibers.

The preparation of the precursor solution will depend on the nature of the functional barrier layer 102. The precursor solution is simply a precursor to the material of the functional barrier layer 102, in a form that is adapted for deposition upon the polymer substrate 104. The precursor solution may also depend on the desired method of deposition.

Once the preparations are complete, a functional barrier layer 102 is deposed on the polymer substrate 104 using the precursor solution (step 204). As those with skill in the art know, there are a variety of ways to depose a thin film or coating of a polymer or polycrystalline material on a substrate. The exact nature of the method of deposition will depend on the nature of the materials (e.g., polymer substrate 104, functional barrier layer 102) being used. Other factors that will influence the method used include scalability and reliability, according to various embodiments.

The precise method for fabricating the contemplated separator may vary depending on the polymer substrate 104 being used. For example, bacteria cellulose 130 may be functionalized with polydopamine 128 while in the form of a nanofiber suspension, and then polymerized. Polypropylene 120, on the other hand, may be formed as a polymer film, onto which ZIF-8 112 is coated using electrodeposition. These two specific examples will be discussed in detail, below. However, they should not be taken as limiting. In other embodiments, these techniques may be applied to different functional barrier layer 102/polymer substrate 104 combinations. Additionally, in some embodiments, additional techniques may be employed that may be advantageous to the particular functional barrier layer 102 and/or polymer substrate 104 being used to fabricate the contemplated ultrathin battery separator 100.

The contemplated ultrathin battery separator 100 is an elegant solution to difficult problems, and is based on an approach that can be implemented with a variety of materials. A more meaningful discussion of the method of fabrication may be had by focusing on some specific, non-limiting examples, such as the fabrication of the ZIF@PP separator 108 and the PDA@BC separator 126.

FIG. 3A is a schematic view of a non-limiting example of the cathodic electrodeposition of polycrystalline ZIF-8 112 onto a porous polypropylene 120 membrane (i.e., the polymer substrate 104). In the broad field of MOF-based membrane technology, although many synthesis techniques have been developed, preparing uniform, crack-free, and compact MOF layers with a sub-μm thickness on flexible porous substrates has remained a challenge. Conventional MOF powder coating is excluded for being too thick, often tens of micrometers. Techniques such as layer-by-layer assembly and phase transformation interfacial growth could fulfill this purpose, but they usually need tens of hours for deposition, and hence are not suitable for large-scale battery separator applications. According to various embodiments, a cathodic (electro) deposition method allows the fabrication of compact MOF films with shorter synthesis time while also providing control over the thickness and morphology.

First, the polymer substrate 104 is prepared. In non-limiting example of a method for the fabrication of a ZIF@PP separator 108, the polymer substrate 104 may be a commercial polypropylene 120 membrane that is porous. According to various embodiments, the preparation comprises sputtering a metal coating 302 (e.g., gold, etc.) on the polymer substrate 104. The metal coating 302 is used as the cathode and as the hydrogen evolution catalyst. As a specific example, a commercial PP 120 membrane was prepared by sputtering a few nanometers thick gold coating to act as a conductive substrate for the in-situ growth of ZIF-8 112 using the current-driven electrosynthetic method.

Next, a precursor solution 300 is prepared. According to various embodiments, preparing the precursor solution 300 for this non-limiting example of a method for fabricating a ZIF@PP separator 108 comprises the preparation of two solutions, an aqueous solution of 2-Methylimidazole (MIM), and another aqueous solution of zinc acetate dihydrate (Zn(CH₃COO)₂·2H₂O). These two aqueous solutions are then mixed to form the precursor solution 300 in which the electrodeposition will be performed, according to various embodiments.

According to various embodiments, the functional barrier layer 102 may be deposed on the polymer substrate 104 through electrodeposition within the precursor solution 300, as shown in FIG. 3A. With Au/PP as the cathode, graphite paper as the anode 304, the MIM and Zn salt solution as the electrolyte (i.e., the precursor solution 300), a small current (e.g., 0.13 mA cm⁻²) is applied for electrodeposition. When MIM diffuses to the cathode surface, it is reduced by deprotonation: 2MIM+2e=2MIM⁻+H₂ (circle ‘1’ in FIG. 3A). Meanwhile, Zn²⁺ in the solution migrates to the cathode, coordinating with MIM⁻:Zn²⁺+2MIM⁻=Zn(MIM)₂ (circle ‘2’ in FIG. 3A), nucleating on the Au-coated PP surface, and eventually forming a film.

Since ZIF-8 112 is electronically insulating, deprotonation of MIM more easily occurs at the spots on the cathode where ZIF-8 112 has no perfect coverage. Therefore, electrodeposition is a self-limiting process, which ensures complete and pinhole-free coverage of ZIF-8 112 on the PP 120 substrate, while its thickness is self-limited. In some embodiments, the thickness of the ZIF-8 112 functional barrier layer 102 covering the PP 120 substrate surface may be only ˜1 μm (i.e., as thick as that of a single layer of MOF particles). It should be noted that this method of functional barrier layer 102 ZIF-8 using electrodeposition may be used to form ZIF-8 functional barrier layers 102 on other polymer substrates 104, and is not limited to PP polymer substrates 104.

As a specific example, in one embodiment a ZIF@PP separator 108 was fabricated using the following method. It should be noted that samples of this particular embodiment of the contemplated ZIF@PP separator 108 were fabricated and characterized, as will be discussed below. Two different thicknesses of PP 120 substrate were used, and will be referred to as specific examples of a ZIF@PP separator 108 followed by the PP 120 thickness.

In this specific example, 4.105 g 2-Methylimidazole (MIM) was initially dissolved in 50 ml DI water. Meanwhile, another aqueous solution was prepared by dissolving 0.183 g Zinc acetate dihydrate (Zn(CH₃COO)₂·2H₂O) in another 10 ml DI water. The two solutions were mixed and stirred to prepare the ZIF-8 precursor solution 300 for the cathodic electrodeposition.

The polymer substrates 104, 8-μm ultrathin commercial PP membranes, were coated with gold via sputtering at 20 mA for 20 seconds. The gold-coated PP membranes, along with a graphite paper, were positioned parallel to each other with a separation distance of 1.5 cm and soaked in the ZIF-8 precursor solution 300. The current-driven cathodic electrodeposition process was performed for 60 minutes under a current density of 0.13 mA cm⁻². The resultant ZIF@PP separators 108 were thoroughly rinsed by DI water and methanol to remove the residues after the synthesis process.

The obtained ZIF-coated 8-μm PP separator was tailored and named “ZIF-8@8-μm PP” separator. Similarly, “ZIF-8@25-μm PP” separators were prepared through the same synthesis protocol while replacing the ultrathin 8-μm PP membranes by conventional 25-μm PP membranes. The fabricated composite membranes were activated in methanol and dried in vacuum oven at 80° C.

FIG. 3B is a schematic view of a non-limiting example of a method for fabricating a PDA@BC separator 126, as described above. Specifically, this is a non-limiting example of a method for fabricating a separator 126 composed up of polydopamine-coated cellulose nanofibers, as shown in FIG. 1C.

The functional barrier layer 102 of PDA 128 on BC 130 fibers can be understood through the schematic in FIG. 3B. Dopamine has an amine group (—NH), which undergoes oxidation in an alkaline environment to yield unstable intermediates. As a result, the structure undergoes cyclic rearrangement, which causes the creation of multiple nucleophilic structures with aromatic nitrogen groups. The delocalized electron density on these unstable intermediates drives the nucleophilic attachment of these oxidized dopamine molecules to the cellulose. To bind with cellulose, these intermediaries go through the Michael Addition and Schiff Base reactions. In addition, the oxidized dopamine self-polymerizes by joining and cross-linking with one another. The binding between PDA 128 and BC 130 is also accelerated by the dehydration between catechol of PDA 128 and hydroxyl groups of BC 130. The presence of amino and phenolic groups in these molecules leads to enhanced binding among them through hydrogen bonding. The resulting lithophilic PDA@BC separator 126 with a uniform pore distribution can strongly bind LiPS and regulate Li⁺ transportation, thus helping address the two challenging problems of LiPS shuttling and Li dendrite formation in Li—S chemistry.

First, the polymer substrate 104 is prepared. While in some embodiments, preparing the polymer substrate 104 may comprise forming the substrate or preparing a surface of the substrate, in the contemplated method for fabricating a PDA@BC separator 126 the preparation of the polymer substrate 104 may instead involve breaking bacteria cellulose 130 down. According to various embodiments, sheets or films of bacteria cellulose 130 are broken down in water to form a suspension of cellulose nanofibers. In a specific embodiment, a 30 g of bacteria cellulose 130 (sheets) is impelled in 100 mL of DI water to form a dispersed bacteria cellulose 130 nanofiber suspension. These nanofibers will be the polymer substrate.

Next, the precursor solution 300 is prepared. The precursor solution 300 is the precursor to polydopamine 128, according to various embodiments. In the specific embodiment, polydopamine hydrochloride (i.e., 2 gL⁻¹) and 10 mM tris-HCl solution (i.e., pH=8) are combined to form the precursor solution 300 that will be used to functionalize the bacteria cellulose 130 nanofibers.

The functional barrier layer 102 is deposed on the polymer substrate 104 by first functionalizing the bacteria cellulose 130 nanofibers with the precursor solution 300, and then polymerizing the polydopamine 128. In the specific embodiment, the precursor solution 300 is added to the cellulose nanofiber suspension under vigorous stirring and left for 24 hours in the air, under a fume hood, for PDA 128 polymerization. The white color of the solution turns brownish-black due to the polydopamine coating on the BC 130. The resulting solution is then used to make a membrane via the vacuum filtration method.

The formed PDA@BC separator 126 is then washed with DI water to remove any unreacted precursors. After this step, solvent exchange with ethanol is used to remove water from the PDA@BC separator 126. The separator 126 is peeled carefully from the filter paper and kept between two glass slides for vacuum drying at 120° C. for 12 hours. The separator 126 is then roller pressed at 80° C. to reach a thickness of 30 μm, according to the specific embodiment. It should be noted that the steps of the specific embodiment may be modified and adapted for use with other materials, other techniques known in the art, and other scales, according to various embodiments.

In some embodiments, including this specific, non-limiting embodiment, the BC 130 begins in a bulk form. In other embodiments, this process may start with the BC 130 already in a thin film form. According to various embodiments, when starting with a thin film of BC 130 the polymer substrate 104 may simply be submerged in the polydopamine precursor solution 300 to coat the BC 130 film with PDA 128. This method may also be applied to other thin films, such as a PP 120 substrate, in other embodiments. The method of functionalization after thin film formation may lead to increased mechanical strength, since the resulting PDA functional barrier layer 102 is a continuous coating, rather than starting as coated fibers later formed into a membrane.

In some embodiments, the functional barrier layer 102 may comprise more than one material. In other embodiments, the battery separator 100 may comprise more than one functional barrier layer 102. For example, in some embodiments the battery separator 100 may comprise a functional barrier layer 102 composed of polycrystalline ZIF-8 112 that is deposed upon a functional barrier layer 102 composed of polydopamine 128. This approach may be advantageous in embodiments where, due to the material or the deposition method being used, a functional barrier layer 102 is difficult to depose.

As a specific example, in some embodiments a ZIF-based functional barrier layer 102 may be deposed using interfacial growth, which may be implemented by simply floating the substrate on the surface of the ZIF-8 precursor solution 300, or submerging it into the solution 300. However, PP and PE polymer substrates 104 have no chemical functional groups, making it difficult for ZIF-8 112 to nucleate. The application of a PDA functional barrier layer 102 first, however, gives the polycrystalline ZIF-8 112 a better surface for interfacial growth.

According to various embodiments, PP 120 (or other material such as BC 130) may first be submerged in the polydopamine precursor solution 300 (i.e., the polydopamine hydrochloride and tris-HCl solution) to coat with PDA 128. The PDA 128 will be coated on both surfaces and along the pore wall of the polymer substrate 104. Next, ZIF-8 112 is deposited on one surface using interfacial growth. The use of PDA as a “primer” layer does more than simply give the ZIF-8 112 better nucleation sites-it also serves as an additional functional barrier layer 102, while only slightly increasing the thickness of the resulting battery separator 100. Experiment has shown that Li—S cells using this dual functional barrier layer approach can result in a greater specific capacity than using PDA 128 alone. This primer approach may also be applied to other deposition techniques including, but not limited to, electrodeposition.

### Characterization and Results

The following is a discussion of the characteristics, properties, and performance of two specific, non-limiting embodiments, the ZIF@PP separator 108 and the PDA@BC separator 126. Again, this discussion is meant to illustrate the advantages the contemplated separators 100 have over conventional battery separators, and should not be interpreted as limitations. The methods described herein may be applied to other embodiments.

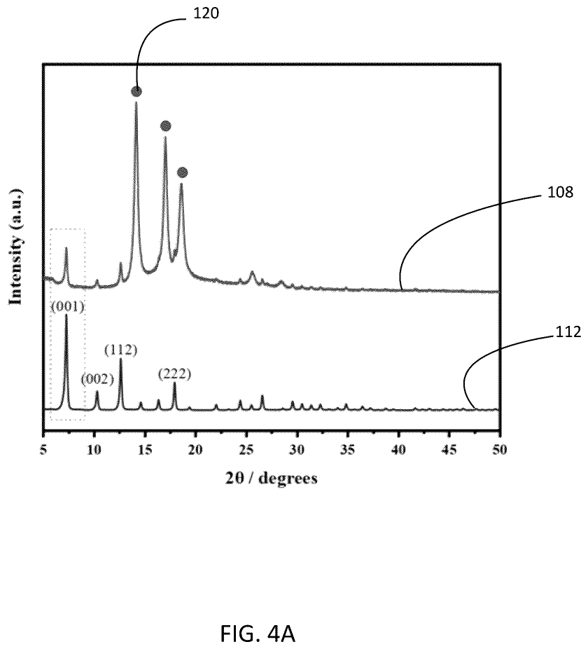

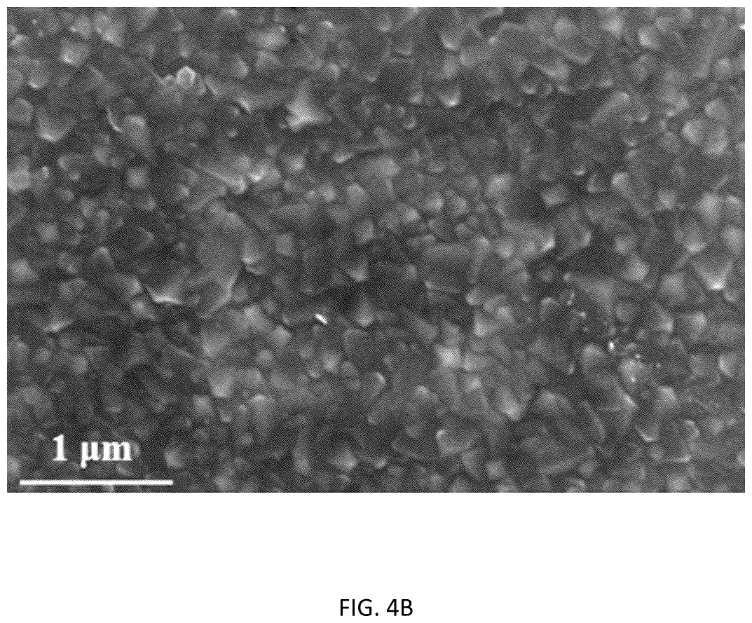

FIG. 4A shows an XRD pattern of the specific embodiment of ZIF-8@PP 108, and pure ZIF-8 crystals. FIG. 4B shows an SEM top view of ZIF-8@8-μm PP separator 108. The XRD pattern of the ZIF-8@PP membrane, as shown in FIG. 4A, reveals three distinct peaks centered at the 2θ angles of 14.0°, 16.9° and 18.5°, corresponding to the (110), (040) and (130) crystallographic planes of the PP substrate, respectively. Additionally, peaks at 7.3°, 10.35°, 12.7° and 18.0° emerge, attributed to the (001), (002), (112), and (222) planes of ZIF-8 crystals. This observation suggests the successful deposition of ZIF-8 film. By using the PP membrane substrate with different thickness (8 μm vs. 25 μm), the resultant ZIF-8 deposited PP membranes were denoted as ZIF-8@8-μm PP and ZIF-8@25-μm PP, respectively. The SEM image in FIG. 4B (top view) reveals the surface morphology of the ZIF-8 film on a PP membrane, demonstrating the formation of a crack-free and uniform layer of ZIF-8 crystals on the surface of 8 μm thick PP membrane.

X-ray photoelectron spectroscopy (XPS) analysis was carried out to study the chemical composition of the materials. The wide XPS surveys revealed Zn 2p, N 1s and O 1s peaks emerge in ZIF-8@PP samples after cathodic deposition. In the Zn 2p spectra of ZIF-8@PP, two narrow peaks are evident, corresponding to Zn 2p3/2 at 1022.2 eV and Zn 2p1/2 at 1045.1 eV, respectively. This observation suggests that the majority of zinc ions are in tetrahedral coordination. The N Is spectra of the ZIF-8@PP sample exhibits two peaks at 400 and 398.9 eV, attributed to the C═N and C—N bonds, respectively, in the 2-methylimidazole organic ligands. This observation is consistent with the C—N signal detected in the C 1s spectra of ZIF-8@PP, whereas pristine PP only contains C—C bonds without additional polar functional groups.

The elemental configuration of the studied separators was further investigated using Fourier-transform infrared (FT-IR) spectrometer. The spectrum of the pristine PP is similar to the one observed in previous studies, while the change in intensity peaks of the modified separators is evident, indicating the presence of additional functional groups introduced by the very thin ZIF-8 layer. The additional C—H bending observed in the wavelength region of 2800-3000 cm⁻¹ in the ZIF-modified separator indicates the presence of methyl groups from the ZIF-8 rings. The nitrogen-coordinated zinc atoms are confirmed by Zn—N vibrations at approximately 421 cm⁻¹. Furthermore, the C—N and C═N vibrations at approximately 1150 cm-1 and 1585 cm⁻¹, respectively, confirm the formation of functional groups due to ZIF-8 deposition.

The synthesis of continuous MOF membranes with high flexibility is practically useful and has been considered technically challenging. According to various embodiments, the ZIF-8@8-μm PP ultrathin separator 108 exhibits excellent flexibility. Even after multiple times of folding and unfolding, the in-situ formed ZIF-8 layer remained firmly affixed to the surface of the ultrathin PP separator without any obvious visual changes in the thin-film optical interference, indicating the exceptional flexibility of the ZIF-8@8-μm PP separator.

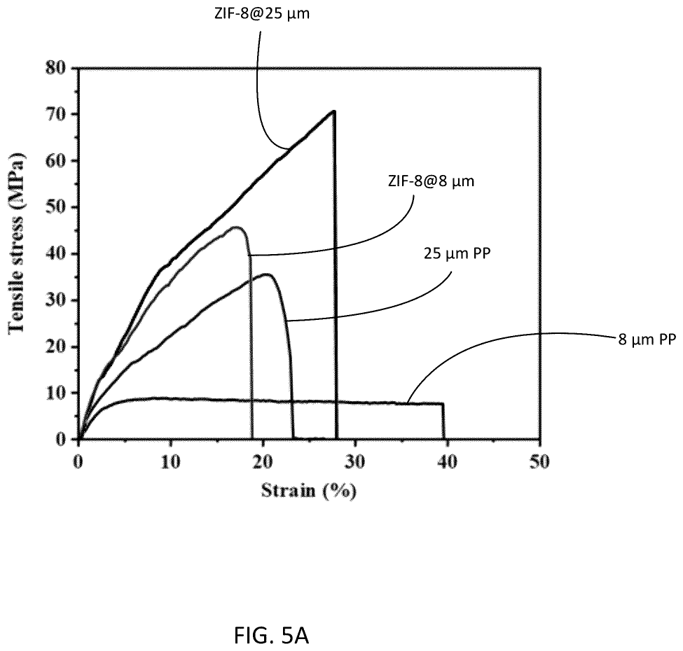

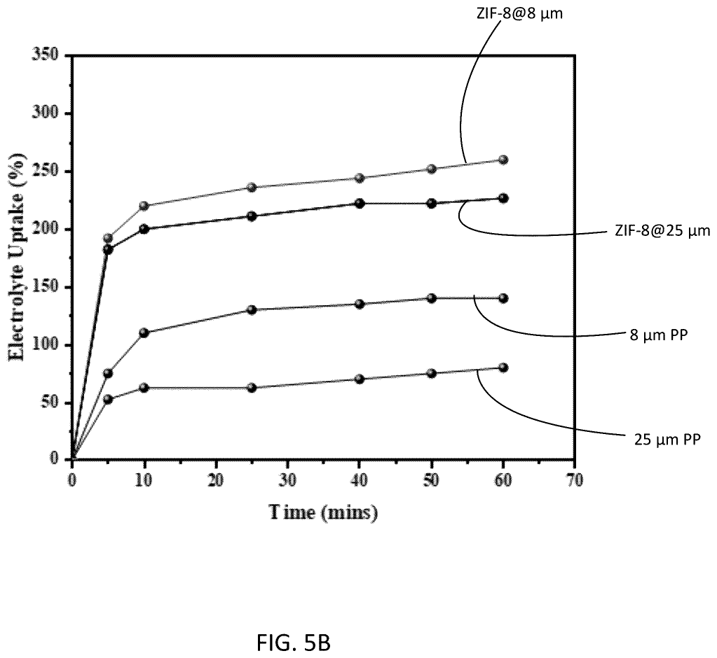

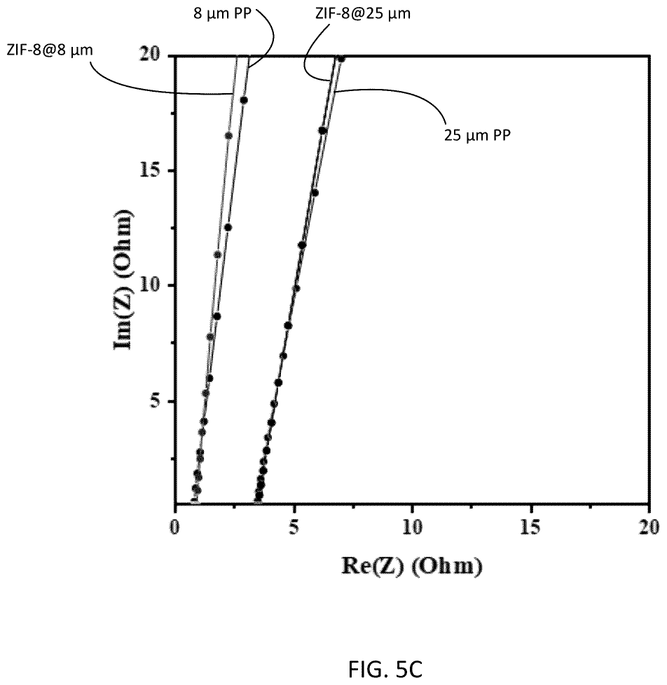

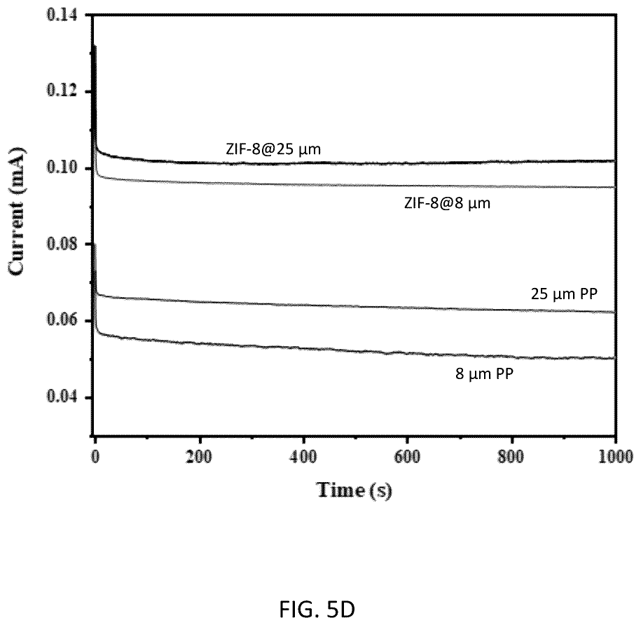

FIG. 5A examines the stress-strain characteristics of different separators under uniaxial elongation. As shown, the ZIF-8@8-μm separator demonstrated a significantly higher yield stress of approximately 45.7 MPa at a strain of 17.2%, in contrast to the pristine 8-μm PP, which exhibited a yield stress of 7.75 MPa at a strain of 39.4%. The conventional 25-μm PP separator showed a yield stress of 35.5 MPa at a strain of 20.8%, while the ZIF-8 coating increased the yield stress to 70.5 MPa at a strain of 27.8%. These results indicate that a thin ZIF-8 coating can dramatically increase the yield stress of PP separators, enabling them with superior breaking strength. This is particularly true for the fragile 8-μm PP. The tensile test confirms that the incorporation of a thin crystalline ZIF-8 layer enhances the mechanical strength, thereby overcoming the limitations of the pristine 8-μm PP.

Thermal stability is a critical factor that significantly impacts the safety and reliability of lithium-based batteries. To quantitatively characterize the thermal stability and phase changes at elevated temperatures, differential scanning calorimetry (DSC) analysis was performed. The pristine commercial PP separator shows a main endothermic peak at ˜ 160° C., which is close to the melting point of polypropylene. However, ZIF-8 modified PP membranes shift to a higher phase transition temperature with the same substrate materials. The wider temperature window indicates the improved thermal stability of ZIF-8@PP separators. Thermal shrinkage tests were performed by keeping different separators in a drying oven and the temperature was increased up to 150° C. at 5° C./min. All separators made of polypropylene material decomposed at 150° C., consistent with the DSC measurements. However, in the case of the decomposition of ZIF-8@PP separators, a coarse layer of ZIF-8 remained behind compared to pristine PP separators.

The separator, along with the electrolyte it holds, forms ionic pathways for lithium ions, aiding their transport across electrodes. Maximizing transport efficiency can be achieved by increasing the electrolyte load on separators. FIG. 5B presents the electrolyte uptake by different separators, with the ZIF-8 coating demonstrating higher electrolyte absorption. The lithophilic functional groups (—N, ═N, —Zn—N) and the cage-like porous structure of ZIF-8 enable these separators to hold a considerable amount of electrolyte, thereby enhancing electrolyte uptake.

The wettability of separators also plays a critical role in batteries, as it influences the ion transportation. A wetting test was performed by adding a droplet of the electrolyte onto the surface of each separator and observing the spread of the electrolyte over time. When a droplet of electrolyte is placed on the surface of the ZIF-8@8-μm and ZIF-8@25-μm PP separators, it rapidly spreads over and is absorbed, leading to complete wetting within 10 seconds. The affinity between the separator and electrolyte is closely associated with ionic conductivity and internal resistance. Efficient wetting not only improves the performance of the battery by enhancing ion transportation but also reduces the time required for electrolyte filling, simplifying manufacturing processes and extending the battery life cycle. In contrast, the commercial PP separator exhibits considerably less wetting under the same testing conditions, with the electrolyte drop observed to remain on the surface. Therefore, with the introduction of ZIF-8 thin film, fast and uniform wetting of the liquid electrolyte over the entire separator can be realized.

Unlike ceramic-coated separators containing low-surface-area ceramic particles or polymer materials with low Li⁺ conductivity, the crack-free ZIF-8 layer offers a higher surface area and abundant open metal sites with an appropriate pore size. This enables efficient Li⁺ transport with high Li⁺ transference number. The modification of the ZIF-8 layer allows for rapid absorption of sufficient liquid electrolyte and retention of the absorbed electrolyte throughout the discharge and charge processes. This results in lower internal resistance of both separators and batteries, contributing to excellent electrochemical performance over an extended period. Consequently, the rate capability and cycle durability of the batteries are improved. In general, achieving high ionic conductivity in separators depends on having a sufficient number of pores with appropriate sizes. Additionally, good wettability with the liquid electrolyte is essential for the ionic conductivity of separators. The electrochemical impedance spectroscopy (EIS) results in FIG. 5C indicate that cells using the ZIF-8@8-μm and 8-μm PP separators exhibit smaller internal resistance. This lower internal resistance with the thin separator compared to the thick separator is due to reduced tortuosity for Li⁺ transportation. Based on the Nyquist plots of their EIS spectra, the resistance (R) is defined at the intersection of the spectrum curve with the Zre-axis. This resistance is used to calculate Li⁺ conductivity based on the formula

$$σ = \frac{L}{R A} ,$$

where L is the thickness and A is the area of the separator. The thickness of the ZIF-8 layer has been confirmed to be approximately 1 μm. Therefore, the ZIF-8@8-μm separator was determined to have the highest Li⁺ conductivity of 0.322 mS/cm, compared to 0.307 mS/cm for the 8-μm PP separator, 0.235 mS/cm for the ZIF-8@25-μm PP separator, and 0.229 mS/cm for the 25-μm PP separator. Thus, the ZIF-8 modified separators exhibited enhanced ionic conductivity compared to the pristine PP separator due to the improved wettability, despite slightly higher membrane thicknesses.

The Li⁺ transference number (t_{Li+}) is another significant factor affecting the batteries performance. To obtain the transference number of a separator, it is sandwiched between two lithium chips, and a DC potential of 10 mV is applied for 1000 sec to record the chronoamperometry, as presented in FIG. 5D. The transference number can be calculated by

$${t}_{Li +} = \frac{{I}_{s} ( V - {I}_{o} {R}_{o} )}{{I}_{o} ( V - {I}_{s} {R}_{s} )} ,$$

where V represents the applied DC voltage (10 mV), Iₒ and Iₛ denote the initial and steady-state currents, respectively, which can be read from the chronoamperometry curves. Rₒ and Rₛ stand for the interfacial resistances before and after DC polarization, respectively, and can be derived from the EIS curves. With a thin ZIF-8 coating, the 25-μm PP increases its transference number from 0.61 to 0.68, while the 8-μm PP increases its value from 0.59 to 0.67. The crack-free ZIF-8 thin film enhances the permselectivity of Li⁺ through the separator, resulting in an increased transference number.

Lithium polysulfides (LiPSs) are reported to easily dissolve within the commonly used ether-based electrolyte, and the size of desolvated and solvated LiPSs molecules is about 7 and 10-13 Å, which are significantly smaller than the 50-200 nm strip-shaped pores in commonly used PP separators. Therefore, LiPSs can easily permeate across the separator and shuttle between the electrodes. The densely covered ZIF-8 layer consists of ZIF-8 nano crystals possessing a small pore aperture of 3.4 Å, which can serve as a molecule sieve and physically block the diffusion of LiPSs through the separator.

The superior polysulfide blocking capability of the ZIF-8@8-μm PP membrane compared with the pristine 8-μm PP separator can be directly observed in lithium polysulfide permeation tests. Initially, the H-type cells were coupled with ZIF-8@8-μm PP and 8-μm PP separators. The left tube was filled with a pure DOL/DME solution, while the right tube contained a 0.025 M Li₂S₆ DOL/DME brownish solution. Over time, polysulfide diffusion from right to left became evident with the 8-μm PP separators, noticeable after 24 hours. In contrast, the ZIF-8@8-μm PP separator effectively prevented almost any Li₂S₆ from passing through within the same period. Similarly, the ZIF-8@25-μm PP also strongly inhibits the polysulfide shuttling compared to the pristine 25-μm PP separators. Based on the visual observations, the permeation rate of polysulfide in 8-μm PP is slightly faster than that of 25-μm PP due to the reduced diffusion distance across the separator. However, the ZIF-8@8-μm PP can block the polysulfide shuttling as the ZIF-8@25-μm PP, which highlights the benefits of ZIF-8 modification thin film on an ultrathin PP separator.

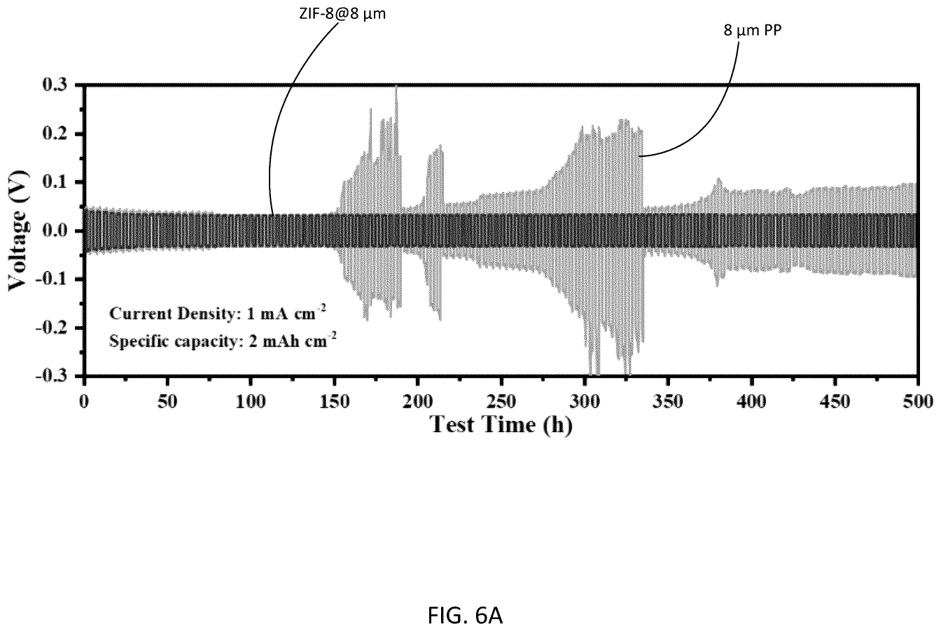

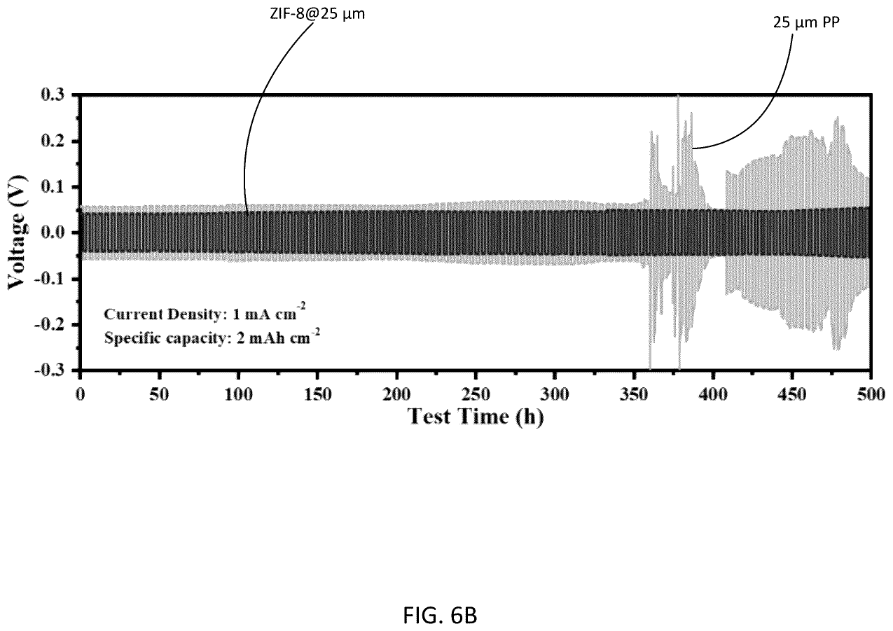

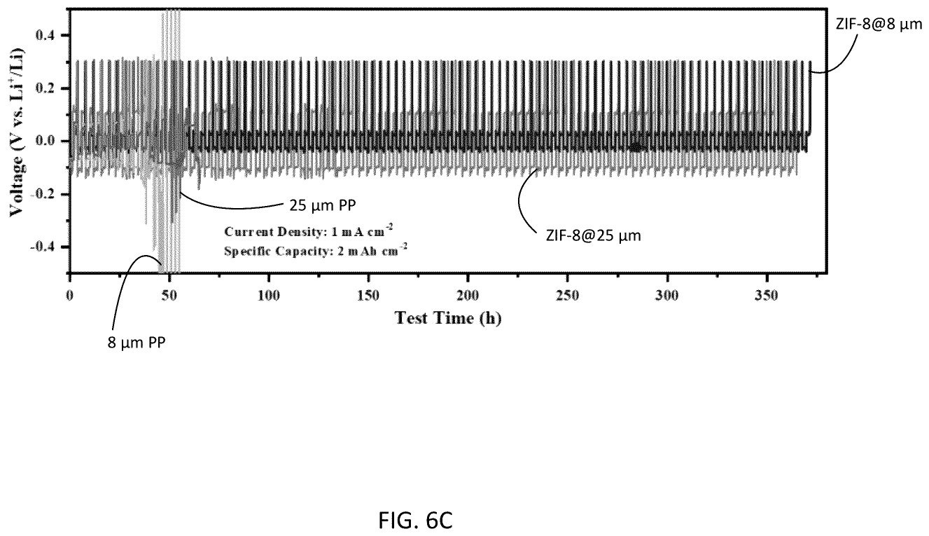

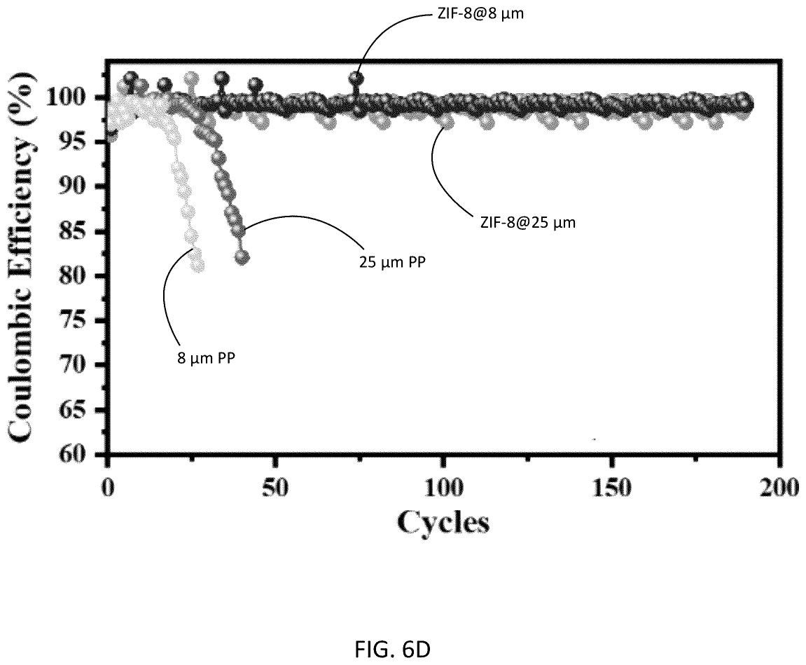

FIG. 6A shows time-voltage curves of Li plating/stripping in Li∥8-μm PP∥Li cell and Li∥ZIF-8@8-μm PP∥Li symmetrical cells at 1 mA cm-2 and 2 mAh cm 2. FIG. 6B shows time-voltage curves of Li plating/stripping in Li∥25-μm PP∥Li cell and Li∥ZIF-8@25-μm PP∥Li symmetrical cells at 1 mA cm-2 and 2 mAh cm⁻². FIG. 6C shows time-voltage curves of Li plating-stripping in Li∥Cu asymmetrical cells with different separators and FIG. 6D shows their respective Coulombic efficiency comparison.

The electrochemical function of ZIF-8 coating on the separator can be appreciated in the Li plating/stripping test. The test was first conducted in Li∥Li symmetrical cells with specific capacity of 2 mAh cm 2 at 1 mA cm⁻² that were assembled with different separators. The electrolyte is 1 M LiTFSI in DOL/DME (1:1 vol %) with 2% LiNO₃.

As shown in FIGS. 6A and 6B, the overpotential of symmetric Li∥PP separator∥Li metal cell gradually increases during cycling, implying a deteriorating electrode/electrolyte interface caused by Li dendrite growth. More importantly, the cell assembled with 8-μm PP separator faced an earlier short circuit failure (˜150 h) compared to 25-μm PP separator, indicating that the inherent lithium dendrites can easily penetrate through the ultrathin separator and result much faster cell failure and more severe safety hazards. However, the symmetric cells using the ZIF-8 coated separator present stable and reversible cycling with low Li stripping/plating overpotential after over 500 h in the case of both 8-μm and 25-μm separators, which obviously overcome the challenges of anode deterioration when utilizing ultrathin separator and ensure the safety for high performance LMBs. As has been demonstrated, the compact ZIF-8 coating enhances the diffusion coefficient and transference number of Lit. Moreover, the presence of polar functional group, open lithophilic metal sites as well as homogeneous and ordered microporous structure of ZIF-8 help to regulate the uniform deposition of lithium ions. All these contribute to the significantly expanded Sand's time and capacity before lithium dendrites appearance, thereby prolonging the lithium electrode lifespan.

Plating-stripping behavior in a Li∥Cu cell was further tested to determine the Coulombic Efficiency (CE) of Li∥Cu half cells with the various separators. CE hints at the reversibility of the lithium transfer in a full metal cell. These cells were tested at a large specific capacity of 4 mAh/cm² with a current density of 2 mA/cm². FIG. 6C shows that the plating-stripping occurs with minimum overpotential for the ZIF-8@8-μm separator. This can be attributed to improved ionic pathways with reduced length and a uniform lithium-ion flux due to the presence of a crack free uniform ZIF-8 layer. The cells with pristine separators showed signs of short circuit after ˜70 and ˜100 hours of cycling at this rate, while the ZIF modified separator showed almost invariable CE of ˜99.5% over a course of 380 hours as evident from FIG. 6D. This suggests that the ZIF-8@8-μm separator can inhibit the formation of lithium dendrites at a faster charging/discharging rate for a longer span compared to the other commercially available separators.

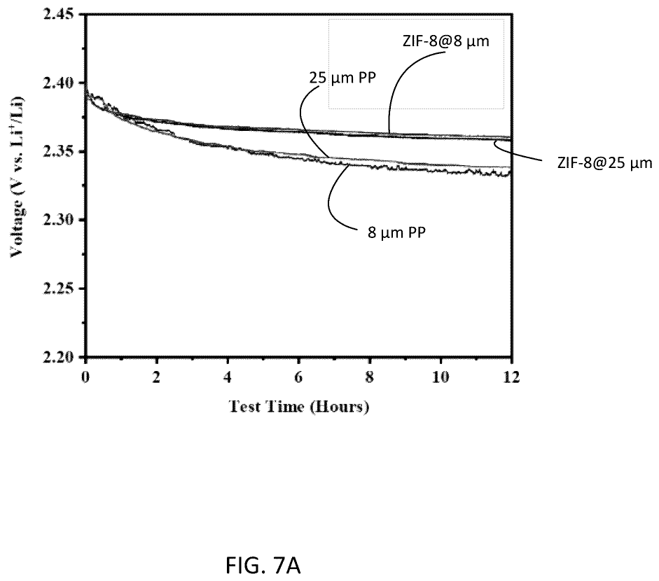

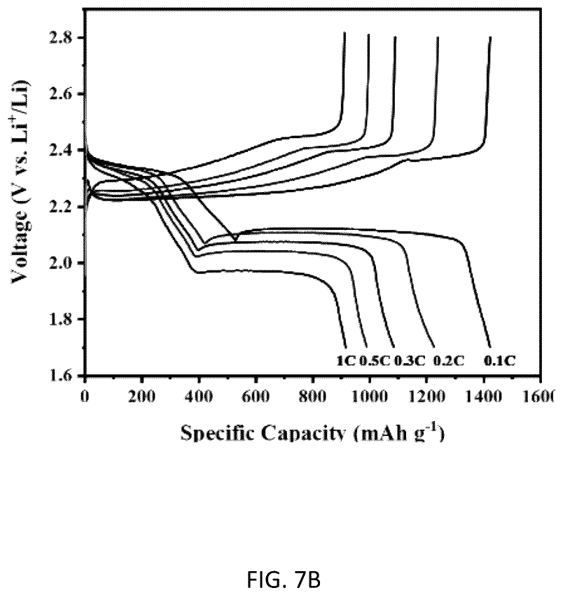

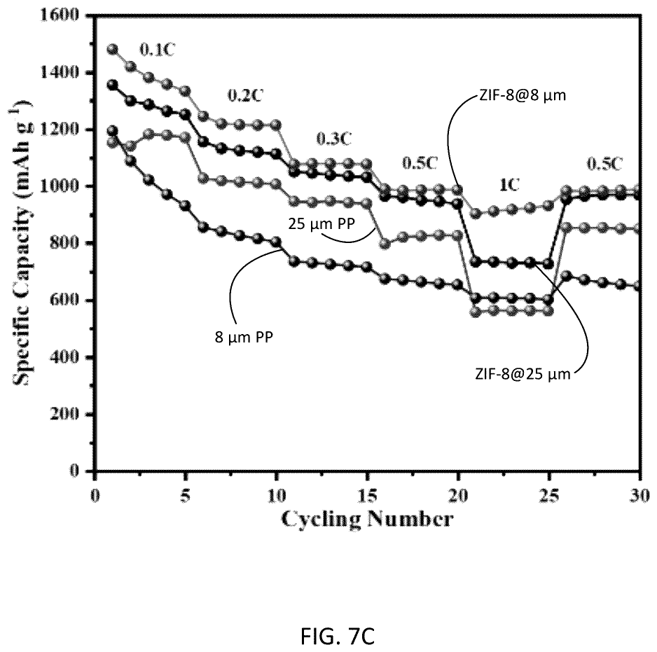

The improved charge transfer properties of LSBs by incorporation of ZIF-8@8-μm are evident in its electrochemical impedance spectroscopy (EIS) profiles, where the smallest semi-circle loop in the high frequency region indicates lowest charge transfer resistance, whilst the higher slope in the low frequency region suggests a trend towards an ideal ion diffusion behavior. FIG. 7A shows open-circuit voltage (OCV) curves of Li—S cells assembled with different separators. FIG. 7B shows voltage charge/discharge profiles of Li—S cell coupled with ZIF-8@8-μm PP from 0.1 to 1 C. FIG. 7C shows the rate capabilities demonstration of LSBs coupled with different separators.

The open-circuit voltage profiles in FIG. 7A illustrate the self-discharge behavior of LSBs using different separators. The self-discharge rate follows the sequence: 8-μm PP>25-μm PP>ZIF-8@ 25-μm PP>ZIF-8@8-μm PP. This sequence is consistent with the capacity decay rate observed in LSBs during the cycling and rate capability tests. In contrast to the rapid voltage drop with the pristine PP separator, the ZIF-8 modified separators slow down the self-discharge. This is achieved by inhibiting or suppressing crossover polysulfide diffusion, leading to a sustained stable plateau of 2.37 V.

The experiments collectively indicate that the application of ZIF-8@8-μm PP separator is highly beneficial for achieving high capacity and good cyclic stability in LSB performance at high current density. This is attributed to the ability of ZIF-8 to enhance wettability to the electrolyte, improve Lit ion conductivity and diffusion within the electrolyte, and effectively suppress the shuttle effect of LiPSs.

To assess the viability of the crack-free ZIF-8 functional layer modified PP separator in LSBs, a set of LSBs was assembled using different separators: pristine 8-μm PP, 25-μm PP, ZIF-8@25-μm PP and ZIF-8@8-μm PP. The assembled coin cells have a sulfur loading of 1.5 mg/cm² and E/S ratio of 15 μl/mg. The rate capability and cyclic performance of these cells were evaluated using galvanostatic charge/discharge measurement.

As depicted in FIGS. 7B and 7C, batteries utilizing ZIF-8 modified separators exhibited an increasing rate capability, which became more pronounced with higher applied current density. Specifically, the batteries equipped with ZIF-8@8 μm PP separators delivered specific discharge capacities of 1480, 1250, 1090, 990, and 917 mAh·g⁻¹ at current densities of 0.1 C, 0.2 C, 0.3 C, 0.5 C and 1 C rate, respectively. Upon returning to a current density of 0.5 C, the capacity remained stable at 968 mAh-g⁻¹. This superior rate capability can be attributed to the synergistic effect of ZIF-8 modification and ultrathin separator, which enhances wettability to the electrolyte and improved Li⁺ conductivity and its transference number. In terms of LSBs cycled at a rate of 1 C with different separators, the cells assembled with ZIF-8@8-μm demonstrated a retained capacity of ˜891 mAh g⁻¹ after 500 cycles from an initial capacity of ˜1053 mAh g⁻¹. The capacity fading rate for each cycle is approximately 0.031%, which was the best among the four LSBs with different separators. In contrast, cells assembled with a commercial ultrathin 8-μm PP separator exhibited very fast capacity decay, experiencing sudden failure after only 160 cycles.

Moreover, when cycled at a high rate of 2 C, Li—S cells assembled with ZIF-8@8-μm PP maintain a capacity of 785 mAh/g after 200 cycles. To meet the practical requirements of Li—S batteries, cells coupled with ZIF-8@8-μm PP were further tested with a higher sulfur loading of 5 mg/cm² and a lower E/S ratio of 7.5 μl/mg. After being activated at 0.1 C for 5 cycles, those cells assembled with ZIF-8@8-μm PP demonstrated outstanding cyclic stability at 0.3 C with a high capacity of 623 mAh/g after 100 cycles.

To further validate the application of the ZIF-8 modified separator in lithium metal batteries, these separators were tested in an LFP∥Li cell configuration. The LFP−Li cells exhibited charge/discharge behavior with lowest polarization when using the ZIF-8@8-μm separator at both 0.1 and 0.5 C rates. The LFP−Li cells achieved the highest first cycle capacity of 178 mAh/g at 0.1 C and 167 mAh/g at 0.5 C when using the ZIF-8@8-μm PP separator. When tested over longer durations, cells with unmodified separators exhibited immediate capacity decay in the first few cycles. In contrast, the ZIF-8 modified thin and thick separators maintained capacities of 138 mAh/g and 130 mAh/g, respectively, after 140 cycles. This indicates that ZIF-8 modification enables the functioning of a very thin 8-μm separator, potentially leading to the application of dendrite free lithium metal batteries.

Furthermore, a postmortem examination of the cycled LSBs was conducted to inspect the effects of ZIF-8 coating on Li metal anodes. The pristine Li anode exhibited a flat and glossy surface. However, the cycled Li anodes with 8-μm ultrathin PP displayed very rough and lumpy surfaces, caused by irreversible plating/stripping behavior and undesired corrosion reaction between Li and LiPSs. In contrast, after introducing ZIF-8 modification layer, the cycled Li anodes almost retained their original smooth morphology, indicating that the ZIF-8@8-μm PP separator effectively confines LiPSs on the cathode side and regulates Li⁺ flux and deposition. This finding was consistent with the previously discussed superior electrochemical performance of ZIF-8@8-μm PP cells, in contrast to those low-performance pristine PP cells.

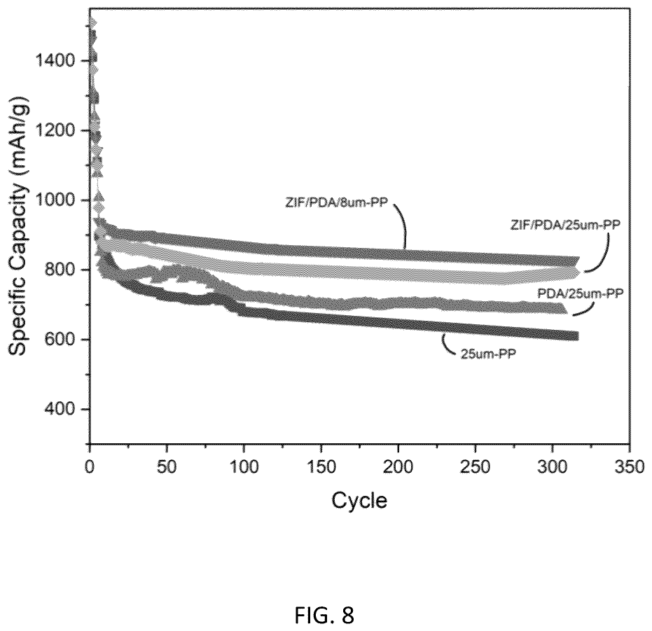

FIG. 8 shows preliminary performance data for Li—S cells with ZIF electrodeposited on top of PDA 128. As shown, this dual functional barrier layer 102 can result in a greater specific capacity than PDA 128 alone. It should be noted that for these specific cells, the S-cathodes were fabricated using the method of powder coating on an Al current collector. This method, known in the art, is easier to apply in an industrial context, but results in lower performance than the freestanding cathode method used in other specific, non-limiting embodiments whose performance will be discussed below. For this and other reasons, FIG. 8 should not be compared with other results disclosed herein.

Samples of the specific embodiment of the PDA@BC separator 126 discussed above were fabricated and characterized. The subsequent physicochemical and electrochemical studies revealed the excellence of PDA@BC as a separator for Li—S batteries. Li—S cells using the PDA@BC separator 126 demonstrate dramatically improved performance with a specific capacity of 1449 mAh/g at 0.1 C and 877 mAh/g at 1 C.

While nanocellulose offers its dense network as a physical trap, the presence of polydopamine 128 in the separator offers polar functional groups which not only has a high binding energy towards the polysulfides but also helps in redistribution of the Li⁺ ions across it. The electrochemical and physiochemical results suggest that the synthesized separator can have practical applicability owing to its superior performance compared to a commercial separator. The Li—S batteries assembled with this separator showed a specific discharge capacity of 1449 mAh/g at 0.1 C and 877 mAh/g at 1 C, and a capacity fade of 0.03% per cycle over 650 cycles at 1 C. Using a PDA@BC separator 126, a practical Li—S battery cell with S loading of 7.5 mg/cm² (and E/S ratio of 10 μL/mg, 82% S ratio) was tested at 1 C, which delivered a capacity of ˜6 mAh/cm² for 500 cycles.

The functional barrier layer 102 of PDA 128 on BC fibers can be understood through the schematic in FIG. 3B. Dopamine has an amine group (—NH), which undergoes oxidation in an alkaline environment to yield unstable intermediates. As a result, the structure undergoes cyclic rearrangement, which causes the creation of multiple nucleophilic structures with aromatic nitrogen groups. The delocalized electron density on these unstable intermediates drives the nucleophilic attachment of these oxidized dopamine molecules to the cellulose. To bind with cellulose, these intermediaries go through the Michael Addition and Schiff Base reactions. In addition, the oxidized dopamine self-polymerizes by joining and cross-linking with one another. The binding between PDA 128 and BC is also accelerated by the dehydration between catechol of PDA 128 and hydroxyl groups of BC. The presence of amino and phenolic groups in these molecules leads to enhanced binding among them through hydrogen bonding.

Characterization of the resulting separator sample illustrates the advantages it offers over conventional battery separators 100. Differential scanning calorimetry (DSC) was performed for the BC-based and the commercial Celgard 2400 (C-2400) separators to study their thermal stability. Scanning electron microscopy (SEM) was performed to characterize the sample's morphology. The chemical bonding information was revealed using Fourier transform infrared spectroscopy (FT-IR). Further, the composition and chemical bonding information of the separator was studied using an X-ray photoelectron spectroscope (XPS).

For evaluating Lit ion conductivity through the separator, the PDA@BC separator 126 was soaked in the electrolyte (i.e., 1M LiTFSI in 1:1 DOL: DME vol. ratio, with 1 wt % LiNO₃ was the standard electrolyte used in this specific non-limiting example) and then sandwiched between two stainless steel spacers inside a coin cell. Electrochemical impedance spectroscopy (EIS) was conducted on a Bio-logic workstation to measure the bulk resistance. Li⁺ ion conductivity was calculated using the equation σ=L/RA, where L is the thickness of the separator, R is the measured bulk resistance, and A is the electrode area. Li—Li symmetric coin cells (CR2032) were assembled with PDA@BC or C-2400 as the separator to measure their transference number, t=Iₛ(V−IₒRₒ)/Iₒ(V−IₛRₛ), where Iₒ and Iₛ are the initial and steady-state current obtained after 1000 s, V is the applied potential, Rₒ and Rₛ are the resistance before and after DC polarization.

Sample batteries were assembled, and freestanding sulfur cathodes were used. BC sheets were first hydrolyzed in DI water at 80° C. for 2 days until the sheets were fully saturated. These sheets were freeze-dried at −85° C. and 0.72 mm Hg to remove the water, which were further carbonized at 800° C. in an argon environment for 2 hours. Discs with a diameter of 10 mm were punched from these carbonized sheets onto which 0.25 M Li₂S₆ catholyte was added to form the freestanding sulfur cathodes during assembly.

Li—S coin cells (CR2032) were assembled using the freestanding cathodes, PDA@BC or C-2400 as the separator, Li chips as the anode, and the above-mentioned standard electrolyte. These cells were created with different sulfur loadings of 5 mg/cm² and 7.5 mg/cm² and their corresponding E/S ratios of 15 and 10 μL/mg. The galvanostatic charge/discharge was performed between 1.7-2.8 V at different current rates. Cyclic Voltammetry (i.e., scan rate: 0.1-0.4 mV/s, voltage range: 1.7-2.8V) and EIS (i.e., 0.1-100 kHz with 10 mV AC voltage amplitude) were conducted on a Bio-logic workstation. Li—Li and Li—Cu cells were assembled to study the impact of the separator on the Li plating-stripping behavior. All cells were tested and recorded in a LANHE battery testing machine.

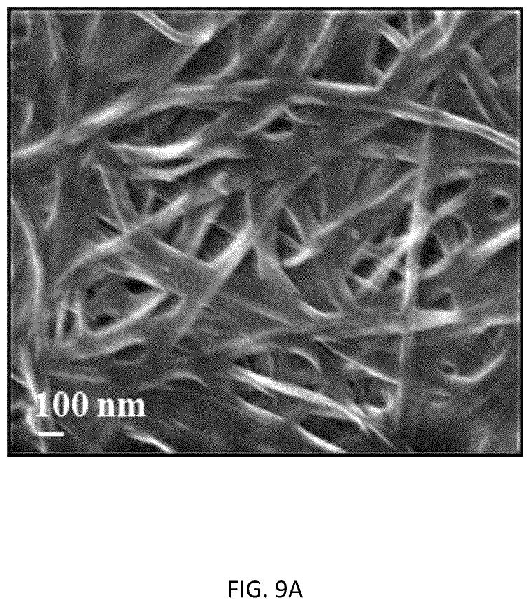

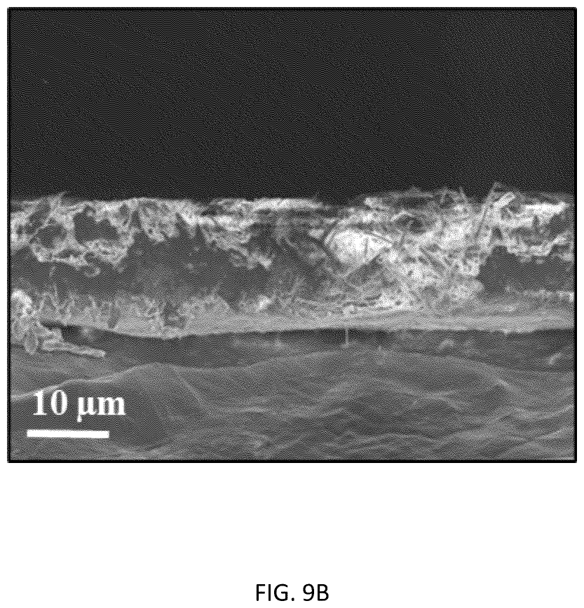

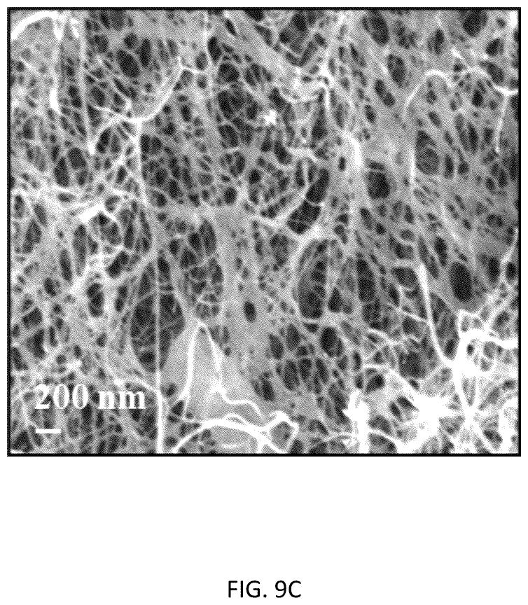

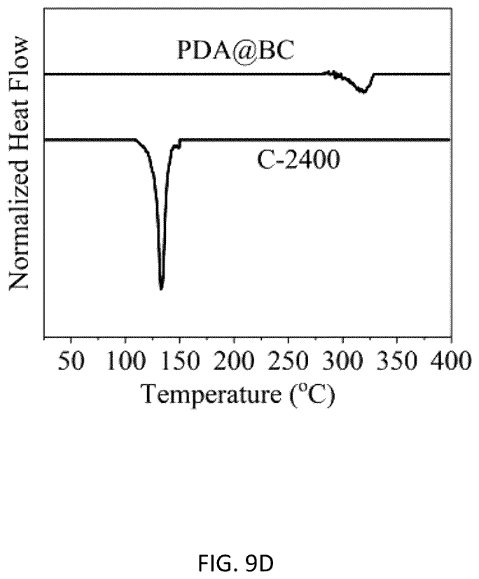

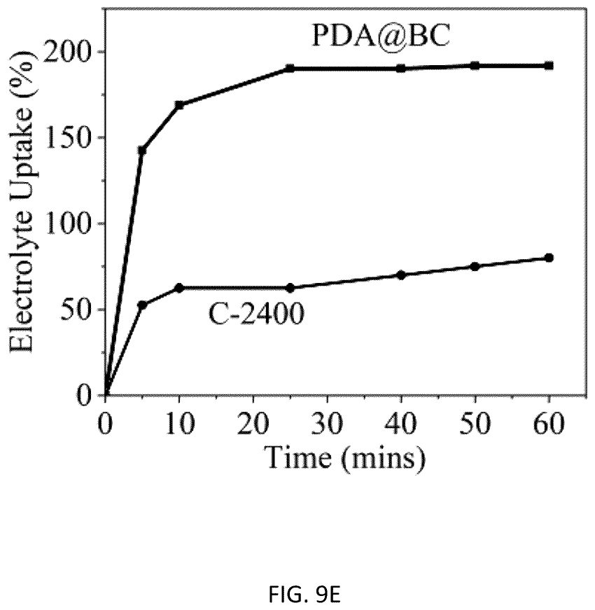

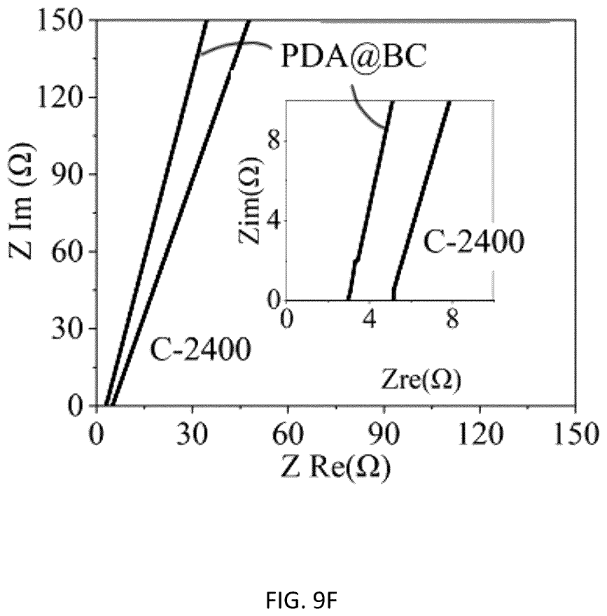

FIGS. 9A and 9B are SEM images of this PDA@BC separator 126, and FIGS. 9 C and 9D are SEM images of a conventional Celgard® 2400 (C-2400) separator. FIGS. 9D, 9E, and 9F show DSC curves, electrolyte uptake capability, and ion conductivity test results, respectively, for these PDA@BC and C-2400 separators 100.

The formed PDA@BC separator 126 was observed under SEM to reveal their surface morphology. FIG. 9A shows that the PDA 128 coated cellulose nanofibers are cross-linked with each other forming an interconnected network with distributed nanopores. Such a morphology can facilitate the transportation of the Li⁺ ions with a uniform flux. FTIR spectra confirm the functional barrier layer 102 of PDA 128 on BC via dehydration, imine interaction, and hydrogen bonding.

FIG. 9B shows a cross-sectional SEM image, which confirms the formation of a 30 μm thick, porous separator. FIG. 9C shows the SEM images of a free-standing carbonized scaffold derived from BC as the sulfur host. The spaced-out networks, as seen in the image, provide mesoporous and microporous spaces for S loading. This interconnected carbon nanofiber scaffold facilitates high sulfur loading in the cell with ionically and electronically conductive pathways for the ionically and electronically highly insulating sulfur and Li₂S.

Ideally, a porous separator should provide excellent isolation between the anode and cathode even at high temperatures to prevent thermal runaway. As is known in the art, the C-2400 separator will be molten at elevated operation temperatures (i.e., >˜100° C.), causing catastrophic battery failure. separators 100 with much-improved temperature tolerance features will enhance battery safety. The thermal stability of the PDA@BC membrane was tested in an oven along with the C-2400, from room temperature to 140° C. The PDA@BC membrane retained its shape without any signs of deformation while the commercial separator decomposed. Indeed, the DSC measurements in FIG. 9D show that C-2400 has an endothermic decomposition peak around 140° C., while it is about 340° C. for the PDA@BC, suggesting the PDA@BC has much better temperature tolerance. The high crystallinity of BC renders it intrinsic thermal stability, while the closed-packed chains of polysaccharides in PDA@BC, due to their hydrogen bonding, further contribute to this property. Hence, using PDA@BC as a separator can ensure safe battery operation at higher temperatures. The biopolymer separator was also folded multiple times, after which its original shape was regained, showing the excellent flexibility of the prepared PDA@BC membrane.

This porous separator should also be able to hold a specific volume of electrolyte to ensure facile transport of Li⁺ across the separator with a substantially small internal resistance in the battery. To measure their electrolyte uptake capabilities, separators 100 were submerged in the DOL-DME-based electrolyte, and the mass change over an hour was recorded. FIG. 9E demonstrates the superior electrolyte uptake capabilities of the PDA@BC separator 126, with an initial accelerated absorption of up to 150%.

The contact angle was measured to show the wetting nature of the separators 100. The C-2400 separator had a contact angle of 26.5° after the initial resting time, as opposed to 0° for the PDA@BC separator 126. The presence of N- and O-abundant sites in PDA@BC increases its surface energy due to which they have a strong affinity towards the used electrolyte, and hence the electrolyte gets thoroughly soaked in it, showing better wettability.

Cells were assembled with two stainless steel spacers as electrodes, a separator, and an electrolyte to determine Lit ion conductivity across the separator. EIS measurements were conducted, and the Nyquist plot for both separators 100 is shown in FIG. 9F. The ionic conductivity across the separator was calculated to be 0.37 mS/cm for PDA@BC, compared to 0.21 mS/cm for C-2400. These excellent electrical characteristics of PDA@BC can be accredited to its multiple functional groups and lithophilic nature that offer facile diffusion pathways for Li⁺. To measure the Li⁺ transference number, DC potential of 10 mV was applied to the cell, and their current response was recorded for the specified time. The transference number for PDA@BC is ˜0.74, compared to 0.65 for C-2400, suggesting that the former facilitates Li⁺ transportation. The porous structures of PDA@BC, along with its lithiophilic features, offer highly diffusive pathways enabling faster transportation of these charged ions. These results suggest that PDA@BC offers ameliorated separator characteristics compared to the C-2400.

A cyclic voltammetry (CV) study of Li—S cells, in the potential window of 1.6-2.7 V, was conducted further to elucidate the improved functionality by the PDA@BC separator 126. Comparing the CV curves for both separators 100 at a scan rate of 0.1 mV/s shows reduction of S to Li₂Sₓ (x>=4) and succession to Li₂S/Li₂S₂ occurring at higher potentials of 2.35 V and 2.02V for PDA@BC, compared to 2.31V and 2.01V for C-2400. The CV curves of Li—S batteries at increasing scan rates from 0.1 to 0.4 mV/s with PDA@BC shows a more positive and negative shift in the anodic and cathodic peaks respectively compared to C-2400, hinting an improved reaction kinetics for Li—S cell with PDA@BC as the separator.

EIS measurements were done on freshly assembled Li—S coin cells to reveal the charge transfer resistance (R_{ct}). The functional groups of N and O in the membrane creates active sites on the separator allowing redistribution of the Lit ions, and a uniform flux of Li⁺ ions facilitates a lower resistance and higher diffusion. These cells were subjected to EIS measurements again after CV cycling to investigate any change in the electrochemical processes inside the Li—S cells. The cells show a resistive element due to the diffusion of ions across the SEI formed during the cell activation. The reduction in Ret values post CV can be explained by increased activation sites, improved electrolyte availability in the cathode, and increased diffusion pathways.

Li stripping and plating in LI/Li and Li/Cu cells was also investigated. The separator in a battery controls the Li⁺ flux distribution at the microscale, and this flux distribution impacts the Li deposition and stripping. The unstable stripping of the Li⁺ ions from the anode side during discharge leads to the formation of whiskers and pits, deteriorating its long-time performance. The formation of these irregularities can be studied by their corresponding overpotentials in a Li—Li symmetric and Li—Cu asymmetric cell.

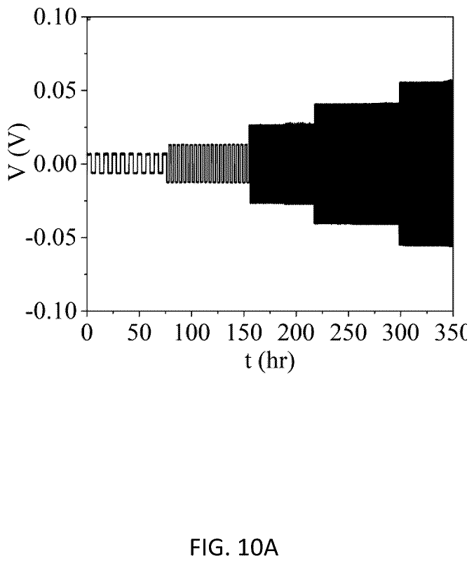

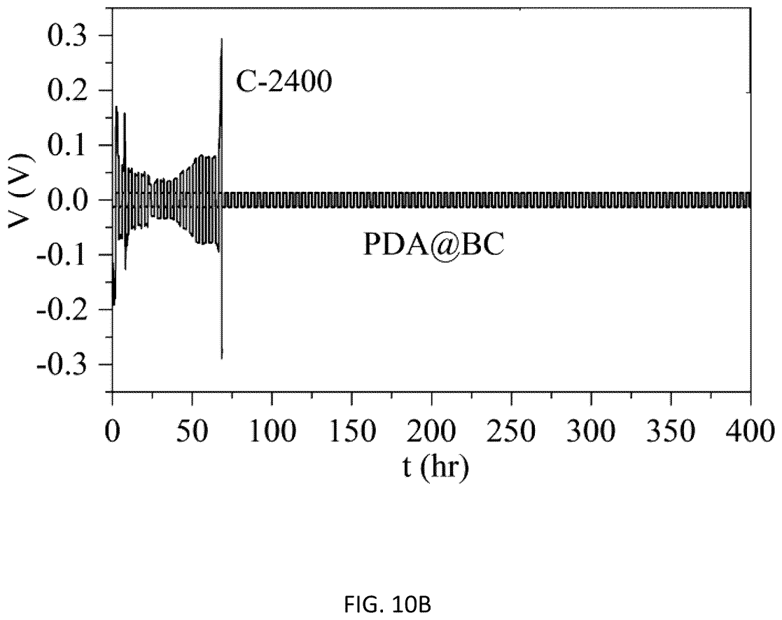

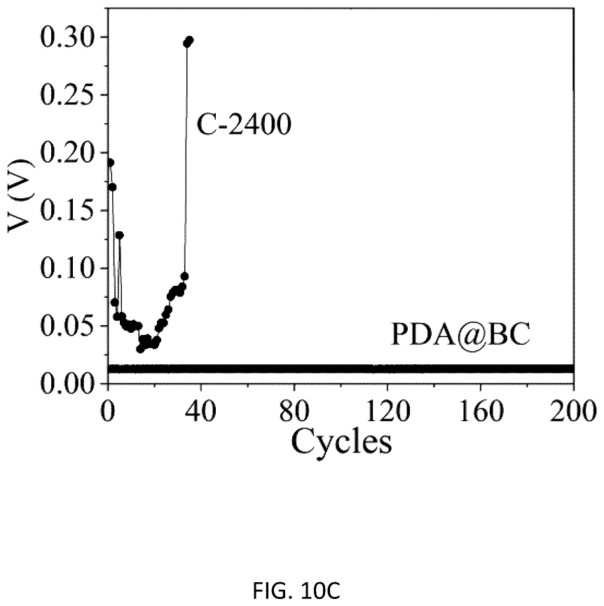

FIGS. 10A and 10B show the Li—Li plating-stripping study of PDA@BC from 0.5 to 6 mAcm⁻², and of PDA@BC and C-2400 at 1 mAcm⁻², respectively. FIG. 10C shows the overpotentials measured from 2b. Lithium plating-stripping result of Li—Cu unsymmetric cell with PDA@BC and C-2400 separators 100 at 2 mAhcm⁻² discharge capacity and their second cycle Voltage-capacity graph.

Galvanostatic cycling tests of Li—Li cells were carried out. FIG. 10A shows the plating-stripping behavior of the PDA@BC cell under a constant capacity of 2 mAh cm⁻² but at different currents, with overpotentials of 7, 13, 27, 41 and 55 mV for a current of 0.5, 1, 2,4 and 6 mAcm⁻², respectively. FIG. 10B compares the long plating-stripping behavior of PDA@BC and C-2400 at a current of 1 mAcm⁻² and a capacity of 1 mAhcm⁻². For the C-2400 cell, the potential flickered in each cycle, and the cell quickly reached a cutoff potential of 300 mV after just 70 hours of cycling test. These observations suggest C-2400 failed to maintain a stable Li plating and stripping process by curbing dendritic growth. PDA@BC, in comparison, shows more than 400 hours of stable cycling with an almost invariable overpotential of 13 mV. FIG. 10C maps the overpotentials measured in case of both stripping and plating behavior, from FIG. 10B, for each cycle. The symmetric cells with C-2400 reports variable overpotentials in almost every cycle with a minimum overpotential of 30 mV, clearly indicating the presence of irregular Li flux across it. The magnified voltage time profiles at different cycles confirm the same. These uniformly distributed functional groups homogenize the Li ions across the membrane giving rise to stable and symmetric plating-stripping.

Li—Cu cells were also assembled to test the Li stripping and plating behavior under the two separators 100. Lithium was plated on the copper electrode first at a constant discharge capacity of 2 mAh cm⁻², and it was then plated back while maintaining a cutoff voltage of 1V. The plating-stripping in these cells was compared at 1 mAcm⁻². The cell with C-2400 separator has a cyclic capability of ˜50 hours with unstable stripping and plating behaviors leading to dendritic growth and, ultimately, membrane penetration leading to its failure. Li—Cu cells with PDA@BC separator 126 have a cyclic capacity of more than 180 hours. Uniform removal and deposition of lithium occurs at a lower overpotential, 19 mV, for the functionalized separator, whereas the C-2400 shows not only non-uniform stripping and deposition characteristics but also higher polarization potentials suggesting its inability to protect anode at higher discharge rates. To further demonstrate the effectiveness of using this biopolymer-based separator, the voltage-capacity profiles for its different cycles were generated for the Li—Cu batteries assembled with PDA@BC separator 126, showing there is an almost negligible increase in the overpotentials. The coulombic efficiency derived from the Li—Cu study has a value of 98.9% after 80 cycles, while there is quick fade observed for C-2400. The chemical interactions between the functional groups and the Li ions help in its redistribution in the initial few hours of the first cycle of plating, leading to its uniform deposition on the copper foil. These studies justify the use of PDA@BC addressing the dendritic issues in the lithium-metal cells.

To meet the basic design requirements for a separator in a Li—S battery, waning the polysulfide (PS) shuttling may be a pivotal design consideration as it leads to continuous capacity degradation. Hence, PDA@BC and C-2400 separators 100 were tested for their adsorption ability towards LiPS by dipping in 0.1 mM Li₂S₆ solution. The chemical interaction of the LiPS with PDA@BC separator 126 can be physically observed. The dark red color of the LiPS solution slowly faded away, in the vial with PDA@BC, to a very light-yellow colored solution suggesting the adsorption of the LiPS from the solution, while the vial with C-2400 separator retained the same color.

The chemical configuration and interaction between the PDA@BC separator 126 and polysulfides were studied by X-ray photoelectron spectroscopy (XPS) before and after polysulfide adsorption tests. In the wide XPS surveys, new peaks appeared at 57.1 eV and 168.7 eV corresponded to the Li Iₛ and S 2p regions after polysulfide adsorption. In the high-resolution S 2p spectrum, two nearby peaks at 161.8 eV and 163.3 eV correspond to terminal S and bridging S, respectively, which indicates effective polysulfides trapping by the separator. The peaks at 168.3 and 166.4 eV correspond to polythionate and thiosulfate, respectively. In the Li 1s spectrum, the peak at 54.6 eV corresponds to the Li—S bond of polysulfides, and the peak at 57.2 eV corresponds to newly formed Li—O and Li—N bonds between polysulfides and O, N-containing groups of the separator, which served as lithophilic sites to form Li—O and Li—N bonds with polysulfides. This demonstration is further validated by the presence of Li—O bonds (530.9 eV) in the O 1s spectrum and Li—N bonds (401.9 eV) in the N 1s spectrum. Thus, polysulfides were found to be chemically trapped by the PDA@BC separator 126 by forming Li—O and Li—N bonds. This confirms that these functional groups not only block the polysulfide but also regulate the Li ion flow by forming these chemical bonds.

The PS diffusion test was also conducted in an H-cell setup with PS solution in one arm and blank solution in the other, with the separator in between. Over the span of 48 hours, PDA@BC absorbs the polysulfides present in the solution rendering it transparent, while C-2400 shows the apparent diffusion of the PS. Hence, integrating the results of these experiments yields the conclusion that the PDA@BC can effectively inhibit the PS shuttling.

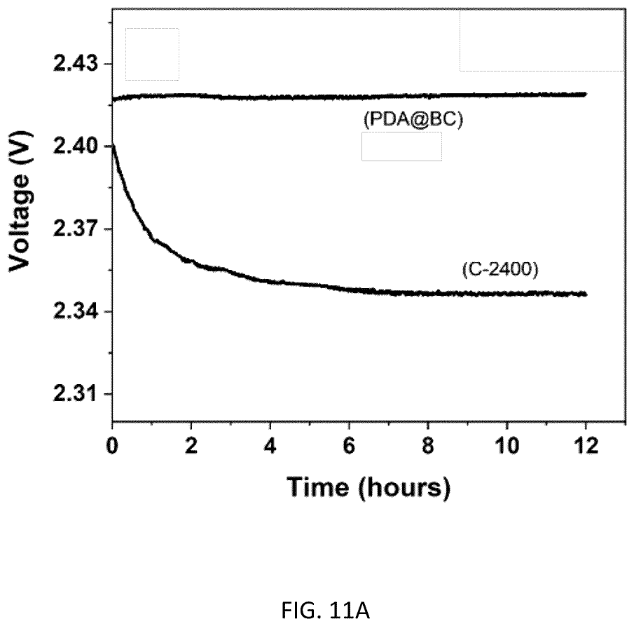

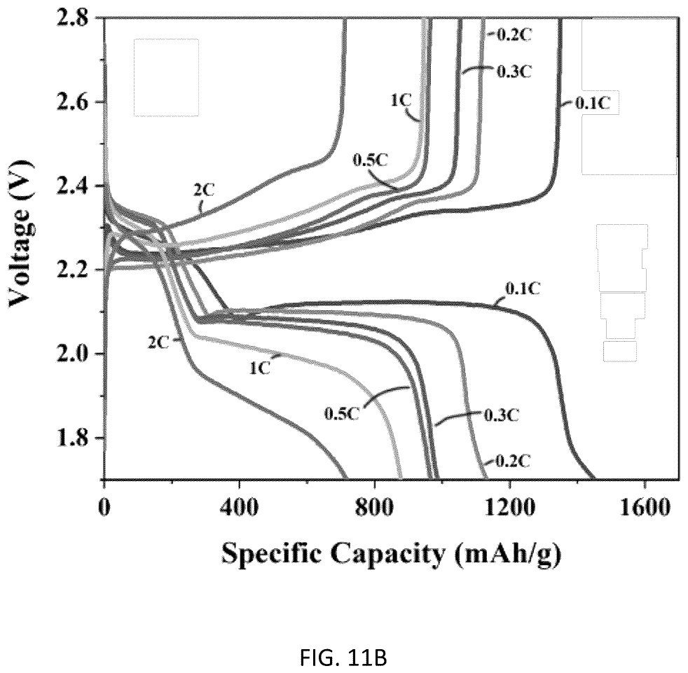

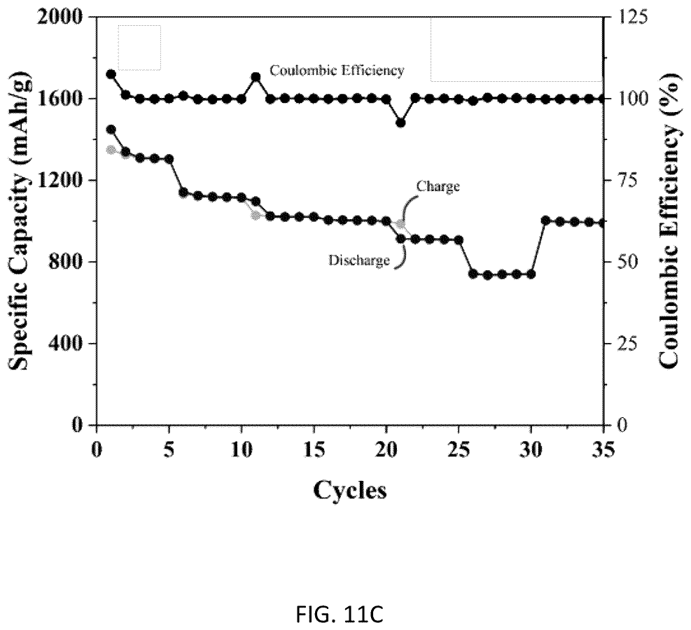

FIG. 11A shows the results of an Open Circuit Potential test of Li—S batteries with PDA@BC and C-2400 separators 100. FIGS. 11B and 11 C are the voltage profile and rate capability, respectively, of a Li—S Battery with PDA@BC at different current densities.

Li—S coin cells were assembled with PDA@BC and C-2400 separators 100 to conduct various electrochemical studies. After the first discharge and charge cycle, the cell underwent an open circuit potential (V_{OC}) test. Under this condition, the decay of V_{OC}, corresponding to capacity loss, is fueled by various self-discharge mechanisms, of which LiPS shuttling is perhaps the most significant one in a Li—S cell. FIG. 11A shows a dramatic voltage loss of ˜ 60 mV for a typical C-2400 cell in 12 hours, while almost no loss in the potential was observed for a PDA@BC cell. This suggests that under the no load condition, the LiPS shuttling has largely been curbed by the PDA@BC biopolymer separator.

The impact of this new separator on cell rate performance was further investigated. The assembled Li—S cells were charged and discharged at different rates from 0.1 to 2 C and then back to 0.5 C. The cell showed a first cycle capacity of 1449 mAh/g at 0.1 C, which reduces to 877 mAh/g at 1 C (FIG. 11B). It was observed that the separator allows capacity reversibility in the Li—S battery as it regains its capacity after running at higher discharge rates (FIG. 11C). In contrast to this, the Li—S battery with C-2400 shows an initial capacity of 1171 mAh/g at 0.1 C while having a significantly reduced capacity of ˜600 mAh/g at 1 C.

The charge-discharge profiles of Li—S battery with PDA@BC and C-2400 at 0.1 and 1 C were created. There are two capacity-determining steps in a Li—S battery during discharge, which are represented by Q_{H}, referring to the higher capacity step in which sulfur reduces to long chain soluble PS, and Q_{L}, the lower capacity step in which the long chain PS further reduce to insoluble short chain PS. Shuttling of these soluble PS is effectively suppressed with the use of PDA@BC, as indicated by higher values of Q_{H} and Q_{L}. The reduction of sulfur/polysulfides in these steps also occurs at a lower potential for C-2400 compared to PDA@BC (˜2.09V vs. 2.07V at 0.1 C), and it reduces drastically at a higher discharge rate for C-2400 (˜1.9V at 1 C). The disappearance of the discharge reduction peak at a high discharge rate of 2 C in the case of C-2400 suggests irreversible battery degradation. Hence, to compare the performance of Li—S batteries with these separators 100 at a high discharge rate, these cells were cycled at 1 C at 5 mg/cm-2, 75% S loading, with the first five cycles at 0.1 C. The use of PDA@BC separator 126 in Li—S battery against the commercially available one is clearly justified, as it offers a specific capacity of over 879 mAh/g in the first cycle while fading to 707 mAh/g after 650 cycles of runtime with an average fade of 0.27 mAh/g each cycle, while the latter has an initial specific capacity ˜600 mAh/g while fading to ˜300 mAh/g in 130 cycles and maintaining that over the next 200 cycles before its complete failure. The Coulombic efficiency observed is very volatile in the case of C-2400, hinting at unstable electrode reactions due to irregular diffusion of Li ions, while it is almost constant and always above ˜98.5% with slight fluctuations for the biopolymer separator. The Li—S battery with PDA@BC was also tested at 1 C with S loading of 7.5 mg/cm² (and E/S ratio of 10 μL/mg, 82% S loading) to check for its cyclic performance under high loading conditions. The Li—S battery has an initial capacity of 800 mAh/g in the first few cycles, maintaining a capacity of 630 mAh/g after 400 cycles and fading to 498 mAh/g in the next 150 cycles. The areal capacity at 1 C for these S loadings shows excellent capacity retention, having a first cycle capacity of 6.39 mAhcm⁻² and 3.7 mAhcm⁻² respectively.

SEM images of cycled Li-metal anode at different magnifications, with different separators and after various cycles were examined. The evolution of dendrites, pits, and other surface irregularities over the long cyclic performance suggests irregular stripping and plating from the Li anode caused by repeated SEI breakage due to polysulfide corrosion. Hence, the Li—S cells with both these separators 100 were disassembled after certain cycles to observe the Li evolution and redeposition under SEM. The Li chips of Li—S cell with C-2400 after 100 and 200 cycles showed a change in morphology from a planar structure to grainy coarse deposits in the first 100 cycles to highly irregular deposits, forming pits and extrusions on the surface in the next 100 cycles can be observed. The Li surface from the Li—S cell with PDA@BC separator 126 shows compact deposits on the surface. These deposits undergo moderate surface degradation while remaining compact and uniform after 500 cycles. Lithium deposits for C-2400 and PDA@BC after 100 cycles were compared. The difference in the morphology of the deposits can be attributed to the controlled growth of the Li facilitated by PDA@BC. The evolution of small uneven agglomerates from larger agglomerates suggests the dendritic growth for C-2400 which would lead to formation of dead Li and much worse the cell failure eventually, while continued compact deposits were shown reverberating the reversible nature of the plating-stripping and the protection of the Li anode from corrosive polysulfides.

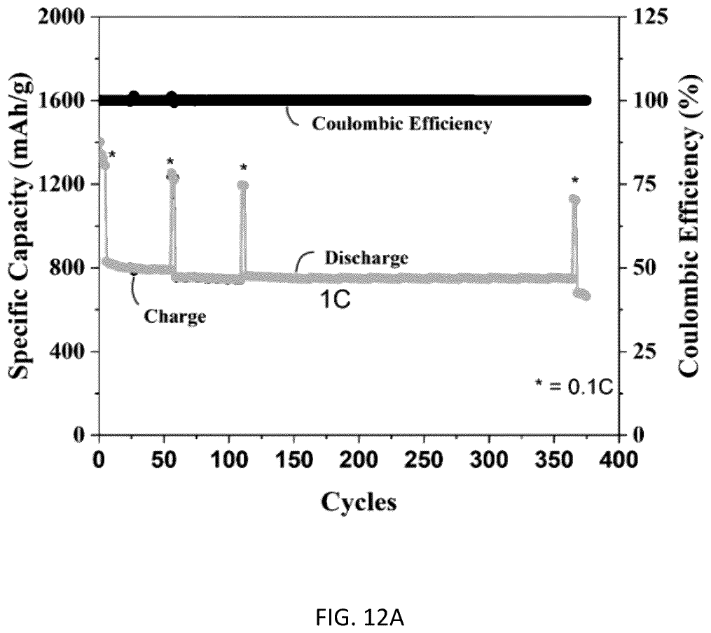

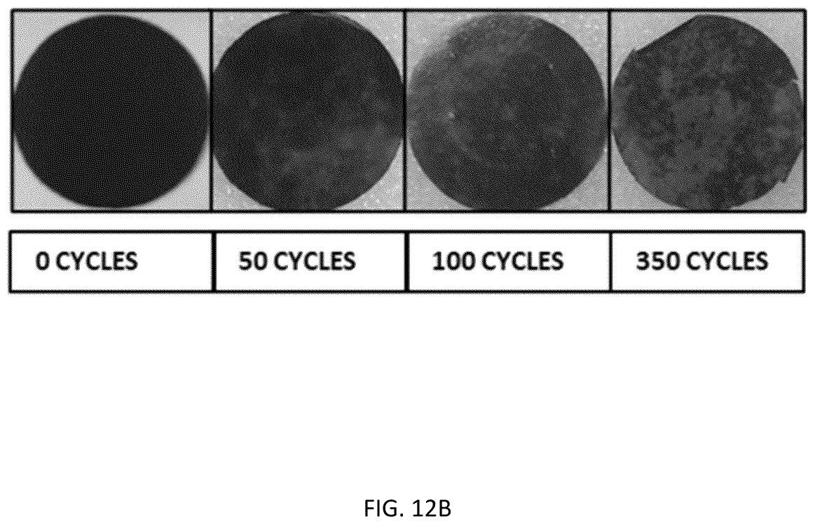

FIG. 12A shows the Li—S battery performance at 1 C with PDA@BC separator 126. The samples were dissembled at specified cycles, shown in FIG. 12B. After each disassembly they were run at 0.1 C for 3 cycles for conditioning and then cycled at 1 C. FIG. 12B shows images of the PDA@BC separator 126 showing degradation after the specified number of cycles. The PDA@BC membrane can be successfully implemented in a Li—S battery to stop the PS shuttling.

However, with repeated cycling there is expected degradation in the Li—S battery caused by the repeated SEI formation and its ultimate protrusions through the separators 100. The effect of this degradation on the separator is studied with the help of a split cell. A Li—S cell with PDA@BC is assembled and disassembled inside a glove box after 0, 50, 100 and finally 350 cycles to study this physical degradation in the separator. This battery was run at 1 C and after each assembly it was run at 0.1 C for few cycles to facilitate SEI formation. FIGS. 12A and 12B show the specific capacity of each cycle span and its corresponding optical image of the separator which was taken after disassembly and washing of separator with DME at the end of the cycle span. The blackish color of the separator slightly fades after 100 cycles, with the appearance of several spots on the final separator. Since the black component is PDA 128, the stress generated in the cycling may degrade the PDA@BC separator 126 by PDA 128 partially peeling off. It is clear from the figure that with more cycles, the separator lost more PDA 128 until the cell finally failed. Therefore, addressing the stability of PDA@BC shall further improve the Li—S battery performance when this novel PDA@BC separator 126 is used.

In this specific, non-limiting embodiment, PDA 128 was successfully coated on BC 130 by facile synthesis to form a functional biopolymer separator for Li—S batteries. The functional groups formed due to the polymerization of PDA 128 with BC provide abundant nitrogen and oxygen groups acting as active sites for chemically trapping the shuttling PS from the cathode side. Li—S batteries with this PDA@BC separator 126 gave a capacity of 1449 mAh/g at 0.1 C and showed an average decay of 0.03% per cycle at 1 C over 650 cycles. These groups form stable bonds with Li⁺ ions which allows uniform deposition and removal on the anode side, suppressing the dendrite formation on the Li-metal anode.

It will be understood that implementations are not limited to the specific components disclosed herein, as virtually any components consistent with the intended operation of a functional ultrathin battery separator and method for fabricating the same may be utilized. Accordingly, for example, although particular materials and fabrication methods for functional barrier layers, polymer substrates, and functional ultrathin battery separators may be disclosed, such components may comprise any shape, size, style, type, model, version, class, grade, measurement, concentration, material, weight, quantity, and/or the like consistent with the intended operation of a functional ultrathin battery separator and method for fabricating the same may be used. In places where the description above refers to particular implementations of a functional ultrathin battery separator and method for fabricating the same, it should be readily apparent that a number of modifications may be made without departing from the spirit thereof and that these implementations may be applied to other separators or porous membranes.

### REFERENCES

1. Peng, L.; Wei, Z.; Wan, C.; Li, J.; Chen, Z.; Zhu, D.; Baumann, D.; Liu, H.; Allen, C. S.; Xu, X. J. N. C. A fundamental look at electrocatalytic sulfur reduction reaction. 2020, 3, 762-770.
2. Li, S.; Fan, Z. J. E. S. M. Encapsulation methods of sulfur particles for lithium-sulfur batteries: A review. 2021, 34, 107-127.
3. Li, S.; Zhang, W.; Zheng, J.; Lv, M.; Song, H.; Du, L. J. A. E. M. Inhibition of polysulfide shuttles in Li—S batteries: modified separators and solid-state electrolytes. 2021, 11, 2000779.
4. Weng, Y.-T.; Wang, H.; Lee, R.-C.; Huang, C.-Y.; Huang, S.-S.; Abdollahifar, M.; Kuo, L.-M.; Hwang, B.-J.; Kuo, C.-L.; Cui, Y. J. J.o.P. S. Efficient synthesis of high-sulfur-content cathodes for high-performance Li—S batteries based on solvothermal polysulfide chemistry. 2020, 450, 227676.
5. Li, S.; Leng, D.; Li, W.; Qie, L.; Dong, Z.; Cheng, Z.; Fan, Z. J. E. S. M. Recent progress in developing Li₂S cathodes for Li—S batteries. 2020, 27, 279-296.
6. Tao, X.; Wang, J.; Liu, C.; Wang, H.; Yao, H.; Zheng, G.; Seh, Z. W.; Cai, Q.; Li, W.; Zhou, G. J. N.c. Balancing surface adsorption and diffusion of lithium-polysulfides on nonconductive oxides for lithium-sulfur battery design. 2016, 7, 1-9.
7. Wang, L.; Song, Y.-H.; Zhang, B.-H.; Liu, Y.-T.; Wang, Z.-Y.; Li, G.-R.; Liu, S.; Gao, X.-P. J. A.a.m.; interfaces. Spherical metal oxides with high tap density as sulfur host to enhance cathode volumetric capacity for lithium-sulfur battery. 2020, 12, 5909-5919.
8. Lu, C.; Chen, Y.; Yang, Y.; Chen, X. J. N. L. Single-atom catalytic materials for lean-electrolyte ultrastable lithium-sulfur batteries. 2020, 20, 5522-5530.
9. Zhang, S.; Ao, X.; Huang, J.; Wei, B.; Zhai, Y.; Zhai, D.; Deng, W.; Su, C.; Wang, D.; Li, Y. J. N. L. Isolated Single-Atom Ni-N5 Catalytic Site in Hollow Porous Carbon Capsules for Efficient Lithium-Sulfur Batteries. 2021, 21, 9691-9698.
10. Zhuang, Z.; Kang, Q.; Wang, D.; Li, Y. J. N. R. Single-atom catalysis enables long-life, high-energy lithium-sulfur batteries. 2020, 13, 1856-1866.
11. Li, S.; Mou, T.; Ren, G.; Warzywoda, J.; Wei, Z.; Wang, B.; Fan, Z. J. J.o.M. C. A. Gel based sulfur cathodes with a high sulfur content and large mass loading for high-performance lithium-sulfur batteries. 2017, 5, 1650-1657.
12. Luo, M.; Bai, Y.; Sun, R.; Qu, M.; Wang, M.; Yang, Z.; Wang, Z.; Sun, W.; Sun, K. J. J.o.E. C. Enhancing anchoring and catalytic conversion of polysulfides by nitrogen deficient cobalt nitride for advanced lithium-sulfur batteries. 2022, 73, 407-415.
13. He, Y.; Qiao, Y.; Zhou, H. J. D. T. Recent advances in functional modification of separators in lithium-sulfur batteries. 2018, 47, 6881-6887.
14. Fu, Y.; Wu, Z.; Yuan, Y.; Chen, P.; Yu, L.; Yuan, L.; Han, Q.; Lan, Y.; Bai, W.; Kan, E. J. N. C. Switchable encapsulation of polysulfides in the transition between sulfur and lithium sulfide. 2020, 11, 845.
15. Li, Y.; Zhou, P.; Li, H.; Gao, T.; Zhou, L.; Zhang, Y.; Xiao, N.; Xia, Z.; Wang, L.; Zhang, Q. J. S. M. A freestanding flexible single-atom cobalt-based multifunctional interlayer toward reversible and durable lithium-sulfur batteries. 2020, 4, 1900701.
16. Yu, B.; Fan, Y.; Mateti, S.; Kim, D.; Zhao, C.; Lu, S.; Liu, X.; Rong, Q.; Tao, T.; Tanwar, K. K. J. A.n. An Ultra-Long-Life Flexible Lithium-Sulfur Battery with Lithium Cloth Anode and Polysulfone-Functionalized Separator. 2020, 15, 1358-1369.
17. Liu, H.; Lai, W.-H.; Yang, H.-L.; Zhu, Y.-F.; Lei, Y.-J.; Zhao, L.; Peng, J.; Wang, Y.-X.; Chou, S.-L.; Liu, H.-K. J. C. E. J. Efficient separators with fast Li-ion transfer and high polysulfide entrapment for superior lithium-sulfur batteries. 2021, 408, 127348.
18. Li, Q.; Liu, Y.; Yang, L.; Wang, Y.; Liu, Y.; Chen, Y.; Guo, X.; Wu, Z.; Zhong, B. J. J.o.C.; Science, I. N, O co-doped chlorella-based biomass carbon modified separator for lithium-sulfur battery with high capacity and long cycle performance. 2021, 585, 43-50.
19. Xiao, R.; Yang, S.; Yu, T.; Hu, T.; Zhang, X.; Xu, R.; Wang, Y.; Guo, X.; Sun, Z.; Li, F. J. B.; et al. A Janus Separator for Inhibiting Shuttle Effect and Lithium Dendrite in Lithium-Sulfur Batteries. 2022, 5, e202100389.
20. Wei, Z.; Zhang, N.; Feng, T.; Wu, F.; Zhao, T.; Chen, R. J. C. E. J. A copolymer microspheres-coated separator to enhance thermal stability of lithium-sulfur batteries. 2022, 430, 132678.
21. Jing, W.; Zu, J.; Zou, K.; Dai, X.; Song, Y.; Han, J.; Sun, J.; Tan, Q.; Chen, Y.; Liu, Y. J. J.o.M. C. A. Sandwich-like strontium fluoride graphene-modified separator inhibits polysulfide shuttling and lithium dendrite growth in lithium-sulfur batteries. 2022, 10, 4833-4844.
22. Zhang, K.; Chen, Z.; Ning, R.; Xi, S.; Tang, W.; Du, Y.; Liu, C.; Ren, Z.; Chi, X.; Bai, M. J. A.a.m.; et al. Single-atom coated separator for robust lithium-sulfur batteries. 2019, 11, 25147-25154.
23. Hong, X.-J.; Song, C.-L.; Yang, Y.; Tan, H.-C.; Li, G.-H.; Cai, Y.-P.; Wang, H. J. A.n. Cerium based metal-organic frameworks as an efficient separator coating catalyzing the conversion of polysulfides for high performance lithium-sulfur batteries. 2019, 13, 1923-1931.
24. Li, W.; Li, S.; Bernussi, A. A.; Fan, Z. J. E. M. A. 3-D edge-oriented electrocatalytic NiCo2S4 nanoflakes on vertical graphene for Li—S batteries. 2021, 2021.
25. Mathew, D. E.; Gopi, S.; Kathiresan, M.; Rani, G. J.; Thomas, S.; Stephan, A. M. J. M. A. A porous organic polymer-coated permselective separator mitigating self-discharge of lithium-sulfur batteries. 2020, 1, 648-657.
26. Wu, X.; Fan, L.; Qiu, Y.; Wang, M.; Cheng, J.; Guan, B.; Guo, Z.; Zhang, N.; Sun, K. J. C. Ion-Selective Prussian-Blue-Modified Celgard Separator for High-Performance Lithium-Sulfur Battery. 2018, 11, 3345-3351.
27. Liu, Q.; Han, X.; Zheng, Z.; Xiong, P.; Jeong, R. G.; Kim, G.; Park, H.; Kim, J.; Kim, B. K.; Park, H. S. J. A. F. M. Crystallinity Regulated Functional Separator Based on Bimetallic NixFey Alloy Nanoparticles for Facilitated Redox Kinetics of Lithium-Sulfur Batteries. 2022, 2207094.
28. Wang, J.; Zhu, Y.; Wu, N.; Kan, Y.; Hu, Y. J. C. P. B. E. Designing thermotolerant and flame-resistant PAN-based separator via surface engineering with heteroatoms doped carbon framework encapsulated with CoS2 nanocatalysts towards safe lithium-sulfur batteries. 2022, 233, 109644.
29. Jiang, F.; Yin, L.; Yu, Q.; Zhong, C.; Zhang, J. J. J.o.P. S. Bacterial cellulose nanofibrous membrane as thermal stable separator for lithium-ion batteries. 2015, 279, 21-27.
30. Li, M.; Wang, X.; Yang, Y.; Chang, Z.; Wu, Y.; Holze, R. J. J.o.m.s. A dense cellulose-based membrane as a renewable host for gel polymer electrolyte of lithium ion batteries. 2015, 476, 112-118.
31. Li, W.; Wang, S.; Fan, Z.; Li, S.; Newman, N. J. C. Oxidized bacterial cellulose functionalized with SiO2 nanoparticles as a separator for lithium-metal and lithium-sulfur batteries. 2022, 1-13.
32. Zhang, T.; Yang, L.; Yan, X.; Ding, X. J. S. Recent advances of cellulose-based materials and their promising application in sodium-ion batteries and capacitors. 2018, 14, 1802444.
33. Zhou, W.; Chen, M.; Tian, Q.; Chen, J.; Xu, X.; Wong, C.-P. J. E. S. M. Cotton-derived cellulose film as a dendrite-inhibiting separator to stabilize the zinc metal anode of aqueous zinc ion batteries. 2022, 44, 57-65.
34. Li, J.; Klöpsch, R.; Nowak, S.; Kunze, M.; Winter, M.; Passerini, S. J. J.o.P. S. Investigations on cellulose-based high voltage composite cathodes for lithium ion batteries. 2011, 196, 7687-7691.
35. Ma, L.; Li, J.; Li, Z.; Ji, Y.; Mai, W.; Wang, H. J. N. Ultra-stable potassium ion storage of nitrogen-doped carbon nanofiber derived from bacterial cellulose. 2021, 11, 1130.
36. Liu, J.; Wang, D.; Zhang, D.; Gao, L.; Lin, T. J. J.o.P. S. Synergistic effects of carboxymethyl cellulose and ZnO as alkaline electrolyte additives for aluminium anodes with a view towards Al-air batteries. 2016, 335, 1-11.
37. Cheng, M.; Liu, J.; Wang, X.; Li, Y.; Xia, W.; Liu, Q.; Hu, J.; Wei, T.; Ling, Y.; Liu, B. J. C. E. J. In-situ synthesis of Bi nanospheres anchored in 3D interconnected cellulose nanocrystal derived carbon aerogel as anode for high-performance Mg-ion batteries. 2023, 451, 138824.
38. Ma, L.; Bi, Z.; Xue, Y.; Zhang, W.; Huang, Q.; Zhang, L.; Huang, Y. J. J.o.M. C. A. Bacterial cellulose: an encouraging eco-friendly nano-candidate for energy storage and energy conversion. 2020, 8, 5812-5842.
39. Huang, Q.; Chen, J.; Liu, M.; Huang, H.; Zhang, X.; Wei, Y. J. C. E. J. Polydopamine-based functional materials and their applications in energy, environmental, and catalytic fields: State-of-the-art review. 2020, 387, 124019.
40. Delparastan, P.; Malollari, K. G.; Lee, H.; Messersmith, P. B. J. A. C. Direct evidence for the polymeric nature of polydopamine. 2019, 131, 1089-1094.
41. Zhou, W.; Xiao, X.; Cai, M.; Yang, L. J. N.l. Polydopamine-coated, nitrogen-doped, hollow carbon-sulfur double-layered core-shell structure for improving lithium-sulfur batteries. 2014, 14, 5250-5256.
42. Xu, Q.; Kong, Q.; Liu, Z.; Zhang, J.; Wang, X.; Liu, R.; Yue, L.; Cui, G. J. R. A. Polydopamine-coated cellulose microfibrillated membrane as high performance lithium-ion battery separator. 2014, 4, 7845-7850.
43. Szabó, L.s.; Imanishi, S.; Hirose, D.; Tsukegi, T.; Wada, N.; Takahashi, K. J. A.o. Mussel-inspired design of a carbon fiber-cellulosic polymer interface toward engineered biobased carbon fiber-reinforced composites. 2020, 5, 27072-27082.
44. Hemmatpour, H.; De Luca, O.; Crestani, D.; Stuart, M. C.; Lasorsa, A.; van der Wel, P. C.; Loos, K.; Giousis, T.; Haddadi-Asl, V.; Rudolf, P. J. N. C. New insights in polydopamine formation via surface adsorption. 2023, 14, 664.
45. Zhang, J.; Yue, L.; Kong, Q.; Liu, Z.; Zhou, X.; Zhang, C.; Xu, Q.; Zhang, B.; Ding, G.; Qin, B. J. S.r. Sustainable, heat-resistant and flame-retardant cellulose-based composite separator for high-performance lithium ion battery. 2014, 4, 1-8.
46. Chun, S.-J.; Choi, E.-S.; Lee, E.-H.; Kim, J. H.; Lee, S.-Y.; Lee, S.-Y. J. J.o.m.c. Eco-friendly cellulose nanofiber paper-derived separator membranes featuring tunable nanoporous network channels for lithium-ion batteries. 2012, 22, 16618-16626.
47. Dumitriu, C.; Voicu, S. I.; Muhulet, A.; Nechifor, G.; Popescu, S.; Ungureanu, C.; Carja, A.; Miculescu, F.; Trusca, R.; Pirvu, C. J. C.p. Production and characterization of cellulose acetate-titanium dioxide nanotubes membrane fraxiparinized through polydopamine for clinical applications. 2018, 181, 215-223.
48. Li, W.; Wang, S.; Fan, Z.; Li, S.; Bernussi, A.; Newman, N. J. M. T. E. Functionalized bacterial cellulose as a separator to address polysulfides shuttling in lithium-sulfur batteries. 2021, 21, 100813.
49. Liu, X.; Wu, Y.; Lin, Q.; Cheng, J.; Lin, F.; Tang, L.; Huang, B.; Lu, B. J. C. Polydopamine-coated cellulose nanocrystal as functional filler to fabricate nanocomposite hydrogel with controllable performance in response to near-infrared light. 2021, 28, 2255-2271.
50. Li, S.; Warzywoda, J.; Wang, S.; Ren, G.; Fan, Z. J. C. Bacterial cellulose derived carbon nanofiber aerogel with lithium polysulfide catholyte for lithium-sulfur batteries. 2017, 124, 212-218.
51. Ball, V.; Del Frari, D.; Toniazzo, V.; Ruch, D. J. J.o.c.; science, i. Kinetics of polydopamine film deposition as a function of pH and dopamine concentration: Insights in the polydopamine deposition mechanism. 2012, 386, 366-372.
52. Sun, J.; Hwang, J. Y.; Jankowski, P.; Xiao, L.; Sanchez, J. S.; Xia, Z.; Lee, S.; Talyzin, A. V.; Matic, A.; Palermo, V. J. S. Critical role of functional groups containing N, S, and O on graphene surface for stable and fast charging Li—S batteries. 2021, 17, 2007242.
53. Francis, C. F.; Kyratzis, I. L.; Best, A. S. J. A. M. Lithium-ion battery separators for ionic-liquid electrolytes: a review. 2020, 32, 1904205.
54. Liu, B.; Torres, J. F.; Taheri, M.; Xiong, P.; Lu, T.; Zhu, J.; Liu, Y.; Yu, G.; Tricoli, A. J. A. E. M. Dual-Ion Flux Management for Stable High Areal Capacity Lithium-Sulfur Batteries. 2022, 12, 2103444.
55. Zhu, X.; Zhao, W.; Song, Y.; Li, Q.; Ding, F.; Sun, J.; Zhang, L.; Liu, Z. J. A. E. M. In situ assembly of 2D conductive vanadium disulfide with graphene as a high-sulfur-loading host for lithium-Sulfur batteries. 2018, 8, 1800201.
56. Zhou, M.-L.; Zhang, Z.; Xu, J.; Wei, J.; Yu, J.; Yang, Z.-Y. J. J.o.E. C. PDA modified commercial paper separator engineering with excellent lithiophilicity and mechanical strength for lithium metal batteries. 2020, 868, 114195.
57. Tian, Y.; Sun, Z.; Zhang, Y.; Wang, X.; Bakenov, Z.; Yin, F. J. N. Micro-spherical sulfur/graphene oxide composite via spray drying for high performance lithium sulfur batteries. 2018, 8, 50.
58. Zhou, G. Graphene-pure sulfur sandwich structure for ultrafast, long-life lithium-sulfur batteries. In Design, Fabrication and Electrochemical Performance of Nanostructured Carbon Based Materials for High-Energy Lithium-Sulfur Batteries; Springer: 2017; pp. 75-94.
59. Um, J. H.; Yu, S. H. J. A. E. M. Unraveling the mechanisms of lithium metal plating/stripping via in situ/operando analytical techniques. 2021, 11, 2003004.
60. Yang, Y.; Wang, W.; Li, L.; Li, B.; Zhang, J. J. J.o.M. C. A. Stable cycling of Li—S batteries by simultaneously suppressing Li-dendrite growth and polysulfide shuttling enabled by a bioinspired separator. 2020, 8, 3692-3700.
61. Yang, Y.; Zhang, J. J. A. E. M. Highly Stable Lithium-Sulfur Batteries Based on Laponite Nanosheet-Coated Celgard Separators. 2018, 8, 1801778.
62. Wang, J.; Zhang, J.; Duan, S.; Li, T.; Jia, L.; Liu, H.; Li, L.; Cheng, S.; Hu, H.; Huang, M. J. C. E. J. Interfacial lithium-nitrogen bond catalyzes sulfide oxidation reactions in high-loading Li₂S cathode. 2022, 429, 132352.
63. Knap, V.; Stroe, D.-I.; Swierczynski, M.; Teodorescu, R.; Schaltz, E. J. J.o.T. E. S. Investigation of the self-discharge behavior of lithium-sulfur batteries. 2016, 163, A911.
64. He, Y.; Bai, S.; Chang, Z.; Li, Q.; Qiao, Y.; Zhou, H. J. J.o.M. C. A. Porous hybrid aerogels with ultrahigh sulfur loading for lithium-sulfur batteries. 2018, 6, 9032-9040.
65. Harrison, K. L.; Merrill, L. C.; Long, D. M.; Randolph, S. J.; Goriparti, S.; Christian, J.; Warren, B.; Roberts, S. A.; Harris, S. J.; Perry, D. L. J. I. Cryogenic electron microscopy reveals that applied pressure promotes short circuits in Li batteries. 2021, 24, 103394.
66. Cheng, X.-B.; Zhang, R.; Zhao, C.-Z.; Zhang, Q. Toward safe lithium metal anode in rechargeable batteries: a review. Chemical reviews 2017, 117, 10403-10473.
67. Yin, Y.-X.; Xin, S.; Guo, Y.-G.; Wan, L.-J. Lithium-Sulfur Batteries: Electrochemistry, Materials, and Prospects. Angewandte Chemie International Edition 2013, 52, 13186-13200.
68. Li, S.; Lin, X.; Wang, S.; Zhu, H.; Fan, Z. Bacteria derived nanomaterials for lithium-based batteries. Carbon 2024, 216, 118564.
69. Lin, D.; Liu, Y.; Cui, Y. Reviving the lithium metal anode for high-energy batteries. Nature nanotechnology 2017, 12, 194-206.
70. Liu, T.; Hu, H.; Ding, X.; Yuan, H.; Jin, C.; Nai, J.; Liu, Y.; Wang, Y.; Wan, Y.; Tao, X. 12 years roadmap of the sulfur cathode for lithium sulfur batteries (2009-2020). Energy Storage Materials 2020, 30, 346-366.
71. Rana, M.; Luo, B.; Kaiser, M. R.; Gentle, I.; Knibbe, R. The role of functional materials to produce high areal capacity lithium sulfur battery. Journal of Energy Chemistry 2020, 42, 195-209.
72. Lin, X.; Li, W.; Pan, X.; Wang, S.; Fan, Z. Electrocatalytic and Conductive Vanadium Oxide on Carbonized Bacterial Cellulose Aerogel for the Sulfur Cathode in Li—S Batteries. Batteries 2023, 9, 14.
73. Lin, X.; Li, W.; Nguyen, V.; Wang, S.; Yang, S.; Ma, L.; Du, Y.; Wang, B.; Fan, Z. Fe-single-atom catalyst nanocages linked by bacterial cellulose-derived carbon nanofiber aerogel for Li—S batteries. Chemical Engineering Journal 2023, 477, 146977.
74. Gueon, D.; Ju, M.-Y.; Moon, J. H. Complete encapsulation of sulfur through interfacial energy control of sulfur solutions for high-performance Li—S batteries. Proceedings of the National Academy of Sciences 2020, 117, 12686-12692.
75. Bai, P.; Li, J.; Brushett, F. R.; Bazant, M. Z. Transition of lithium growth mechanisms in liquid electrolytes. Energy & Environmental Science 2016, 9, 3221-3229.
76. Wang, C.; Wang, A.; Ren, L.; Guan, X.; Wang, D.; Dong, A.; Zhang, C.; Li, G.; Luo, J. Controlling Li Ion Flux through Materials Innovation for Dendrite-Free Lithium Metal Anodes. Advanced Functional Materials 2019, 29, 1905940.
77. Yu, X.; Feng, S.; Boyer, M. J.; Lee, M.; Ferrier, R. C.; Lynd, N. A.; Hwang, G. S.; Wang, G.; Swinnea, S.; Manthiram, A. Controlling the polysulfide diffusion in lithium-sulfur batteries with a polymer membrane with intrinsic nanoporosity. Materials Today Energy 2018, 7, 98-104.
78. Deimede, V.; Elmasides, C. Separators for Lithium-Ion Batteries: A Review on the Production Processes and Recent Developments. Energy Technology 2015, 3, 453-468.
79. Zhong, S.; Yuan, B.; Guang, Z.; Chen, D.; Li, Q.; Dong, L.; Ji, Y.; Dong, Y.; Han, J.; He, W. Recent progress in thin separators for upgraded lithium ion batteries. Energy Storage Materials 2021, 41, 805-841.
80. Arora, P.; Zhang, Z. Battery separators. Chemical reviews 2004, 104, 4419-4462.
81. Huang, Z.-D.; Yang, M.-T.; Qi, J.-Q.; Zhang, P.; Lei, L.; Du, Q.-C.; Bai, L.; Fu, H.; Yang, X.-S.; Liu, R.-Q.; Masese, T.; Zhang, H.; Ma, Y.-W. Mitigating the polysulfides “shuttling” with TiO2 nanowires/nanosheets hybrid modified separators for robust lithium-sulfur batteries. Chemical Engineering Journal 2020, 387, 124080.
82. Zhang, Y.; Miao, L.; Ning, J.; Xiao, Z.; Hao, L.; Wang, B.; Zhi, L. A graphene-oxide-based thin coating on the separator: an efficient barrier towards high-stable lithium-sulfur batteries. 2D Materials 2015, 2, 024013.
83. Li, Z.; Hou, L.-P.; Zhang, X.-Q.; Li, B.-Q.; Huang, J.-Q.; Chen, C.-M.; Liu, Q.-B.; Xiang, R.; Zhang, Q. A Nafion protective layer for stabilizing lithium metal anodes in working lithium-sulfur batteries. Battery Energy 2022, 1, 20220006.
84. Baranwal, R.; Lin, X.; Li, W.; Pan, X.; Wang, S.; Fan, Z. Biopolymer separators from polydopamine-functionalized bacterial cellulose for lithium-sulfur batteries. Journal of Colloid and Interface Science 2024, 656, 556-565.
85. Zhou, C.; Li, Z.; Xu, X.; Mai, L. Metal-organic frameworks enable broad strategies for lithium-sulfur batteries. National Science Review 2021, 8.
86. Bai, S.; Liu, X.; Zhu, K.; Wu, S.; Zhou, H. Metal-organic framework-based separator for lithium-sulfur batteries. Nature Energy 2016, 1, 16094.
87. Zhang, C.; Shen, L.; Shen, J.; Liu, F.; Chen, G.; Tao, R.; Ma, S.; Peng, Y.; Lu, Y. Anion-sorbent composite separators for high-rate lithium-ion batteries. Advanced Materials 2019, 31, 1808338.
88. Liu, W.; Mi, Y.; Weng, Z.; Zhong, Y.; Wu, Z.; Wang, H. Functional metal-organic framework boosting lithium metal anode performance via chemical interactions. Chemical Science 2017, 8, 4285-4291.
89. Lin, G.; Jia, K.; Bai, Z.; Liu, C.; Liu, S.; Huang, Y.; Liu, X. Metal-Organic Framework Sandwiching Porous Super-Engineering Polymeric Membranes as Anionphilic Separators for Dendrite-free Lithium Metal Batteries. Advanced Functional Materials 2022, 32, 2207969.
90. Bai, S.; Zhu, K.; Wu, S.; Wang, Y.; Yi, J.; Ishida, M.; Zhou, H. A long-life lithium-sulphur battery by integrating zinc-organic framework based separator. Journal of Materials Chemistry A 2016, 4, 16812-16817.
91. Zhao, Y.; Wei, Y.; Lyu, L.; Hou, Q.; Caro, J.; Wang, H. Flexible Polypropylene-Supported ZIF-8 Membranes for Highly Efficient Propene/Propane Separation. Journal of the American Chemical Society 2020, 142, 20915-20919.
92. Wang, Z.; Liu, L.; Li, Z.; Goyal, N.; Du, T.; He, J.; Li, G. K. Shaping of Metal-Organic Frameworks: A Review. Energy & Fuels 2022, 36, 2927-2944.
93. Wei, R.; Chi, H.-Y.; Li, X.; Lu, D.; Wan, Y.; Yang, C.-W.; Lai, Z. Aqueously Cathodic Deposition of ZIF-8 Membranes for Superior Propylene/Propane Separation. Advanced Functional Materials 2020, 30, 1907089.
94. Xie, S.; Zhou, Z.; Zhang, X.; Fransaer, J. Cathodic deposition of MOF films: mechanism and applications. Chemical Society Reviews 2023, 52, 4292-4312.
95. Zhang, C.; Lively, R. P.; Zhang, K.; Johnson, J. R.; Karvan, O.; Koros, W. J. Unexpected Molecular Sieving Properties of Zeolitic Imidazolate Framework-8. The Journal of Physical Chemistry Letters 2012, 3, 2130-2134.
96. Ariyoshi, S.; Hashimoto, S.; Ohnishi, S.; Negishi, S.; Mikami, H.; Hayashi, K.; Tanaka, S.; Hiroshiba, N. Broadband terahertz spectroscopy of cellulose nanofiber-reinforced polypropylenes. Materials Science and Engineering: B 2021, 265, 115000.
97. Morris, W.; Stevens, C. J.; Taylor, R. E.; Dybowski, C.; Yaghi, O. M.; Garcia-Garibay, M. A. NMR and X-ray Study Revealing the Rigidity of Zeolitic Imidazolate Frameworks. The Journal of Physical Chemistry C 2012, 116, 13307-13312.
98. Park, K. S.; Ni, Z.; Côté, A. P.; Choi, J. Y.; Huang, R.; Uribe-Romo, F. J.; Chae, H. K.; O'Keeffe, M.; Yaghi, O. M. Exceptional chemical and thermal stability of zeolitic imidazolate frameworks. Proceedings of the National Academy of Sciences 2006, 103, 10186-10191.
99. Mphuthi, L. E.; Erasmus, E.; Langner, E. H. G. Metal Exchange of ZIF-8 and ZIF-67 Nanoparticles with Fe (II) for Enhanced Photocatalytic Performance. ACS Omega 2021, 6, 31632-31645.
100. Dangwal, S.; Ronte, A.; Lin, H.; Liu, R.; Zhu, J.; Lee, J. S.; Gappa-Fahlenkamp, H.; Kim, S.-J. ZIF-8 membranes supported on silicalite-seeded substrates for propylene/propane separation. Journal of Membrane Science 2021, 626, 119165.
101. Kravets, L. I.; Altynov, V. A.; Zagonenko, V. F.; Lizunov, N. E.; Satulu, V.; Mitu, B.; Dinescu, G. Composite Bilayer Polymer Membranes with Hydrophobic Layers. Inorganic Materials: Applied Research 2018, 9, 777-784.
102. Luanwuthi, S.; Krittayavathananon, A.; Srimuk, P.; Sawangphruk, M. In situ synthesis of permselective zeolitic imidazolate framework-8/graphene oxide composites: rotating disk electrode and Langmuir adsorption isotherm. RSC Advances 2015, 5, 46617-46623.
103. Minhas, F. T.; Memon, S.; Bhanger, M.; Iqbal, N.; Mujahid, M. J. A. s. s. Solvent resistant thin film composite nanofiltration membrane: characterization and permeation study. 2013, 282, 887-897.
104. Rodriguez, R.; Palma, M. S.; Bhandari, D.; Tian, F. J. L. Electrodeposition of Ag/ZIF-8-Modified Membrane for Water Remediation. 2023, 39, 2291-2300.
105. Bahar, E.; Ucar, N.; Onen, A.; Wang, Y.; Oksüz, M.; Ayaz, O.; Ucar, M.; Demir, A. Thermal and mechanical properties of polypropylene nanocomposite materials reinforced with cellulose nano whiskers. Journal of Applied Polymer Science 2012, 125, 2882-2889.
106. Prasanna, K.; Kim, C.-S.; Lee, C. W. Effect of SiO2 coating on polyethylene separator with different stretching ratios for application in lithium ion batteries. Materials Chemistry and Physics 2014, 146, 545-550.
107. Evans, J.; Vincent, C. A.; Bruce, P. G. Electrochemical measurement of transference numbers in polymer electrolytes. Polymer 1987, 28, 2324-2328.
108. Zhang, S. S. Liquid electrolyte lithium/sulfur battery: Fundamental chemistry, problems, and solutions. Journal of Power Sources 2013, 231, 153-162.
109. Rajput, N. N.; Murugesan, V.; Shin, Y.; Han, K. S.; Lau, K. C.; Chen, J.; Liu, J.; Curtiss, L. A.; Mueller, K. T.; Persson, K. A. Elucidating the Solvation Structure and Dynamics of Lithium Polysulfides Resulting from Competitive Salt and Solvent Interactions. Chemistry of Materials 2017, 29, 3375-3379.
110. Zheng, J.; Tian, J.; Wu, D.; Gu, M.; Xu, W.; Wang, C.; Gao, F.; Engelhard, M. H.; Zhang, J.-G.; Liu, J.; Xiao, J. Lewis Acid-Base Interactions between Polysulfides and Metal Organic Framework in Lithium Sulfur Batteries. Nano Letters 2014, 14, 2345-2352.
111. Song, J.; Gordin, M. L.; Xu, T.; Chen, S.; Yu, Z.; Sohn, H.; Lu, J.; Ren, Y.; Duan, Y.; Wang, D. Strong lithium polysulfide chemisorption on electroactive sites of nitrogen-doped carbon composites for high-performance lithium-sulfur battery cathodes. Angewandte Chemie 2015, 127, 4399-4403.
112. Kang, X.; He, T.; Zou, R.; Niu, S.; Ma, Y.; Zhu, F.; Ran, F. Size Effect for Inhibiting Polysulfides Shuttle in Lithium-Sulfur Batteries. Small 2023, 2306503.
113. Huang, X.; Wang, Z.; Knibbe, R.; Luo, B.; Ahad, S. A.; Sun, D.; Wang, L. Cyclic Voltammetry in Lithium-Sulfur Batteries-Challenges and Opportunities. Energy Technology 2019, 7, 1801001.
114. Zhou, G.; Tian, H.; Jin, Y.; Tao, X.; Liu, B.; Zhang, R.; Seh, Z. W.; Zhuo, D.; Liu, Y.; Sun, J.; Zhao, J.; Zu, C.; Wu, D. S.; Zhang, Q.; Cui, Y. Catalytic oxidation of Li₂S on the surface of metal sulfides for Li—S batteries. Proceedings of the National Academy of Sciences 2017, 114, 840-845.
115. Huang, J.-Q.; Zhuang, T.-Z.; Zhang, Q.; Peng, H.-J.; Chen, C.-M.; Wei, F. Permselective Graphene Oxide Membrane for Highly Stable and Anti-Self-Discharge Lithium-Sulfur Batteries. ACS Nano 2015, 9, 3002-3011.
116. Li, Z.; Sami, I.; Yang, J.; Li, J.; Kumar, R. V.; Chhowalla, M. Lithiated metallic molybdenum disulfide nanosheets for high-performance lithium-sulfur batteries. Nature Energy 2023, 8, 84-93.

What is claimed is:

1. A battery separator, comprising:
a polymer substrate that is flexible; and
a functional barrier layer deposed on the polymer substrate, the functional barrier layer being polycrystalline and comprising a metal-organic framework and a plurality of micropores;
wherein the functional barrier layer is able to flex with the polymer substrate;
wherein the functional barrier layer is compact, such that diffusion pathways through the functional barrier layer are limited to a cutoff size, and such that the diffusion pathways that are largest are located within grains of the polycrystalline functional barrier layer rather than between grains.

2. The battery separator of claim 1, wherein the battery separator is less than 10 μm thick.

3. The battery separator of claim 1, wherein the polymer substrate is less than 9 μm thick.

4. The battery separator of claim 1, wherein the polymer substrate is bacteria cellulose.

5. The battery separator of claim 1, wherein the polymer substrate is polypropylene.

6. The battery separator of claim 1, wherein the metal-organic framework is ZIF-8.

7. The battery separator of claim 1, wherein the functional barrier layer is less than 2 μm thick.

8. The battery separator of claim 1, wherein the cutoff size is less than 10 Å.

9. A battery separator, comprising:
a polymer substrate; and
a functional barrier layer deposed on the polymer substrate, the functional barrier layer being polycrystalline and comprising a metal-organic framework and a plurality of micropores;
wherein the functional barrier layer is compact, such that diffusion pathways through the functional barrier layer are limited to a cutoff size, and such that the diffusion pathways that are largest are located within grains of the polycrystalline functional barrier layer rather than between grains;
wherein the functional barrier layer is less than 2 μm thick.

10. The battery separator of claim 9, wherein the battery separator is less than 10 μm thick.

11. The battery separator of claim 9, wherein the polymer substrate is bacteria cellulose.

12. The battery separator of claim 9, wherein the polymer substrate is polypropylene.

13. The battery separator of claim 9, wherein the metal-organic framework is ZIF-8.

14. The battery separator of claim 9, wherein the cutoff size is less than 10 Å.

15. A method for fabricating a battery separator, comprising:
preparing a polymer substrate that is flexible;
preparing a precursor solution that is a precursor to a metal-organic framework;
deposing a functional barrier layer on the polymer substrate using the precursor solution, the functional barrier layer being polycrystalline;
wherein the functional barrier layer is compact, such that diffusion pathways through the functional barrier layer are limited to a cutoff size, and such that the diffusion pathways that are largest are located within grains of the polycrystalline functional barrier layer rather than between grains;
wherein the battery separator is less than 10 μm thick.

16. The method of claim 15:
wherein preparing the polymer substrate comprises sputtering a metal coating on the polymer substrate; and
wherein the functional barrier layer is deposed on the polymer substrate through electrodeposition within the precursor solution.

17. The method of claim 15, wherein the functional barrier layer is deposed on the polymer substrate through interfacial growth within the precursor solution.

18. The method of claim 15, wherein the polymer substrate is polypropylene.

19. The method of claim 15, wherein the metal-organic framework is ZIF-8.

20. The method of claim 15, wherein the cutoff size is less than 10 Å.
